(19) United States
(12) Patent Application Publication
(10) Pub. No.: US 2024/0220323 A1
(43) Pub. Date: Jul. 4, 2024

(54) APPARATUSES, METHODS, AND SYSTEMS FOR INSTRUCTIONS FOR LOADING A TILE OF A MATRIX OPERATIONS ACCELERATOR

(71) Applicant: Intel Corporation, Santa Clara, CA (US)

(72) Inventors: Gregory Henry, Hillsboro, OR (US); Kermin E. Chofleming, Hudson, MA (US); Simon C. Steely, JR., Hudson, NH (US)

(21) Appl. No.: 18/149,045

(22) Filed: Dec. 30, 2022

(51) Int. Cl. G06F 9/50; G06F 5/01; G06F 7/487

(52) U.S. Cl. CPC G06F 9/5027; G06F 5/012; G06F 7/4876

(57) ABSTRACT

Systems, methods, and apparatuses relating to floating-point support circuitry to implement floating-point operations on a two-dimensional grid of fixed-point processing elements are described. In one example, a hardware processor includes a two-dimensional grid of fixed-point processing elements; floating-point support circuitry coupled to the two-dimensional grid of fixed-point processing elements; storage for a first, a second, and a destination two-dimensional floating-point matrices coupled to the floating-point support circuitry; and controller circuitry to cause the two-dimensional grid of fixed-point processing elements and the floating-point support circuitry to: determine, by the floating-point support circuitry, an extreme exponent for each row of the first two-dimensional floating-point matrix and for each column of the second two-dimensional floating-point matrix, generate, by the floating-point support circuitry, a first fixed-point matrix from the first two-dimensional floating-point matrix and a second fixed-point matrix from the second two-dimensional floating-point matrix, generate, by the two-dimensional grid of fixed-point processing elements, corresponding fixed-point results by a multiplication of fixed-point elements of the first fixed-point matrix by corresponding fixed-point elements of the second fixed-point matrix, scale, by the floating-point support circuitry, the corresponding fixed-point results according to the extreme exponents to generate scaled fixed-point results, generate, by the floating-point support circuitry, a resultant floating-point matrix from the scaled fixed-point results, and store the resultant floating-point matrix into the destination two-dimensional floating-point matrix.

### TECHNICAL FIELD

The disclosure relates generally to computer processor architecture, and, more specifically, to floating-point support circuitry to implement floating-point operations on a two-dimensional grid of fixed-point processing elements.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an example of configured tiles according to examples of the disclosure.

FIG. 1B illustrates an example of configured tiles according to examples of the disclosure.

FIG. 2 illustrates several examples of matrix storage according to examples of the disclosure.

FIG. 3 illustrates an example of a system utilizing a matrix (tile) operations accelerator according to examples of the disclosure.

FIGS. 4 and 5 show different examples of how memory is shared using a matrix operations accelerator.

FIG. 6 illustrates an example of matrix multiply accumulate operation using tiles (“TMMA”).

FIG. 7 illustrates an example of a subset of the execution of an iteration of a chained fused multiply accumulate instruction.

FIG. 8 illustrates an example of a subset of the execution of an iteration of a chained fused multiply accumulate instruction.

FIG. 9 illustrates an example of a subset of the execution of an iteration of a chained fused multiply accumulate instruction.

FIG. 10 illustrates an example of a subset of the execution of an iteration of chained fused multiply accumulate instruction.

FIG. 11 illustrates power-of-two sized SIMD implementations wherein the accumulators use input sizes that are larger than the inputs to the multipliers according to an example.

FIG. 12 illustrates an example of a system utilizing matrix operations circuitry.

FIG. 13 illustrates an example of a processor core pipeline supporting matrix operations using tiles.

FIG. 14 illustrates an example of a processor core pipeline supporting matrix operations using tiles.

FIG. 15 illustrates an example of a matrix expressed in row major format and column major format.

FIG. 16 illustrates an example of usage of matrices (tiles).

FIG. 17 illustrates an example a method of usage of matrices (tiles).

FIG. 18 illustrates support for configuration of the usage of tiles according to an example.

FIG. 19 illustrates an example of a description of the matrices (tiles) to be supported.

FIGS. 20A-20D illustrate examples of register(s).

FIG. 21 illustrates an example of a system including a matrix operations accelerator that includes floating-point support circuitry for a two-dimensional grid of fixed-point processing elements according to examples of the disclosure.

FIG. 22 illustrates an example of an inner product calculation with floating-point values according to examples of the disclosure.

FIG. 23 illustrates an example of scalar long multiplication according to examples of the disclosure.

FIG. 24 illustrates an example of long multiplication applied to inner product computations according to examples of the disclosure.

FIG. 25 illustrates an example inner product of a row of matrix A and a column of matrix B to generate a resultant value C according to examples of the disclosure.

FIG. 26 illustrates an example table of binary representations of the floating-point elements of the row of matrix A and the column of matrix B in FIG. 25 and the extreme exponent for row A and the extreme exponent for column B according to examples of the disclosure.

FIG. 27 illustrates an example table of binary fixed-point representations of the mantissas of the elements of the row of matrix A shifted according to the extreme exponent for row A and the mantissas of the elements of the column of matrix B shifted according to the extreme exponent for column B, and the chunking of each of those binary fixed-point representations into three chunks according to examples of the disclosure.

FIG. 28 illustrates an example of the calculations to determine a floating-point multiplication using chunked binary fixed-point representations according to examples of the disclosure.

FIG. 29A illustrates an example of the multiplication of A′1*B′1 from the table in FIG. 27 using chunked binary fixed-point representations according to examples of the disclosure.

FIG. 29B illustrates an example of the multiplication of A′2*B′1 from the table in FIG. 27 using chunked binary fixed-point representations according to examples of the disclosure.

FIG. 30 illustrates an example of the final scaling and summation of the C′n matrices using chunked binary fixed-point representations according to examples of the disclosure.

FIG. 31 illustrates a matrix operations accelerator that includes floating-point support circuitry for a two-dimensional grid of fixed-point processing elements according to examples of the disclosure.

FIG. 32 illustrates further detail of a two-dimensional grid of fixed-point processing elements according to examples of the disclosure.

FIG. 33 illustrates floating-point support circuitry for extracting extreme exponents from line-oriented floating-point data according to examples of the disclosure.

FIG. 34 illustrates floating-point support circuitry for extracting extreme exponents from non-line-oriented floating-point data according to examples of the disclosure.

FIG. 35 illustrates floating-point support circuitry for extreme exponent scaling and floating-point to fixed-point conversions according to examples of the disclosure.

FIG. 36 illustrates floating-point support circuitry for intermediate partial sum accumulation according to examples of the disclosure.

FIG. 37 illustrates an example of the calculation of terms of a scaling matrix (S matrix) according to examples of the disclosure.

FIG. 38 illustrates floating-point support circuitry a scaling and conversion of a fixed-point value and accumulation into a final floating-point result according to examples of the disclosure.

FIG. 39 illustrates a hardware processor coupled to storage that includes one or more matrix floating-point (FP) operation instructions that utilize a matrix operations accelerator that includes floating-point support circuitry for a two-dimensional grid of fixed-point processing elements according to examples of the disclosure.

FIG. 40 illustrates a method of processing a “matrix floating-point (FP) operation” instruction according to examples of the disclosure.

FIG. 41 is a block diagram illustrating use of a “matrix floating-point (FP) operation” instruction according to examples of the disclosure.

FIG. 42 illustrates an example computing system.

FIG. 43 illustrates a block diagram of an example processor and/or System on a Chip (SoC) that may have one or more cores and an integrated memory controller.

FIG. 44A is a block diagram illustrating both an example in-order pipeline and an example register renaming, out-of-order issue/execution pipeline according to examples.

FIG. 44B is a block diagram illustrating both an example in-order architecture core and an example register renaming, out-of-order issue/execution architecture core to be included in a processor according to examples.

FIG. 45 illustrates examples of execution unit(s) circuitry.

FIG. 46 is a block diagram of a register architecture according to some examples.

FIG. 47 illustrates examples of an instruction format.

FIG. 48 illustrates examples of an addressing information field.

FIG. 49 illustrates examples of a first prefix.

FIGS. 50A-50D illustrate examples of how the R, X, and B fields of the first prefix in FIG. 49 are used.

FIGS. 51A-51B illustrate examples of a second prefix.

FIG. 52 illustrates examples of a third prefix.

FIG. 53 is a block diagram illustrating the use of a software instruction converter to convert binary instructions in a source instruction set architecture to binary instructions in a target instruction set architecture according to examples.

### DETAILED DESCRIPTION

In the following description, numerous specific details are set forth. However, it is understood that examples may be practiced without these specific details. In other instances, well-known circuits, structures, and techniques have not been shown in detail in order not to obscure the understanding of this description.

Matrices may be increasingly important in many computing tasks such as machine learning and other bulk data processing. Deep Learning is a class of machine learning algorithms. Deep learning architectures, such as deep neural networks, may be applied to fields including computer vision, speech recognition, natural language processing, audio recognition, social network filtering, machine translation, bioinformatics, and drug design.

Inference and training, two tools used for deep learning, may utilize low precision arithmetic. Maximizing throughput of deep learning algorithms and computations may assist in meeting the needs of deep learning processors, for example, those performing deep learning in a data center.

Matrix-matrix multiplication (a.k.a., GEMM or General Matrix Multiplication) is a compute-heavy operation on certain processors. Special hardware for matrix multiplication (e.g., GEMM) is a good option for improving the peak compute (and energy efficiency) of certain applications, such as deep learning. Some of these applications, including deep learning, can operate on input data elements with relatively few bits without losing accuracy, as long as the output elements have enough bits (e.g., more than the inputs).

In certain processors, handling matrices is a difficult and/or instruction intensive task. For example, rows of a matrix could be put into a plurality of packed data (e.g., SIMD or vector) registers and then operated on individually. For example, an add two 8×2 (e.g., row by column) matrices may require a load or gather into four packed data registers depending upon data sizes. Then a first add of packed data registers corresponding to a first row from each matrix is performed and a second add of packed data registers corresponding to a second row from each matrix is performed. Then the resulting packed data registers are scattered back to memory. While for small matrices this scenario may be acceptable, it is often not acceptable with larger matrices.

### Discussion

Described herein are mechanisms to support matrix operations in computer hardware such as central processing units (CPUs), graphic processing units (GPUs), and accelerators. The matrix operations utilize 2-dimensional (2-D) data structures representing one or more packed regions of memory such as registers. Throughout this description, these 2-D data structures are referred to as tiles. Note that a matrix may be smaller than a tile (use less than all of a tile) or utilize a plurality of tiles (the matrix is larger than the size of any one tile). Throughout the description, matrix (tile) language is used to indicate operations performed using tiles that impact a matrix; whether or not that matrix is larger than any one tile is not typically relevant.

Each tile may be acted upon by different operations such as those that are detailed herein and include, but are not limited to: matrix (tile) multiplication, tile add, tile subtract, tile diagonal, tile zero, tile transform, tile dot product, tile broadcast, tile row broadcast, tile column broadcast, tile multiplication, tile multiplication and accumulation, tile move, etc. Additionally, support for operators such as the use of a scale and/or bias may be used with these operations or in support of non-numeric applications in the future, for instance, OpenCL “local memory,” data compression/decompression, etc. Also described herein are instructions for performing matrix operation (e.g., TILEPARTIALDOTPRODUCT) instructions.

Portions of storage (such as memory (non-volatile and volatile), registers, cache, etc.) are arranged into tiles of different horizontal and vertical dimensions. For example, a tile may have horizontal dimension of 4 (e.g., four rows of a matrix) and a vertical dimension of 8 (e.g., 8 columns of the matrix). Typically, the horizontal dimension is related to element sizes (e.g., 2-, 4-, 8-, 16-, 32-, 64-, 128-bit, etc.). Multiple datatypes (single precision floating point, double precision floating point, integer, etc.) may be supported.

### Exemplary Usage of Configured Tiles

In some examples, tile parameters can be configured. For example, a given tile may be configured to provide tile options. Exemplary tile options include but are not limited to: a number of rows of the tile, a number of columns of the tile, whether the tile is VALID, and whether the tile consists of a PAIR of equal-sized tiles.

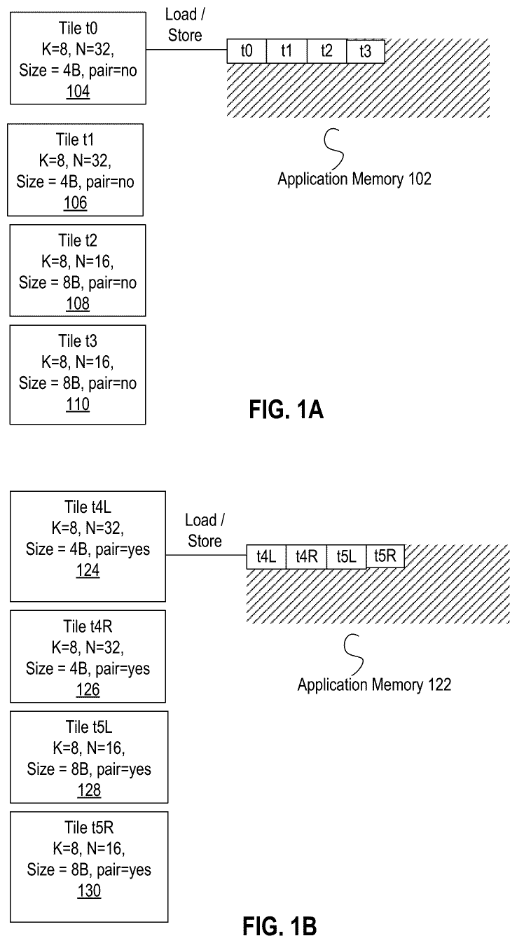

FIG. 1A illustrates an example of configured tiles. As shown, 4 kB of application memory 102 have stored thereon 4 1 KB titles, tile t0 104, tile t1 106, tile t2 108, and tile t3 110. In this example, the 4 tiles do not consist of pairs, and each have elements arranged in rows and columns. Tile t0 104 and tile t1 106 have K rows and N columns of 4-byte elements (e.g., single precision data), where K equals 8 and N=32. Tile t2 108 and tile t3 110 have K rows and N/2 columns of 8-byte elements (e.g., double precision data). As the double precision operands are twice the width of single precision, this configuration is consistent with a palette, used to provide tile options, supplying at least 4 names with total storage of at least 4 kB. In operation, the tiles can be loaded from and stored to memory using load and store operations. Depending upon the instruction encoding scheme used, the amount of available application memory, as well as the size, number, and configuration of available tiles varies.

FIG. 1B illustrates an example of configured tiles. As shown, 4 kB of application memory 122 have stored thereon 2 pairs of 1 kB-titles, the first pair being tile t4L 124 and tile t4R 126, and the second pair being tile t5L 128 and tile t5R 130. As shown the pairs of tiles are divided into a left tile and a right tile. In other examples, the pair of tiles are divided into an even tile and an odd tile. In this example, the 4 tiles each have elements arranged in rows and columns. Tile t4L 124 and tile t4R 126 have K rows and N columns of 4-byte elements (e.g., single precision floating point data), where K equals 8 and N equals 32. Tile t5L 128 and tile t5R 130 have K rows and N/2 columns of 8-byte elements (e.g., double precision floating point data). As the double precision operands are twice the width of single precision, this configuration is consistent with a palette, used to provide tile options, supplying at least 2 names with total storage of at least 4 kB. The four tiles of FIG. 1A use 4 names, each naming a 1 KB tile, whereas the 2 pairs of tiles in FIG. 1B can use 2 names to specify the paired tiles. In some examples, tile instructions accept a name of a paired tile as an operand. In operation, the tiles can be loaded from and stored to memory using load and store operations. Depending upon the instruction encoding scheme used, the amount of available application memory, as well as the size, number, and configuration of available tiles varies.

In some examples, tile parameters are definable. For example, a “palette” is used to provide tile options. Exemplary options include, but are not limited to: the number of tile names, the number of bytes in a row of storage, the number of rows and columns in a tile, etc. For example, a maximum “height” (number of rows) of a tile may be defined as:

Tile Max Rows=Architected Storage/(The Number of Palette Names*The Number of Bytes per row).

As such, an application can be written such that a fixed usage of names will be able to take advantage of different storage sizes across implementations.

Configuration of tiles is done using a tile configuration (“TILECONFIG”) instruction, where a particular tile usage is defined in a selected palette. This declaration includes the number of tile names to be used, the requested number of rows and columns per name (tile), and, in some examples, the requested datatype of each tile. In some examples, consistency checks are performed during the execution of a TILECONFIG instruction to determine that it matches the restrictions of the palette entry.

### Exemplary Tile Storage Types

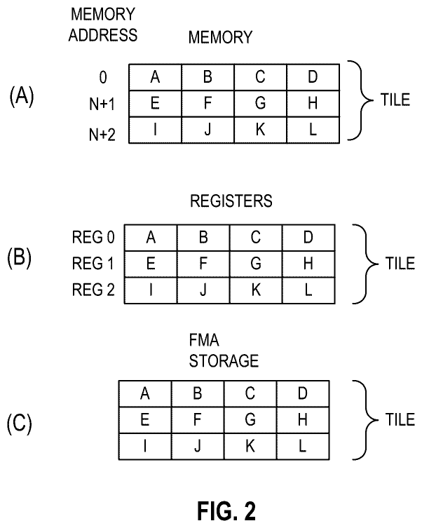

FIG. 2 illustrates several examples of matrix storage. In (A), a tile is stored in memory. As shown, each “row” consists of four packed data elements. To get to the next “row,” a stride value is used. Note that rows may be consecutively stored in memory. Strided memory accesses allows for access of one row to then next when the tile storage does not map the underlying memory array row width.

Tile loads from memory and stores to memory are typically strided accesses from the application memory to packed rows of data. Exemplary TILELOAD and TILESTORE instructions, or other instruction references to application memory as a TILE operand in load-op instructions, are, in some examples, restartable to handle (up to) 2*rows of page faults, unmasked floating point exceptions, and/or interrupts per instruction.

In (B), a matrix is stored in a tile comprised of a plurality of registers such as packed data registers (single instruction, multiple data (SIMD) or vector registers). In this example, the tile is overlaid on three physical registers. Typically, consecutive registers are used, however, this need not be the case.

In (C), a matrix is stored in a tile in non-register storage accessible to a fused multiply accumulate (FMA) circuit used in tile operations. This storage may be inside of a FMA, or adjacent to it. Additionally, in some examples, discussed below, the storage may be for a data element and not an entire row or tile.

The supported parameters for the TMMA architecture are reported via CPUID. In some examples, the list of information includes a maximum height and a maximum SIMD dimension. Configuring the TMMA architecture requires specifying the dimensions for each tile, the element size for each tile and the palette identifier. This configuration is done by executing the TILECONFIG instruction.

Successful execution of a TILECONFIG instruction enables subsequent TILE operators. A TILERELEASEALL instruction clears the tile configuration and disables the TILE operations (until the next TILECONFIG instructions executes). In some examples, XSAVE, XSTORE, etc. are used in context switching using tiles. In some examples, 2 XCR0 bits are used in XSAVE, one for TILECONFIG metadata and one bit corresponding to actual tile payload data.

TILECONFIG not only configures the tile usage, but also sets a state variable indicating that the program is in a region of code with tiles configured. An implementation may enumerate restrictions on other instructions that can be used with a tile region such as no usage of an existing register set, etc.

Exiting a tile region is typically done with the TILERELEASEALL instruction. It takes no parameters and swiftly invalidates all tiles (indicating that the data no longer needs any saving or restoring) and clears the internal state corresponding to being in a tile region.

In some examples, tile operations will zero any rows and any columns beyond the dimensions specified by the tile configuration. For example, tile operations will zero the data beyond the configured number of columns (factoring in the size of the elements) as each row is written. For example, with 64-byte rows and a tile configured with 10 rows and 12 columns, an operation writing FP32 elements would write each of the first 10 rows with 12*4 bytes with output/result data and zero the remaining 4*4 bytes in each row. Tile operations also fully zero any rows after the first 10 configured rows. When using 1K tile with 64-byte rows, there would be 16 rows, so in this example, the last 6 rows would also be zeroed.

In some examples, a context restore instruction (e.g., XRSTOR), when loading data, enforces that the data beyond the configured rows for a tile will be maintained as zero. If there is no valid configuration, all rows are zeroed. XRSTOR of tile data can load garbage in the columns beyond those configured. It should not be possible for XRSTOR to clear beyond the number of columns configured because there is not an element width associated with the tile configuration.

Context save (e.g., XSAVE) exposes the entire TILE storage area when writing it to memory. If XRSTOR loaded garbage data into the rightmost part of a tile, that data will be saved by XSAVE. XSAVE will write zeros for rows beyond the number specified for each tile.

In some examples, tile instructions are restartable. The operations that access memory allow restart after page faults. The computational instructions that deal with floating point operations also allow for unmasked floating-point exceptions, with the masking of the exceptions controlled by a control and/or status register.

To support restarting instructions after these events, the instructions store information in the start registers detailed below.

### Matrix (Tile) Operation Systems

### Exemplary Hardware Support

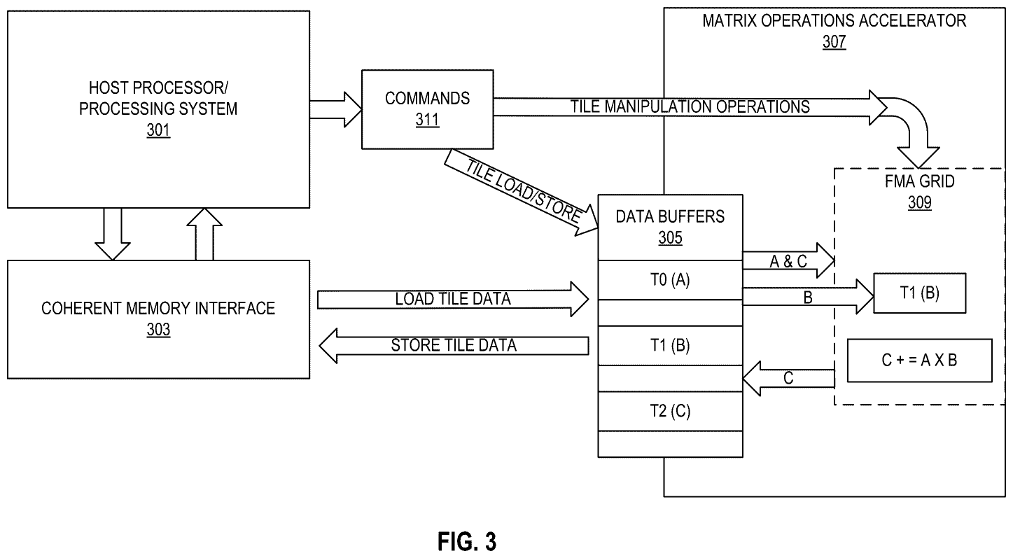

FIG. 3 illustrates an example of a system utilizing a matrix (tile) operations accelerator. In this illustration, a host processor/processing system 301 communicates commands 311 (e.g., matrix manipulation operations such as arithmetic or matrix manipulation operations, or load and store operations) to a matrix operations accelerator 307. However, this is shown this way for discussion purposes only. As detailed later, this accelerator 307 may be a part of a processing core. Typically, commands 311 that are tile manipulation operator instructions will refer to tiles as register-register (“reg-reg”) or register-memory (“reg-mem”) format. Other commands such as TILESTORE, TILELOAD, TILECONFIG, etc., do not perform data operations on a tile. Commands may be decoded instructions (e.g., micro-ops) or macro-instructions for the accelerator 307 to handle.

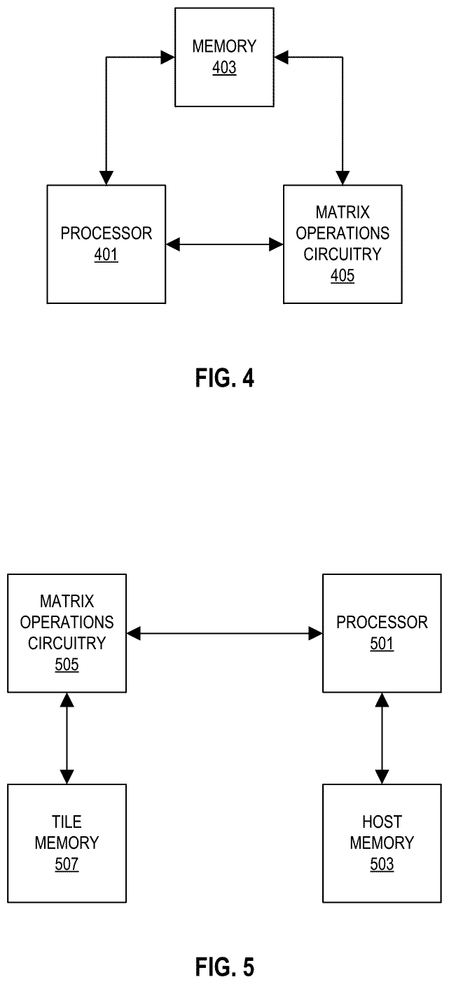

In this example, a coherent memory interface 303 is coupled to the host processor/processing system 301 and matrix operations accelerator 307 such that they can share memory. FIGS. 4 and 5 show different examples of how memory is shared using a matrix operations accelerator. As shown in FIG. 4, the host processor 401 and matrix operations accelerator circuitry 405 share the same memory 403. FIG. 5 illustrates an example where the host processor 501 and matrix operations accelerator 505 do not share memory but can access each other's memory. For example, processor 501 can access tile memory 507 and utilize its host memory 503 as normal. Similarly, the matrix operations accelerator 505 can access host memory 503, but more typically uses its own memory 507. Note these memories may be of different types.

In some examples, tiles are supported using an overlay over physical registers. For example, a tile may utilize 16 1,024-bit registers, 32 512-bit registers, etc. depending on the implementation. In some examples, the matrix operations utilize 2-dimensional (2-D) data structures representing one or more packed regions of memory such as registers. Throughout this description, these 2-D data structures are referred to as tiles or tile registers.

In some examples, the matrix operations accelerator 307 includes a plurality of FMAs 309 coupled to data buffers 305 (in some implementations, one or more of these buffers 305 are stored in the FMAs of the grid as shown). The data buffers 305 buffer tiles loaded from memory and/or tiles to be stored to memory (e.g., using a tileload or tilestore instruction). Data buffers may be, for example, a plurality of registers. Typically, these FMAs are arranged as a grid of chained FMAs 309 which are able to read and write tiles. In this example, the matrix operations accelerator 307 is to perform a matrix multiply operation using tiles T0, T1, and T2. At least one of tiles is housed in the FMA grid 309. In some examples, all tiles in an operation are stored in the FMA grid 309. In other examples, only a subset is stored in the FMA grid 309. As shown, T1 is housed and T0 and T2 are not. Note that A, B, and C refer to the matrices of these tiles which may or may not take up the entire space of the tile.

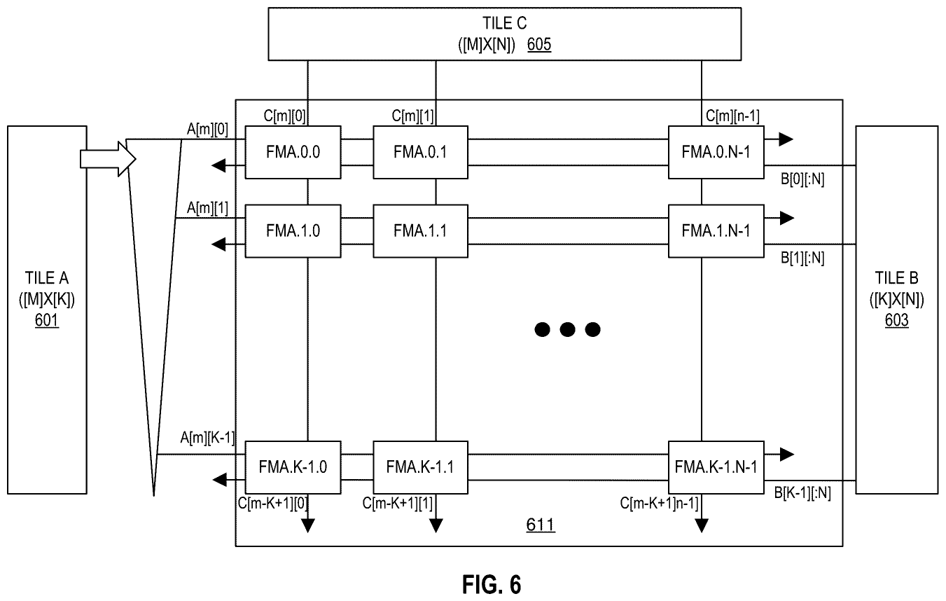

FIG. 6 illustrates an example of matrix multiply accumulate operation using tiles (“TMMA”).

The number of rows in the matrix (TILE A 601) matches the number of serial (chained) FMAs comprising the computation's latency in certain examples. An implementation is free to recirculate on a grid of smaller height, but the computation remains the same.

The source/destination vector comes from a tile of N rows (TILE C 605) and the grid of FMAs 611 performs N vector-matrix operations resulting in a complete instruction performing a matrix multiplication of tiles. Tile B 603 is the other vector source and supplies “broadcast” terms to the FMAs in each stage.

In operation, in some examples, the elements of matrix B (stored in a tile B 603) are spread across the rectangular grid of FMAs. Matrix B (stored in tile A 601) has its elements of a row transformed to match up with the columnar dimension of the rectangular grid of FMAs. At each FMA in the grid, an element of A and B are multiplied and added to the incoming summand (from above in the Figure) and the outgoing sum is passed to the next row of FMAs (or the final output).

The latency of a single step is proportional to K (row height of matrix B) and dependent TMMAs typically have enough source-destination rows (either in a single tile or across tile) to hide that latency. An implementation may also split the SIMD (packed data element) dimension M (row height of matrix A) across time steps, but this simply changes the constant that K is multiplied by. When a program specifies a smaller K than the maximum enumerated by the TMMA, an implementation is free to implement this with “masking” or “early outs.”

The latency of an entire TMMA is proportional to N*K. The repeat rate is proportional to N. The number of MACs per TMMA instruction is N*K*M.

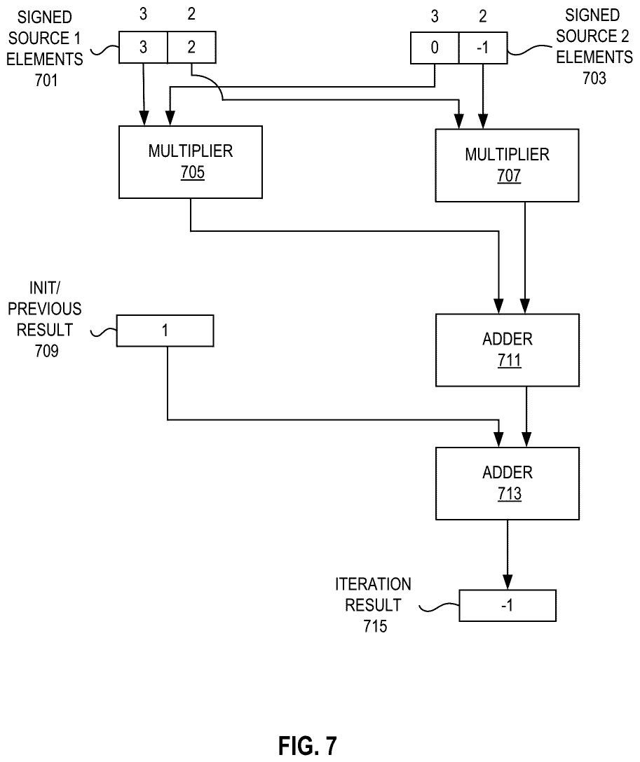

FIG. 7 illustrates an example of a subset of the execution of an iteration of a chained fused multiply accumulate instruction. In particular, this illustrates execution circuitry of an iteration of one packed data element position of the destination. In this example, the chained fused multiply accumulate is operating on signed sources wherein the accumulator is 2× the input data size.

A first signed source (source 1 701) and a second signed source (source 2 703) each have four packed data elements. Each of these packed data elements stores signed data such as floating-point data. A third signed source (source 3 709) has two packed data elements, each of which stores signed data. The sizes of the first and second signed sources 701 and 703 are half that of the third signed source (initial value or previous result) 709. For example, the first and second signed sources 701 and 703 could have 32-bit packed data elements (e.g., single precision floating point) while the third signed source 709 could have 64-bit packed data elements (e.g., double precision floating point).

In this illustration, only the two most significant packed data element positions of the first and second signed sources 701 and 703 and the most significant packed data element position of the third signed source 709 are shown. Of course, the other packed data element positions would also be processed.

As illustrated, packed data elements are processed in pairs. For example, the data of the most significant packed data element positions of the first and second signed sources 701 and 703 are multiplied using a multiplier circuit 705, and the data from second most significant packed data element positions of the first and second signed sources 701 and 703 are multiplied using a multiplier circuit 707. In some examples, these multiplier circuits 705 and 707 are reused for other packed data elements positions. In other examples, additional multiplier circuits are used so that the packed data elements are processed in parallel. In some contexts, parallel execution is done using lanes that are the size of the signed third source 709. The results of each of the multiplications are added using addition circuitry 711.

The result of the addition of the results of the multiplications is added to the data from most significant packed data element position of the signed source 3 709 (using a different adder 713 or the same adder 711).

Finally, the result of the second addition is either stored into the signed destination 715 in a packed data element position that corresponds to the packed data element position used from the signed third source 709 or passed on to the next iteration if there is one. In some examples, a writemask is applied to this storage such that if a corresponding writemask (bit) is set, the storage happens, and, if not set, the storage does not happen.

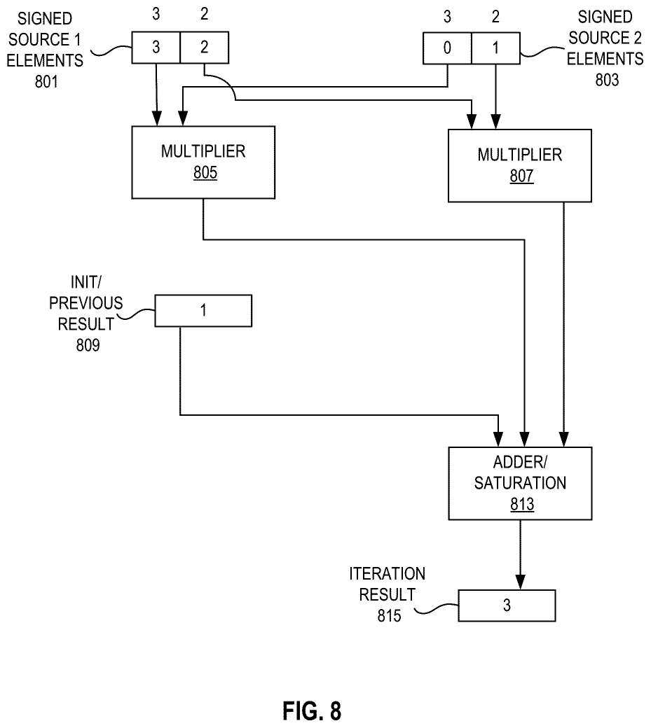

FIG. 8 illustrates an example of a subset of the execution of an iteration of a chained fused multiply accumulate instruction. In particular, this illustrates execution circuitry of an iteration of one packed data element position of the destination. In this example, the chained fused multiply accumulate is operating on signed sources wherein the accumulator is 2× the input data size.

A first signed source (source 1 801) and a second signed source (source 2 803) each have four packed data elements. Each of these packed data elements stores signed data such as integer data. A third signed source (source 3 809) has two packed data elements, each of which stores signed data. The sizes of the first and second signed sources 801 and 803 are half that of the third signed source 809. For example, the first and second signed sources 801 and 803 could have 32-bit packed data elements (e.g., single precision floating point) the third signed source 809 could have 64-bit packed data elements (e.g., double precision floating point).

In this illustration, only the two most significant packed data element positions of the first and second signed sources 801 and 803 and the most significant packed data element position of the third signed source 809 are shown. Of course, the other packed data element positions would also be processed.

As illustrated, packed data elements are processed in pairs. For example, the data of the most significant packed data element positions of the first and second signed sources 801 and 803 are multiplied using a multiplier circuit 805, and the data from second most significant packed data element positions of the first and second signed sources 801 and 803 are multiplied using a multiplier circuit 807. In some examples, these multiplier circuits 805 and 807 are reused for other packed data elements positions. In other examples, additional multiplier circuits are used so that the packed data elements are processed in parallel. In some contexts, parallel execution is done using lanes that are the size of the signed third source (initial value or previous iteration result) 809. The results of each of the multiplications are added to the signed third source 809 using addition/saturation circuitry 813.

Addition/saturation (accumulator) circuitry 813 preserves a sign of an operand when the addition results in a value that is too big. In particular, saturation evaluation occurs on the infinite precision result between the multi-way-add and the write to the destination or next iteration. When the accumulator 813 is floating point and the input terms are integer, the sum of products and the floating-point accumulator input value are turned into infinite precision values (fixed-point numbers of hundreds of bits), the addition of the multiplication results and the third input is performed, and a single rounding to the actual accumulator type is performed.

Unsigned saturation means the output values are limited to a maximum unsigned number for that element width (all 1s). Signed saturation means a value is limited to the be in the range between a minimum negative number and a max positive number for that element width (for bytes for example, the range is from −128 (=−2\hat{ }7) to 127 (=2\hat{ }7−1)).

The result of the addition and saturation check is stored into the signed result 815 in a packed data element position that corresponds to the packed data element position used from the signed third source 809 or passed on to the next iteration if there is one. In some examples, a writemask is applied to this storage such that if a corresponding writemask (bit) is set, the storage happens, and, if not set, the storage does not happen.

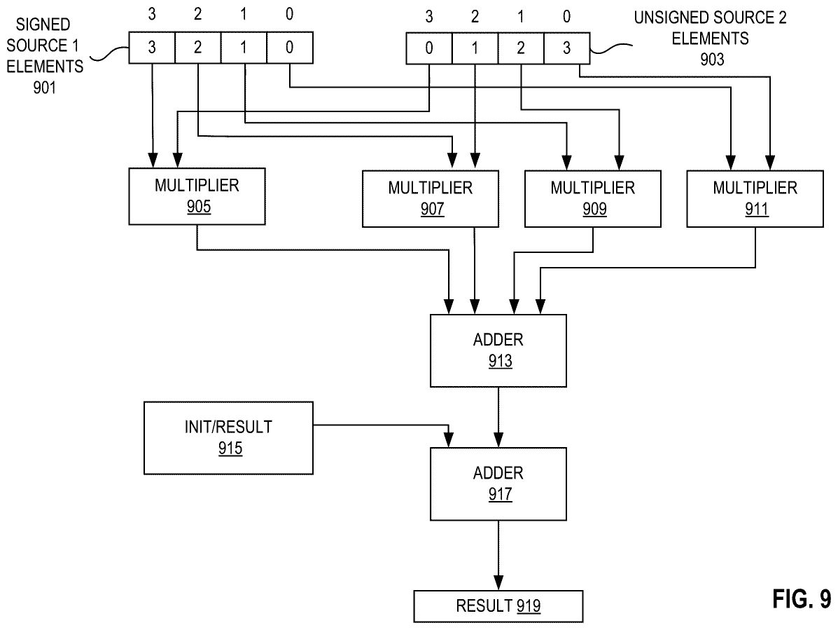

FIG. 9 illustrates an example of a subset of the execution of an iteration of a chained fused multiply accumulate instruction. In particular, this illustrates execution circuitry of an iteration of one packed data element position of the destination. In this example, the chained fused multiply accumulate is operating on a signed source and an unsigned source wherein the accumulator is 4× the input data size.

A first signed source (source 1 901) and a second unsigned source (source 2 903) each have four packed data elements. Each of these packed data elements has data such as floating point or integer data. A third signed source (initial value or result 915) has a packed data element of which stores signed data. The sizes of the first and second sources 901 and 903 are a quarter of the third signed source 915. For example, the first and second sources 901 and 903 could have 16-bit packed data elements (e.g., word) and the third signed source 915 could have 64-bit packed data elements (e.g., double precision floating point or 64-bit integer).

In this illustration, the four most significant packed data element positions of the first and second sources 901 and 903 and the most significant packed data element position of the third signed source 915 are shown. Of course, other packed data element positions would also be processed if there are any.

As illustrated, packed data elements are processed in quadruplets. For example, the data of the most significant packed data element positions of the first and second sources 901 and 903 are multiplied using a multiplier circuit 905, data from second most significant packed data element positions of the first and second sources 901 and 903 are multiplied using a multiplier circuit 907, data from third most significant packed data element positions of the first and second sources 901 and 903 are multiplied using a multiplier circuit 909, and data from the least significant packed data element positions of the first and second sources 901 and 903 are multiplied using a multiplier circuit 911. In some examples, the signed packed data elements of the first source 901 are sign extended and the unsigned packed data elements of the second source 903 are zero extended prior to the multiplications.

In some examples, these multiplier circuits 905-911 are reused for other packed data elements positions. In other examples, additional multiplier circuits are used so that the packed data elements are processed in parallel. In some contexts, parallel execution is done using lanes that are the size of the signed third source 915. The results of each of the multiplications are added using addition circuitry 913.

The result of the addition of the results of the multiplications is added to the data from most significant packed data element position of the signed source 3 915 (using a different adder 917 or the same adder 913).

Finally, the result 919 of the second addition is either stored into the signed destination in a packed data element position that corresponds to the packed data element position used from the signed third source 915 or passed to the next iteration. In some examples, a writemask is applied to this storage such that if a corresponding writemask (bit) is set, the storage happens, and, if not set, the storage does not happen.

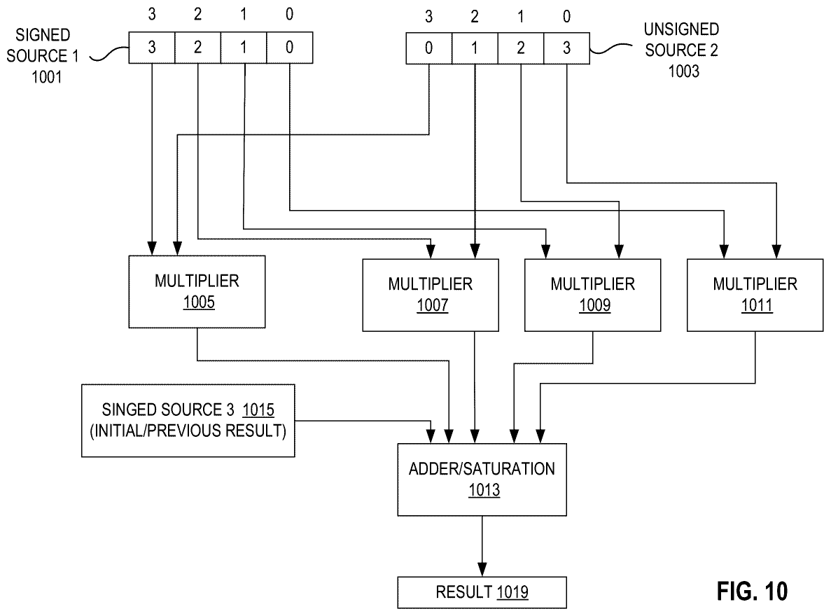

FIG. 10 illustrates an example of a subset of the execution of an iteration of chained fused multiply accumulate instruction. In particular, this illustrates execution circuitry of an iteration of one packed data element position of the destination. In this example, the chained fused multiply accumulate is operating on a signed source and an unsigned source wherein the accumulator is 4× the input data size.

A first signed source 1001 and a second unsigned source 1003 each have four packed data elements. Each of these packed data elements stores data such as floating point or integer data. A third signed source 1015 (initial or previous result) has a packed data element of which stores signed data. The sizes of the first and second sources are a quarter of the third signed source 1015 (initial or previous result). For example, the first and second sources could have 16-bit packed data elements (e.g., word) and the third signed source 1015 (initial or previous result) could have 64-bit packed data elements (e.g., double precision floating point or 64-bit integer).

In this illustration, the four most significant packed data element positions of the first signed source 1001 and the second unsigned source 1003 and the most significant packed data element position of the third signed source 1015 are shown. Of course, other packed data element positions would also be processed if there are any.

As illustrated, packed data elements are processed in quadruplets. For example, the data of the most significant packed data element positions of the first signed source 1001 and the second unsigned source 1003 are multiplied using a multiplier circuit 1005, data from second most significant packed data element positions of the first signed source 1001 and the second unsigned source 1003 are multiplied using a multiplier circuit 1007, data from third most significant packed data element positions of the first signed source 1001 and the second unsigned source 1003 are multiplied using a multiplier circuit 1009, and data from the least significant packed data element positions of the first signed source 1001 and the second unsigned source 1003 are multiplied using a multiplier circuit 1011. In some examples, the signed packed data elements of the first signed source 1001 are sign extended and the unsigned packed data elements of the second unsigned source 1003 are zero extended prior to the multiplications.

In some examples, these multiplier circuits 1005-1011 are reused for other packed data elements positions. In other examples, additional multiplier circuits are used so that the packed data elements are processed in parallel. In some contexts, parallel execution is done using lanes that are the size of third signed source 1015 (initial or previous result). The result of the addition of the results of the multiplications is added to the data from most significant packed data element position of third signed source 1015 (initial or previous result) using adder/saturation 1013 circuitry.

Addition/saturation (accumulator) circuitry 1013 preserves a sign of an operand when the addition results in a value that is too big or too small for signed saturation. In particular, saturation evaluation occurs on the infinite precision result between the multi-way-add and the write to the destination. When the accumulator 1013 is floating point and the input terms are integer, the sum of products and the floating-point accumulator input value are turned into infinite precision values (fixed-point numbers of hundreds of bits), the addition of the multiplication results and the third input is performed, and a single rounding to the actual accumulator type is performed.

The result 1019 of the addition and saturation check is stored into the signed destination in a packed data element position that corresponds to the packed data element position used from third signed source 1015 (initial or previous result) or passed to the next iteration. In some examples, a writemask is applied to this storage such that if a corresponding writemask (bit) is set, the storage happens, and, if not set, the storage does not happen.

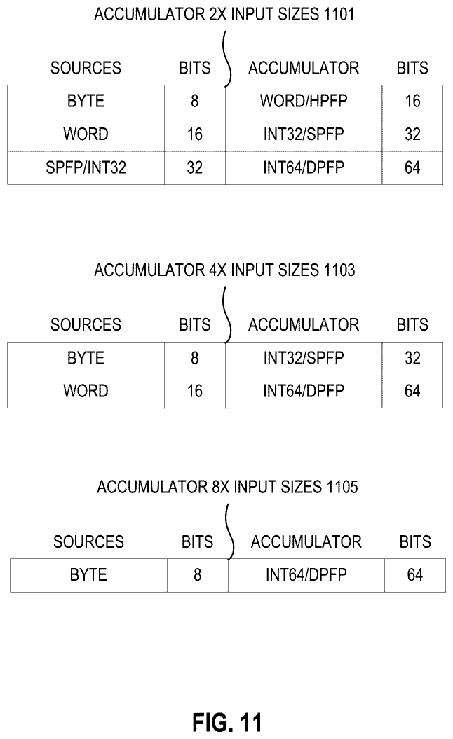

FIG. 11 illustrates power-of-two sized SIMD implementations wherein the accumulators use input sizes that are larger than the inputs to the multipliers according to an example. Note the source (to the multipliers) and accumulator values may be signed or unsigned values. For an accumulator having 2× input sizes (in other words, the accumulator input value is twice the size of the packed data element sizes of the sources), table 1101 illustrates different configurations. For byte sized sources, the accumulator uses word or half-precision floating-point (HPFP) values that are 16-bit in size. For word sized sources, the accumulator uses 32-bit integer or single-precision floating-point (SPFP) values that are 32-bit in size. For SPFP or 32-bit integer sized sources, the accumulator uses 64-integer or double-precision floating-point (DPFP) values that are 64-bit in size.

For an accumulator having 4× input sizes (in other words, the accumulator input value is four times the size of the packed data element sizes of the sources), table 1103 illustrates different configurations. For byte sized sources, the accumulator uses 32-bit integer or single-precision floating-point (SPFP) values that are 32-bit in size. For word sized sources, the accumulator uses 64-bit integer or double-precision floating-point (DPFP) values that are 64-bit in size in some examples.

For an accumulator having 8× input sizes (in other words, the accumulator input value is eight times the size of the packed data element sizes of the sources), table 1105 illustrates a configuration. For byte sized sources, the accumulator uses 64-bit integer.

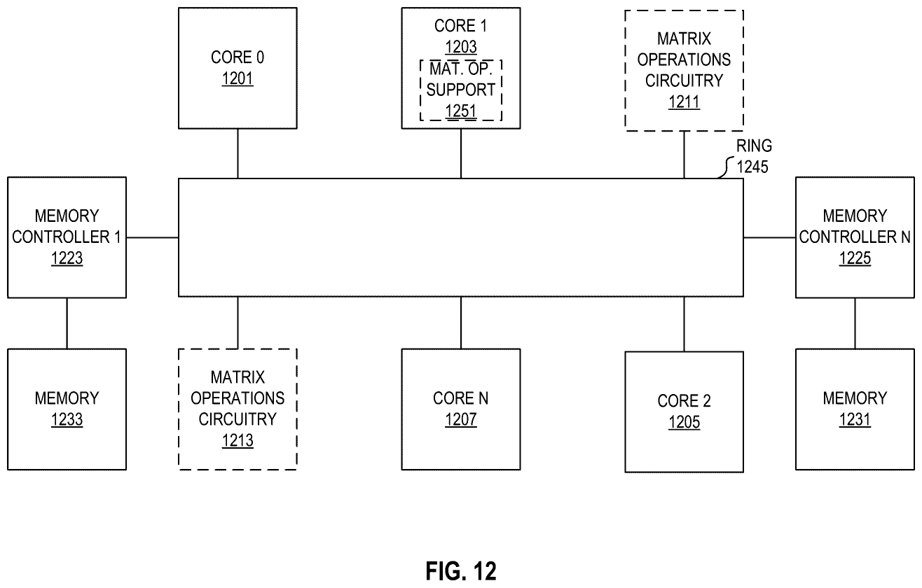

As hinted at earlier, matrix operations circuitry may be included in a core, or as an external accelerator. FIG. 12 illustrates an example of a system utilizing matrix operations circuitry. In this illustration, multiple entities are coupled with a ring interconnect 1245.

A plurality of cores, core 0 1201, core 1 1203, core 2 1205, and core N 1207 provide non-tile-based instruction support. In some examples, matrix operations circuitry 1251 is provided in a core 1203, and in other examples matrix operations circuitries 1211 and 1213 are accessible on the ring interconnect 1245.

Additionally, one or more memory controllers 1223-1225 are provided to communicate with memory 1233 and 1231 on behalf of the cores and/or matrix operations circuitry.

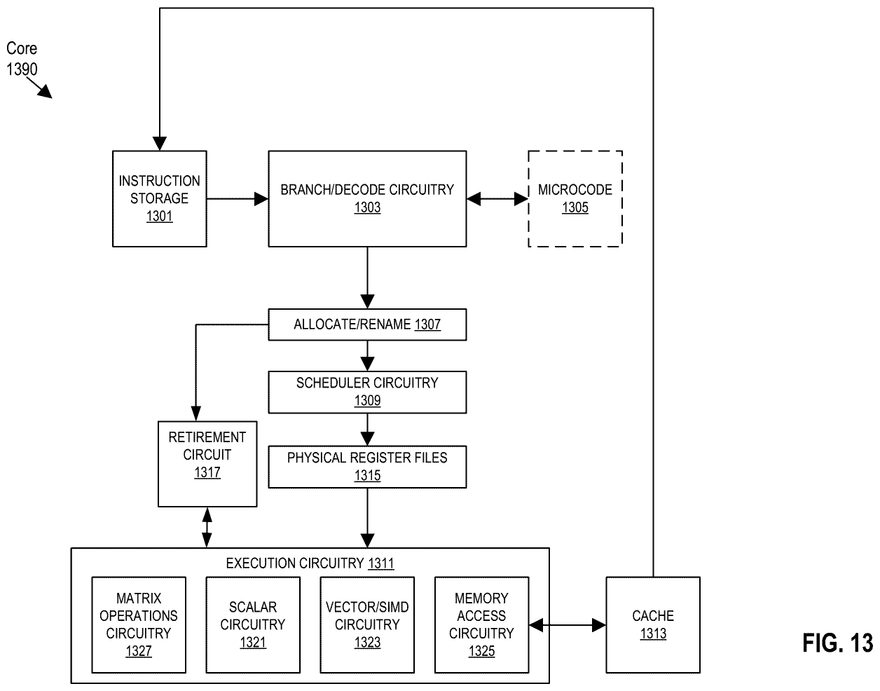

FIG. 13 illustrates an example of a processor core pipeline supporting matrix operations using tiles. Branch prediction and decode circuitry 1303 performs branch predicting of instructions, decoding of instructions, and/or both from instructions stored in instruction storage 1301. For example, instructions detailed herein may be stored in instruction storage. In some implementations, separate circuitry is used for branch prediction and in some examples, at least some instructions are decoded into one or more micro-operations, micro-code entry points, microinstructions, other instructions, or other control signals using microcode 1305. The branch prediction and decode circuitry 1303 may be implemented using various different mechanisms. Examples of suitable mechanisms include, but are not limited to, look-up tables, hardware implementations, programmable logic arrays (PLAs), microcode read only memories (ROMs), etc.

The branch prediction and decode circuitry 1303 is coupled to allocate/rename 1307 circuitry which is coupled, in some examples, to scheduler circuitry 1309. In some examples, these circuits provide register renaming, register allocation, and/or scheduling functionality by performing one or more of: 1) renaming logical operand values to physical operand values (e.g., a register alias table in some examples), 2) allocating status bits and flags to the decoded instruction, and 3) scheduling the decoded instruction for execution on execution circuitry out of an instruction pool (e.g., using a reservation station in some examples).

The scheduler circuitry 1309 represents any number of different schedulers, including reservations stations, central instruction window, etc. The scheduler circuitry 1309 is coupled to, or includes, physical register file(s) 1315. Each of the physical register file(s) 1315 represents one or more physical register files, different ones of which store one or more different data types, such as scalar integer, scalar floating point, packed integer, packed floating point, vector integer, vector floating point, status (e.g., an instruction pointer that is the address of the next instruction to be executed), tiles, etc. In one example, the physical register file(s) 1315 comprises vector registers circuitry, write mask registers circuitry, and scalar registers circuitry. These register circuits may provide architectural vector registers, vector mask registers, and general-purpose registers. The physical register file(s) 1315 is overlapped by a retirement circuit 1317 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement circuit 1317 and the physical register file(s) 1315 are coupled to the execution circuitry 1311.

While register renaming is described in the context of out-of-order execution, it should be understood that register renaming may be used in an in-order architecture. While the illustrated example of the processor may also include separate instruction and data cache units and a shared L2 cache unit, alternative examples may have a single internal cache for both instructions and data, such as, for example, a Level 1 (L1) internal cache, or multiple levels of internal cache. In some examples, the system may include a combination of an internal cache and an external cache that is external to the core and/or the processor. Alternatively, all of the cache may be external to the core and/or the processor.

The execution circuitry 1311 is a set of one or more execution circuits, including scalar circuitry 1321, vector/SIMD circuitry 1323, and matrix operations circuitry 1327, as well as memory access circuitry 1325 to access cache 1313. The execution circuits perform various operations (e.g., shifts, addition, subtraction, multiplication) and on various types of data (e.g., scalar floating point, packed integer, packed floating point, vector integer, vector floating point). While some examples may include a number of execution units dedicated to specific functions or sets of functions, other examples may include only one execution unit or multiple execution units that all perform all functions. The scalar circuitry 1321 performs scalar operations, the vector/SIMD circuitry 1323 performs vector/SIMD operations, and matrix operations circuitry 1327 performs matrix (tile) operations detailed herein.

By way of example, the exemplary register renaming, out-of-order issue/execution core architecture may implement a pipeline as follows: 1) an instruction fetch circuit performs fetch and length decoding stages; 2) the branch and decode circuitry 1303 performs a decode stage; 3) the allocate/rename 1307 circuitry performs an allocation stage and renaming stage; 4) the scheduler circuitry 1309 performs a schedule stage; 5) physical register file(s) (coupled to, or included in, the scheduler circuitry 1309 and allocate/rename 1307 circuitry and a memory unit perform a register read/memory read stage; the execution circuitry 1311 performs an execute stage; 6) a memory unit and the physical register file(s) unit(s) perform a write back/memory write stage; 7) various units may be involved in the exception handling stage; and 8) a retirement unit and the physical register file(s) unit(s) perform a commit stage.

The core may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one example, the core 1390 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

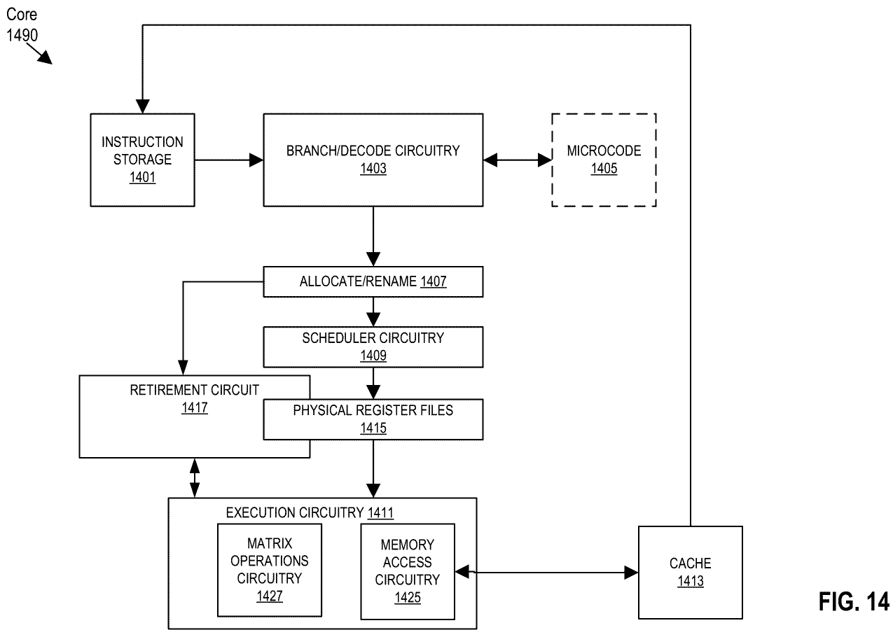

FIG. 14 illustrates an example of a processor core pipeline supporting matrix operations using tiles. Branch prediction and decode circuitry 1403 performs branch predicting of instructions, decoding of instructions, and/or both from instructions stored in instruction storage 1401. For example, instructions detailed herein may be stored in instruction storage. In some implementations, separate circuitry is used for branch prediction and in some examples, at least some instructions are decoded into one or more micro-operations, micro-code entry points, microinstructions, other instructions, or other control signals using microcode 1405. The branch prediction and decode circuitry 1403 may be implemented using various different mechanisms. Examples of suitable mechanisms include, but are not limited to, look-up tables, hardware implementations, programmable logic arrays (PLAs), microcode read only memories (ROMs), etc.

The branch prediction and decode circuitry 1403 is coupled to allocate/rename 1407 circuitry which is coupled, in some examples, to scheduler circuitry 1409. In some examples, these circuits provide register renaming, register allocation, and/or scheduling functionality by performing one or more of: 1) renaming logical operand values to physical operand values (e.g., a register alias table in some examples), 2) allocating status bits and flags to the decoded instruction, and 3) scheduling the decoded instruction for execution on execution circuitry out of an instruction pool (e.g., using a reservation station in some examples).

The scheduler circuitry 1409 represents any number of different schedulers, including reservations stations, central instruction window, etc. The scheduler unit(s) scheduler circuitry 1409 is coupled to, or includes, physical register file(s) 1415. Each of the physical register file(s) 1415 represents one or more physical register files, different ones of which store one or more different data types, such as scalar integer, scalar floating point, packed integer, packed floating point, vector integer, vector floating point, status (e.g., an instruction pointer that is the address of the next instruction to be executed), tiles, etc. In one example, the physical register file(s) 1415 comprises vector registers circuitry, write mask registers circuitry, and scalar registers circuitry. These register circuits may provide architectural vector registers, vector mask registers, and general-purpose registers. The physical register file(s) 1415 is overlapped by a retirement circuit 1417 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement circuit 1417 and the physical register file(s) 1415 are coupled to the execution circuitry 1411.

While register renaming is described in the context of out-of-order execution, it should be understood that register renaming may be used in an in-order architecture. While the illustrated example of the processor may also include separate instruction and data cache units and a shared L2 cache unit, alternative examples may have a single internal cache for both instructions and data, such as, for example, a Level 1 (L1) internal cache, or multiple levels of internal cache. In some examples, the system may include a combination of an internal cache and an external cache that is external to the core and/or the processor. Alternatively, all of the cache may be external to the core and/or the processor.

The execution circuitry 1411 a set of one or more execution circuits 1427 and a set of one or more memory access circuits 1425 to access cache 1413. The execution circuits 1427 perform matrix (tile) operations detailed herein.

By way of example, the exemplary register renaming, out-of-order issue/execution core architecture may implement a pipeline as follows: 1) an instruction fetch circuit performs fetch and length decoding stages; 2) the branch and decode circuitry 1403 performs a decode stage; 3) the allocate/rename 1407 circuitry performs an allocation stage and renaming stage; 4) the scheduler circuitry 1409 performs a schedule stage; 5) physical register file(s) (coupled to, or included in, the scheduler circuitry 1409 and allocate/rename 1407 circuitry and a memory unit perform a register read/memory read stage; the execution circuitry 1411 performs an execute stage; 6) a memory unit and the physical register file(s) unit(s) perform a write back/memory write stage; 7) various units may be involved in the exception handling stage; and 8) a retirement unit and the physical register file(s) unit(s) perform a commit stage.

The core may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one example, the core 1490 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

### Layout

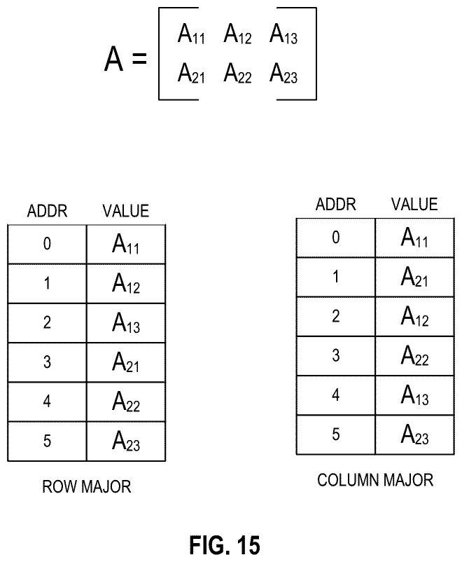

Throughout this description, data is expressed using row major data layout. Column major users should translate the terms according to their orientation. FIG. 15 illustrates an example of a matrix expressed in row major format and column major format. As shown, matrix A is a 2×3 matrix. When this matrix is stored in row major format, the data elements of a row are consecutive. When this matrix is stored in column major format, the data elements of a column are consecutive. It is a well-known property of matrices that AT*BT=(BA) T, where superscript T means transform. Reading column major data as row major data results in the matrix looking like the transform matrix.

In some examples, row-major semantics are utilized in hardware, and column major data is to swap the operand order with the result being transforms of matrix, but for subsequent column-major reads from memory it is the correct, non-transformed matrix.

For example, if there are two column-major matrices to multiply:

| a b | | g i k | ag + bh ai + bj ak + bl |
|---|---|---|---|
| c d * | h j l= | cg + dh ci + dj ck + dl | |
| e f | | eg + fh ei + fj ek + fl | |
| (3 × 2) | (2 × 3) | (3 × 3) | |

The input matrices would be stored in linear memory (column-major) as:
a c e b d f
and
g h i j k l.

Reading those matrices as row-major with dimensions 2×3 and 3×2, they would appear as:

| | | |
|---|---|---|
| a c e | and | g h |
| b d f | | i j |
| k l | | |

Swapping the order and matrix multiplying:

| | | | |
|---|---|---|---|
| g h | | a c e | ag + bh cg + dh eg + fh |
| i j | * | b d f= | ai + bj ci + dj ei + fj |
| k l | | | ak + bl ck + dl ek + fl |

The transform matrix is out and can then be stored in in row-major order:
ag+bh cg+dh eg+fh ai+bj ci+dj ei+fj ak+bl ck+dl ek+fl

and used in subsequent column major computations, it is the correct un-transformed matrix:

| | | |
|---|---|---|
| ag + bh | ai + bj | ak + bl |
| cg + dh | ci + dj | ck + dl |
| eg + fh | ei + fj | ek + fl |

### Exemplary Usage

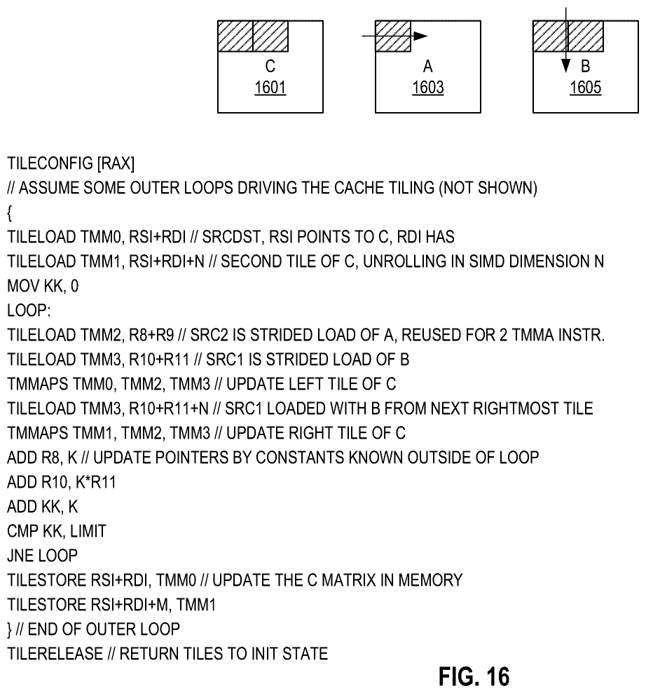

FIG. 16 illustrates an example of usage of matrices (tiles). In this example, matrix C 1601 includes two tiles, matrix A 1603 includes one tile, and matrix B 1605 includes two tiles. This figure shows an example of the inner loop of an algorithm to compute a matrix multiplication. In this example, two result tiles, tmm0 and tmm1, from matrix C 1601 are used to accumulate the intermediate results. One tile from the matrix A 1603 (tmm2) is re-used twice as it multiplied by two tiles from matrix B 1605. Pointers to load a new A matrix (tile) and two new B matrices (tiles) from the directions indicated by the arrows. An outer loop, not shown, adjusts the pointers for the C tiles.

The exemplary code as shown includes the usage of a tile configuration instruction and is executed to configure tile usage, load tiles, a loop to process the tiles, store tiles to memory, and release tile usage.

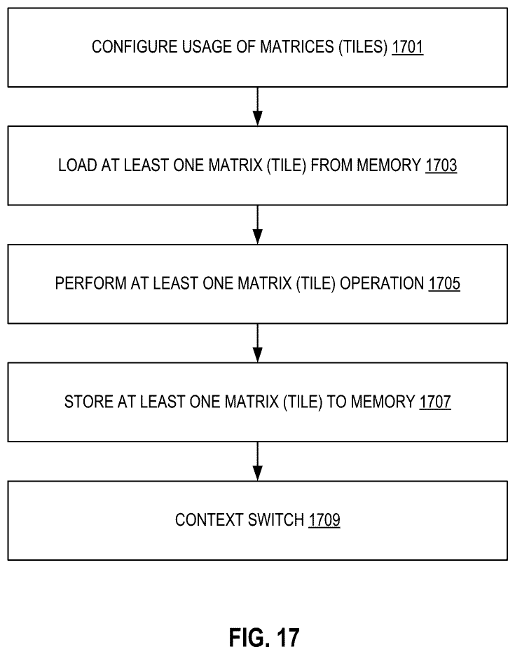

FIG. 17 illustrates an example of usage of matrices (tiles). At 1701, tile usage is configured. For example, a TILECONFIG instruction is executed to configure tile usage including setting a number of rows and columns per tile. Typically, at least one matrix (tile) is loaded from memory at 1703. At least one matrix (tile) operation is performed at 1705 using the matrices (tiles). At 1707, at least one matrix (tile) is stored out to memory and a context switch can occur at 1709.

### Exemplary Configuration

### Tile Configuration Hardware Support

As discussed above, tile usage typically needs to be configured prior to use. For example, full usage of all rows and columns may not be needed. Not only does not configuring these rows and columns save power in some examples, but the configuration may be used to determine if an operation will generate an error. For example, a matrix multiplication of the form (N×M)*(L×N) will typically not work if M and L are not the same.

Prior to using matrices using tiles, in some examples, tile support is to be configured. For example, how many rows and columns per tile, tiles that are to be used, etc. are configured. A TILECONFIG instruction is an improvement to a computer itself as it provides for support to configure the computer to use a matrix accelerator (either as a part of a processor core, or as an external device). In particular, an execution of the TILECONFIG instruction causes a configuration to be retrieved from memory and applied to matrix (tile) settings within a matrix accelerator.

### Tile Usage Configuration

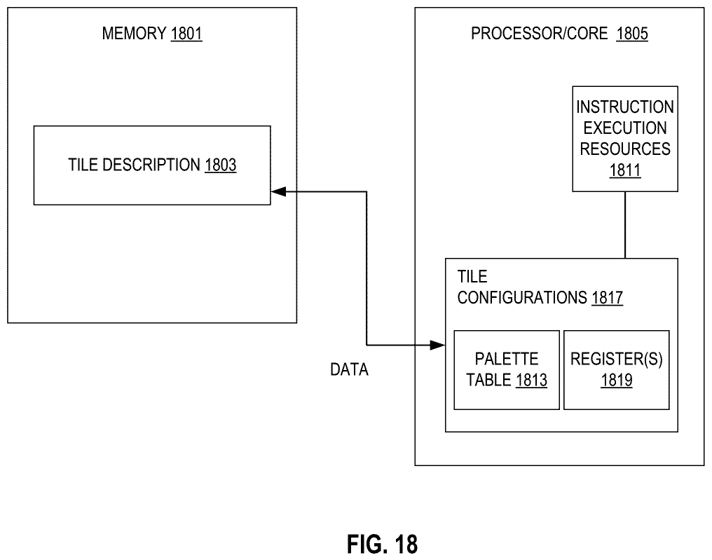

FIG. 18 illustrates support for configuration of the usage of tiles according to an example. A memory 1801 contains the tile description 1803 of the matrices (tiles) to be supported.

Instruction execution resources 1811 of a processor/core 1805 stores aspects of a tile description 1803 into tile configurations 1817. The tile configurations 1817 include palette table 1813 to detail what tiles for a palette are configured (the number of rows and columns in each tile) and a marking that matrix support is in use. In particular, instruction execution resources 1811 are configured to use tiles as specified by the tile configurations 1817. The instruction execution resources 1811 may also include a machine specific register or configuration register to indicate tile usage. Additional values such as in-use and start values are also set. The tile configurations 1817 utilize register(s) 1819 to store tile usage and configuration information.

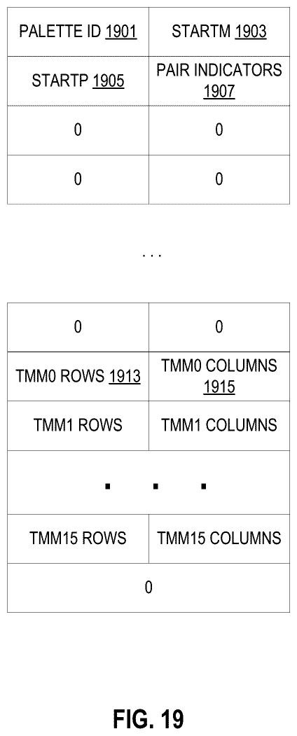

FIG. 19 illustrates an example of a description of the matrices (tiles) to be supported. This is the description that is to be stored upon an execution of a STTILECFG instruction. In this example, each field is a byte. In byte [0], a palette ID 1901 is stored. The palette ID is used to index a palette table 1813 which stores, per palette ID, a number of bytes in a tile, and bytes per row of the tiles that are associated with this ID as defined by the configuration.

Byte 1 stores a value to be stored in a “startRow” register 1903 and byte 2 stores a value to be stored in a register, startP 1905. To support restarting instructions after these events, the instructions store information these registers. To support restarting instructions after break events such as those detailed above, the instructions store information in these registers. The startRow value indicates the row that should be used for restart. The startP value indicates the position within the row for store operations when pairs are used and, in some examples, indicates the lower half of the row (in the lower tile of a pair) or higher half of the row (in the higher tile of a pair). Generally, the position in the row (the column) is not needed.

With the exception of TILECONFIG and STTILECFG, successfully executing matrix (tile) instructions will set both startRow and startP to zero.

Any time an interrupted matrix (tile) instruction is not restarted, it is the responsibility of software to zero the startRow and startP values. For example, unmasked floating point exception handlers might decide to finish the operation in software and change the program counter value to another instruction, usually the next instruction. In this case the software exception handler must zero the startRow and startP values in the exception presented to it by the operating system before resuming the program. The operating system will subsequently reload those values using a restore instruction.

Byte 3 stores an indication of pairs (1b per tile) of tiles 1907.

Bytes 16-17 store the number of rows 1913 and columns 1915 for tile 0, bytes 18-19 store the number of rows and columns for tile 1, etc. In other words, each 2-byte group specifies a number of rows and columns for a tile. If a group of 2 bytes is not used to specify tile parameters, they should have the value zero. Specifying tile parameters for more tiles than the implementation limit or the palette limit results in a fault. Unconfigured tiles are set to an initial state with 0 rows, 0 columns.

Finally, the configuration in memory typically ends with an ending delineation such as all zeros for several consecutive bytes.

### Exemplary Tile and Tile Configuration Storage

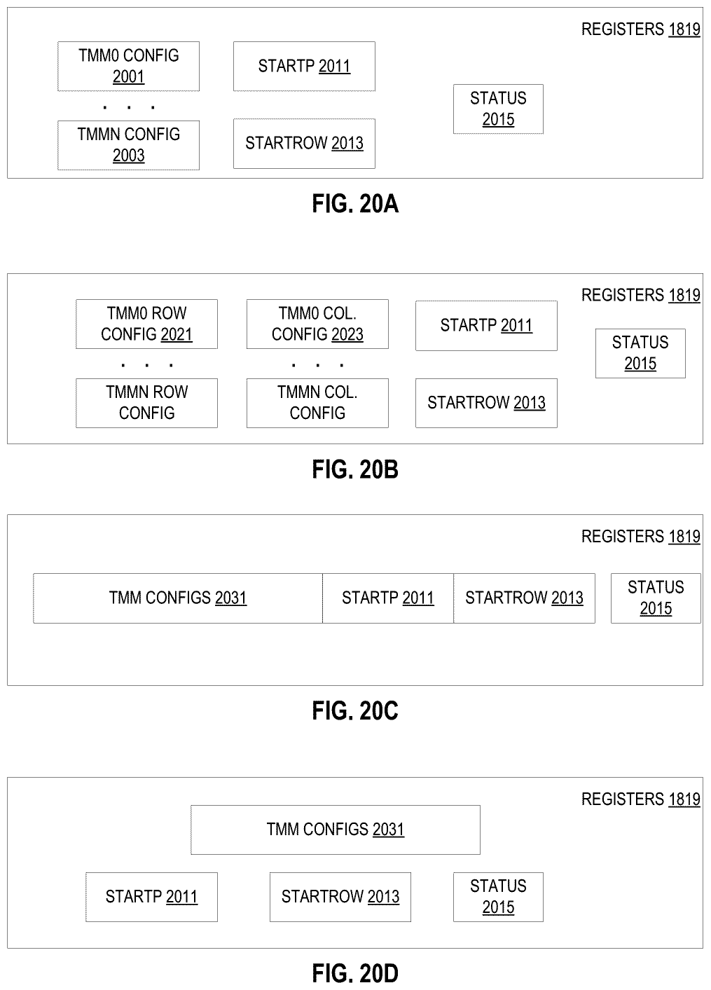

FIGS. 20A-20D illustrate examples of register(s) 1819. FIG. 20A illustrates a plurality of registers 1819. As shown each tile (TMM0 2001 . . . TMMN 2003) has a separate register with each register storing a row and column size for that particular tile. StartP 2011 and StartRow 2013 are stored in separate registers. One or more status registers 2015 are set (e.g., TILES_CONFIGURED=1) to indicate tiles are configured for use.

FIG. 20B illustrates a plurality of registers 1819. As shown each tile has separate registers for its rows and columns. For example, TMM0 rows configuration 2021, TMM0 columns configuration 2023, StartP 2011 and StartRow 2013 are stored in separate registers. One or more status registers 2015 are set (e.g., TILES_CONFIGURED=1) to indicate tiles are configured for use.

FIG. 20C illustrates a single register 1819. As shown, this register stores tile configurations (rows and columns per tile) 2031, StartP 2011, and StartRow 2013 are stored in single register as packed data registers. One or more status registers 2015 are set (e.g., TILES_CONFIGURED=1) to indicate tiles are configured for use.

FIG. 20D illustrates a plurality of registers 1819. As shown, a single register stores tile configuration (rows and columns per tile) 2031. StartP and StartRow are stored in separate registers 2011 and 2013. One or more status registers 2015 are set (e.g., TILES_CONFIGURED=1) to indicate tiles are configured for use.

Other combinations are contemplated such as combining the start registers into a single register where they are shown separately, etc.

### Circuitry to Perform Floating-Point Operations on a Fixed-Point Systolic Array

In certain examples, it is desirable for high-end high performance computing (HPC) systems to move beyond exascale (e.g., where exascale refers to a computer that performs at least 10\hat{ }18 floating-point operations per second), e.g., using 5-10 exa(quintillion) floating point operations (“flops”) for certain double-precision matrix multiplications (e.g., to meet a HPLinpack benchmark).

To achieve these performance targets, substantial improvements in performance-per-Watt are required over existing architectures. Certain architectures (e.g., central processing unit (CPU), graphics processing unit (GPU), field programmable gate array (FPGA), custom processor, artificial intelligence (AI) specific accelerators, etc.) use hardware matrix operation (e.g., multiplication) accelerators in the form of systolic arrays to enhance low-precision AI performance. In certain examples, the systolic array is a two-dimensional grid of processing elements to perform processing operations, e.g., on input matrices.

The operations may be performed on numerical data having different formats (e.g., representations) in a computing system (e.g., accelerator and/or processor). In certain examples, a number is in fixed-point format or a floating-point format. An integer may be represented in a binary format. A signed integer may be represented in a two's (2's) complement format (e.g., where the leading bit being zero indicates a positive integer and a leading bit being one indicates a negative integer), e.g., but the leading bit is part of the number. A signed integer may be represented in a signed magnitude format that is divided into two parts of the (i) sign bit and (ii) magnitude, e.g., where the sign bit is 1 for a negative number and 0 for a positive number, and the magnitude of the number is represented with the binary form of the number. For example, where in signed magnitude a 0 has two different representations: the first is +0 (e.g., +0 being 0:0000000) and the second is −0 (e.g., −0 being 1:0000000) and in 2's complement a 0 has only one representation for −0 and +0 (+0 or −0 both being 00000000). A (e.g., real) number may be represented in floating-point format, e.g., to represent, with a fixed number of digits, numbers of different orders of magnitude.

One example of a numerical format is where a number is generally approximated to a fixed number of significant digits (the significand) and scaled using an exponent in some fixed base (e.g., a base of two, ten, or sixteen). An example of a floating-point format is as follows:

$$x = significand \times {base}^{exponent} \qquad ( 1 )$$

An example of a floating-point format (where S represents a sign bit, M a mantissa, and E an exponent) is as follows:

$$x = {( - 1 )}^{S} \times 1 \cdot M \times {2}^{E - bias} \qquad ( 2 )$$

In accordance with the IEEE 754 standard for binary floating-point (FP) arithmetic, the mantissa is an unsigned number (e.g., a binary fraction) and a normalized floating-point number has a single one in the most-significant-bit (MSB) position. In certain examples, this bit (e.g., to the left of the decimal point) is implicit and therefore the mantissa does not need to store it. In certain examples, the exponent is represented here as a non-negative integer from which a constant bias is subtracted. Examples of floating-point formats are floating point 16 (e.g., binary16), floating point 32 (e.g., binary32), floating point 64 (e.g., binary64), floating point 128 (e.g., binary128), and floating point 256 (e.g., binary256), although any number of sign, significand (e.g., mantissa thereof), or exponent bits may be used in certain examples. In one example, binary16 format has one bit for the sign bit, 5 bits for the exponent, and 11 bits implicit (10 explicitly stored) for the significand. In one example, binary32 format has one bit for the sign bit, 8 bits for the exponent, and 24 bits implicit (23 explicitly stored) for the significand. In one example, binary64 format has one bit for the sign bit, 11 bits for the exponent, and 53 bits implicit (52 explicitly stored) for the significand. In one example, binary 128 format has one bit for the sign bit, 15 bits for the exponent, and 113 bits implicit (112 bits explicitly stored) for the significand. In one example, binary256 format has one bit for the sign bit, 19 bits for the exponent, and 237 bits implicit (236 bits explicitly stored) for the significand.

In certain examples, the systolic array is a two-dimensional grid of fixed-point (e.g., integer only) processing elements. In certain examples, a two-dimensional grid of floating-point (e.g., floating-point only) processing elements utilize more power and takes more time to perform an operation compares to a two-dimensional grid of fixed-point (e.g., integer only) processing elements. In certain examples, it is desirable to not utilize and/or not include a floating-point systolic array (e.g., floating-point only) within a computing system (e.g., processor). In certain examples, it is desirable to not utilize and/or not include a two-dimensional grid of floating-point (e.g., floating-point only) processing elements within a computing system (e.g., processor). In certain examples, it is desirable to not utilize vector execution circuitry to perform floating-point matrix operations (e.g., vector execution circuitry to implement chained multiply accumulate operations (e.g., QMADD, OMADD)), e.g., to instead utilize a (e.g., faster and/or more power efficient) two-dimensional grid of fixed-point (e.g., integer only) processing elements to perform floating-point operations. In certain examples, a QMADD operation (e.g., instruction) is to use vector execution circuitry to perform a matrix multiplication of two 2×2 input matrices and accumulate the results with a third 2×2 matrix, and an OMADD operation (e.g., instruction) is to use vector execution circuitry to perform a matrix multiplication of two 4×4 input matrices and accumulate the results with a third 4×4 matrix.

Examples herein overcome these issues by introducing circuitry (e.g., floating-point support circuitry) to support operations on floating-point values by a two-dimensional grid of fixed-point (e.g., integer only) processing elements, e.g., such that values are still input into the two-dimensional grid of fixed-point (e.g., integer only) processing elements as fixed-point values but the floating-point support circuitry enables floating-point inputs and floating-point outputs to be generated by a hardware matrix operation (e.g., multiplication) accelerator via its two-dimensional grid of fixed-point (e.g., integer only) processing elements. Examples herein enable the emulation of floating-point types (e.g., single and/or double precision) using the fixed-point (e.g., integer) arithmetic support provided by a systolic array. In certain examples, this approach requires minimal modifications to existing systolic arrays, e.g., allowing the systolic array to function on both integer values and floating-point values (e.g., via the floating-point support circuitry).

Examples herein improve the functioning of a computer (e.g., processor) by allowing floating-point values to be processed by a two-dimensional grid of fixed-point (e.g., integer only) processing elements, e.g., by including floating-point support circuitry as discussed herein. As discussed herein, the floating-point support circuitry allows for a computer (e.g., processor) to support floating-point matrix operations (e.g., arithmetic) with its two-dimensional grid of fixed-point (e.g., fixed-point only) processing elements without utilizing (and/or not even including) a floating-point systolic array (e.g., floating-point only) within the computer (e.g., processor). As discussed herein, the floating-point support circuitry allows for a computer (e.g., processor) to support floating-point matrix operations (e.g., arithmetic) with its two-dimensional grid of fixed-point (e.g., fixed-point only) processing elements without utilizing (and/or not even including) a two-dimensional grid of floating-point (e.g., floating-point only) processing elements within a computer (e.g., processor). As discussed herein, the floating-point support circuitry also allows for minimal modifications to an (e.g., existing) fixed-point systolic array where it is desired to add floating-point functionality.

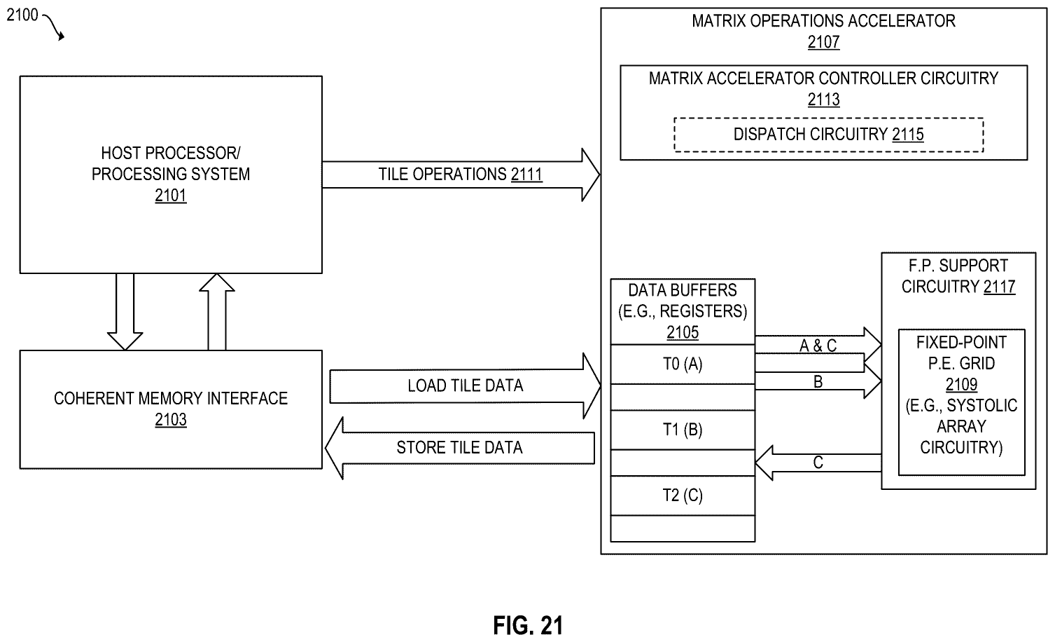

In certain examples, a processor (e.g., core) supports one or more instructions that are to cause floating-point support circuitry to enable support of floating-point matrix operations (e.g., arithmetic) with a two-dimensional grid of fixed-point (e.g., fixed-point only) processing elements. Those instructions disclosed herein are improvements to the functioning of a processor (e.g., of a computer) itself. Instruction decoder circuitry (e.g., a decoder) not having such an instruction as a part of its instruction set would not decode as discussed herein. An execution circuit not having such an instruction as a part of its instruction set would not execute as discussed herein. For example, a processor that, is to (i) decode, by a decoder circuit of a hardware processor comprising a matrix operations accelerator circuit including a two-dimensional grid of fixed-point processing elements, floating-point support circuitry coupled to the two-dimensional grid of fixed-point processing elements, and storage for a first, a second, and a destination two-dimensional floating-point matrices coupled to the floating-point support circuitry, the single “floating-point matrix operations” instruction into a decoded single instruction, the single “floating-point matrix operations” instruction including a first field that identifies the first two-dimensional floating-point matrix, a second field that identifies the second two-dimensional floating-point matrix, and an opcode that indicates an execution circuit of the hardware processor is to cause the matrix operations accelerator circuit to: determine, by the floating-point support circuitry, an extreme exponent for each row of the first two-dimensional floating-point matrix and for each column of the second two-dimensional floating-point matrix, generate, by the floating-point support circuitry, a first fixed-point matrix from the first two-dimensional floating-point matrix and a second fixed-point matrix from the second two-dimensional floating-point matrix, generate, by the two-dimensional grid of fixed-point processing elements, corresponding fixed-point results by a multiplication of fixed-point elements of the first fixed-point matrix by corresponding fixed-point elements of the second fixed-point matrix, scale, by the floating-point support circuitry, the corresponding fixed-point results according to the extreme exponents to generate scaled fixed-point results, generate, by the floating-point support circuitry, a resultant floating-point matrix from the scaled fixed-point results, and store the resultant floating-point matrix into the destination two-dimensional floating-point matrix, and (ii) execute, by the execution circuit of the hardware processor, the decoded single instruction according to the opcode. Certain examples herein allow for multiple precision (e.g., floating-point) matrix multiplication. Certain examples herein allow a matrix operations accelerator circuit including a two-dimensional grid of fixed-point processing elements to process (i) fixed point (e.g., integer) input values when in a first mode and (ii) floating-point input values when in a second mode, see, e.g., the discussion of FIGS. 21-41.

In certain examples, matrix multiplication can be thought of as a set of dot product calculations (with much data reuse between dot products). One key idea of examples herein is for a processor to include floating-point support circuitry that enables support of floating-point matrix operations (e.g., arithmetic) with a two-dimensional grid of fixed-point (e.g., fixed-point only) processing elements. In certain examples, the floating-point support circuitry determines the binary “point” of each dot product by examining the input matrices, e.g., once a fixed-point is chosen, the floating-point support circuitry then translates all floating-point input values into fixed-point (e.g., as they stream into the systolic array). To deal with the lower precision (e.g., fixed precision) of certain systolic arrays (e.g., two-dimensional grid of fixed-point (e.g., fixed-point only) processing elements), certain examples herein include floating-point support circuitry that breaks input elements into chunk sized (e.g., word-sized) pieces, and thus (e.g., narrow) chunk sized (e.g., word) multiplications are then used to complete a wider element (e.g., word) multiplication. In certain examples, all multiplication and accumulation in the systolic array are performed in fixed-point, and the results are converted back into floating-point at the end of the matrix multiplication.

Such floating-point support circuitry and two-dimensional grid of fixed-point (e.g., fixed-point only) processing elements cannot practically be performed in the human mind (or with pen and paper). Such floating-point support circuitry is an improvement in the functioning of a computer as discussed herein. An example improvement realized by the floating-point support circuitry is improved matrix multiplication performance and performance per Watt of power consumed, e.g., from 3-8 times better than without using the floating-point support circuitry. Another example improvement realized by the floating-point support circuitry is the ability to add floating-point support to an (e.g., existing) systolic array, e.g., as a component in processor architectures. An example improvement realized by the floating-point support circuitry is because it uses fixed-point, more performance is unlocked where arrays have more integer multiplication support than floating-point multiplication support. Surprisingly, in certain examples, operating in fixed-point also improves the accuracy of the matrix multiplications, which will unlock additional performance gains in some application use cases. Also note that by eliminating the need for floating-point systolic arrays, the fixed-point (e.g., AI) systolic arrays could be made larger in a processor and/or also achieve higher AI performance points.

FIG. 21 illustrates an example of a system 2100 including a matrix operations accelerator 2107 that includes floating-point support circuitry 2117 for a two-dimensional grid 2109 of fixed-point processing elements according to examples of the disclosure. In this illustration, a host processor/processing system 2101 communicates commands 2111 (e.g., matrix manipulation operations such as arithmetic or matrix manipulation operations, or load and store operations) to a matrix operations accelerator 2107. However, this is shown this way for discussion purposes only. As detailed later, this accelerator 2107 may be a part of a processing core. Typically, commands 2111 that are tile manipulation operator instructions will refer to tiles as register-register (“reg-reg”) or register-memory (“reg-mem”) format. Other commands such as TILESTORE, TILELOAD, TILECONFIG, etc., do not perform data operations on a tile. Commands may be decoded instructions (e.g., micro-ops) or macro-instructions for the accelerator 2107 to handle. In one example, dispatch circuitry 2115 controls the sending of data (e.g., one or more values from a tile) from data buffers 2105 (e.g., registers forming a tile) to the grid of fixed-point processing elements 2109.

In this example, a coherent memory interface 2103 is coupled to the host processor/processing system 2101 and matrix operations accelerator 2107 such that they can share memory. FIGS. 4 and 5 show different examples of how memory is shared using a matrix operations accelerator.

In certain examples, matrix operations circuitry (e.g., matrix operations accelerator 2107 circuitry), and particularly, the two-dimensional grid 2109 of fixed-point processing elements, is augmented by floating-point support circuitry 2117 to logically allow the two-dimensional grid 2109 of fixed-point processing elements to perform floating-point (e.g., arithmetic) operations (e.g., floating-point matrix multiplication), for example, in contrast to using a grid of floating-point processing elements to perform floating-point (e.g., arithmetic) operations.

In certain examples, the floating-point support circuitry 2117 is included to perform a conversion, in hardware, of floating-point values into fixed-point values, breaking wide fixed-point values (e.g., words) into the narrow chunks (e.g., sub-words) supported by the fixed-point systolic array (e.g., grid 2109 of fixed-point processing elements), conducting a set of low-precision matrix multiplications, combining the results of these matrix multiplications, and then converting the inner product result back in to floating-point format. In certain examples, architecturally, the usage of the fixed-point systolic array (e.g., grid 2109 of fixed-point processing elements) is unchanged from its usage and interface for low precision types, e.g., programmers will still provide floating-point matrices as inputs and larger matrix operations will be composed of smaller matrix operations. In certain examples, the hardware modifications (e.g., floating-point support circuitry 2117) to enable the approach are constrained to the perimeter of the array, rather than the array internals. Certain examples herein use floating-point support circuitry 2117 to naturally support a wide range of types including single, double, and single-time-double matrix multiplications.

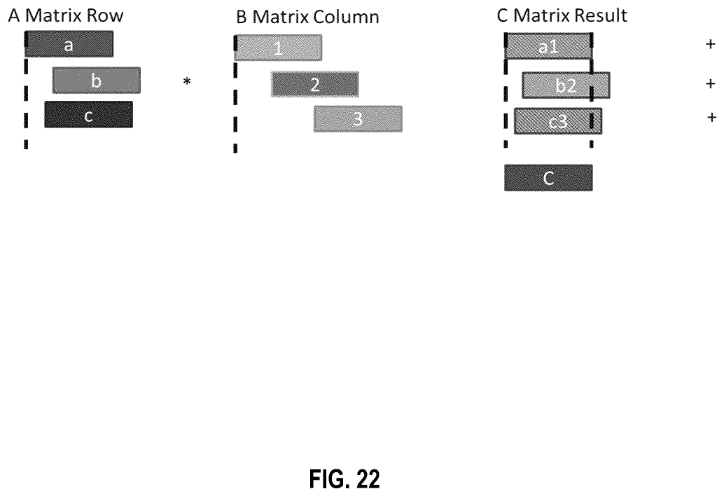

FIG. 22 illustrates an example of an inner product calculation with floating-point values according to examples of the disclosure. The multiplication of terms a (e.g., a row a of matrix A) and 1 (e.g., a column 1 of matrix B) will usually determine, or nearly determine the exponent of the final floating-point result. FIG. 22 visually illustrates a floating-point inner product multiplication of a matrix row and a matrix column, from which a full matrix multiplication may be composed. The terms of the inner product are shown normalized to a maximum exponent of the inner product, illustrating the actual magnitude of the numbers in real terms. Multiplication will change the magnitude of the terms, but the product of the two highest magnitude terms will be larger than all other terms. In certain examples, these largest magnitude terms are referred to as “extreme” exponents, and each inner product of a matrix multiplication will have a pair: one for the row of A matrix and one for the column of B matrix used to produce it.

This observation leads to a way of re-framing floating-point multiplication as fixed-point multiplication. In certain examples of floating-point multiplication, shifting and rounding would happen at each multiplication, based on the arguments to that particular multiplication. However, the extreme exponents provide a way of estimating the exponent of the final inner product result, allowing each input term of the inner product to be scaled to the estimated final exponent prior to any multiplication. This permits all multiplications and additions during the inner product calculation to occur in fixed-point using the extreme exponent as a basis. In certain examples, at the end of the fixed-point inner product calculation, scaling is inverted, and then the result is converted back into floating-point format. In certain examples, scaling and scaling inversion terms (S) are always powers of two. In certain examples, “extreme” exponent (e.g., maximum exponent from that set of values) scaling occurs per row of the ‘A’ input matrix and per column of the ‘B’ input matrix, and with the benefit that it happens only once per input matrix, even if that matrix is reused multiple times as a part of a larger matrix multiplication.

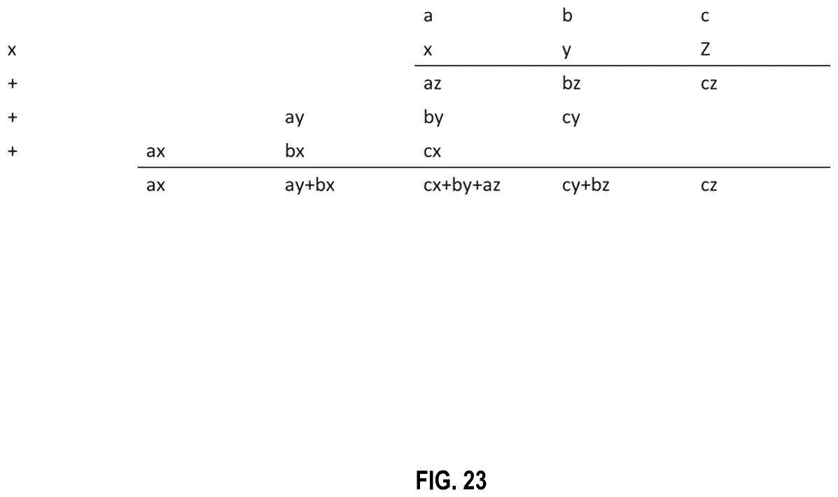

FIG. 23 illustrates an example of scalar long multiplication according to examples of the disclosure. In certain examples, a, b, and c (e.g., 324) are a single value of three numbers and x, y, z (e.g., 292) are a single value of three numbers. In certain examples, the “internal” multiplication digits (e.g., a*x) are not limited to being single values and can be of arbitrary precision (e.g., chunks), enabling any high precision multiplication to be broken into a series of low precision multiplications. In certain examples, once the matrix multiplication of matrix A multiplied by matrix B is re-framed as fixed-point, the elements can be subsequently partitioned from a wide fixed-point value (e.g., word granularity) into narrower chunks (e.g., sub-word granularity), and use “long” multiplication as in FIG. 23. This approach uses narrow multiplications and wider summation operations to aggregate the sums.

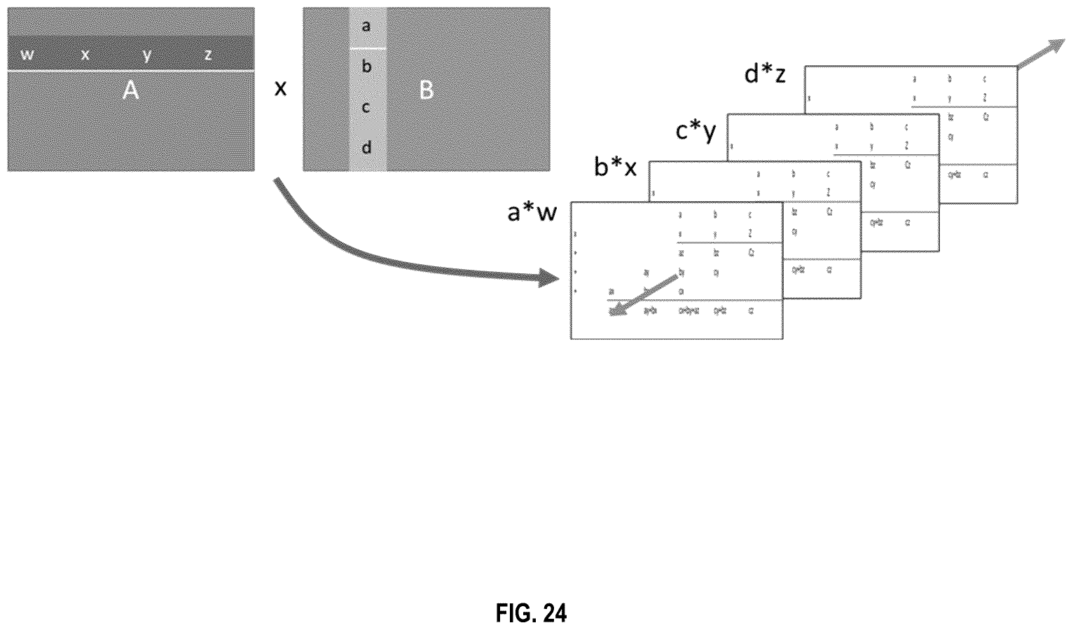

FIG. 24 illustrates an example of long multiplication applied to inner product computations according to examples of the disclosure. Here, it is seen that an inner product can be broken up using the long multiplication method, and that this regrouping is itself a series of inner products. The downward left pointing arrow represents a single “long” inner product, e.g., where this computation is performed in a (e.g., AI) systolic array (e.g., grid of processing elements).

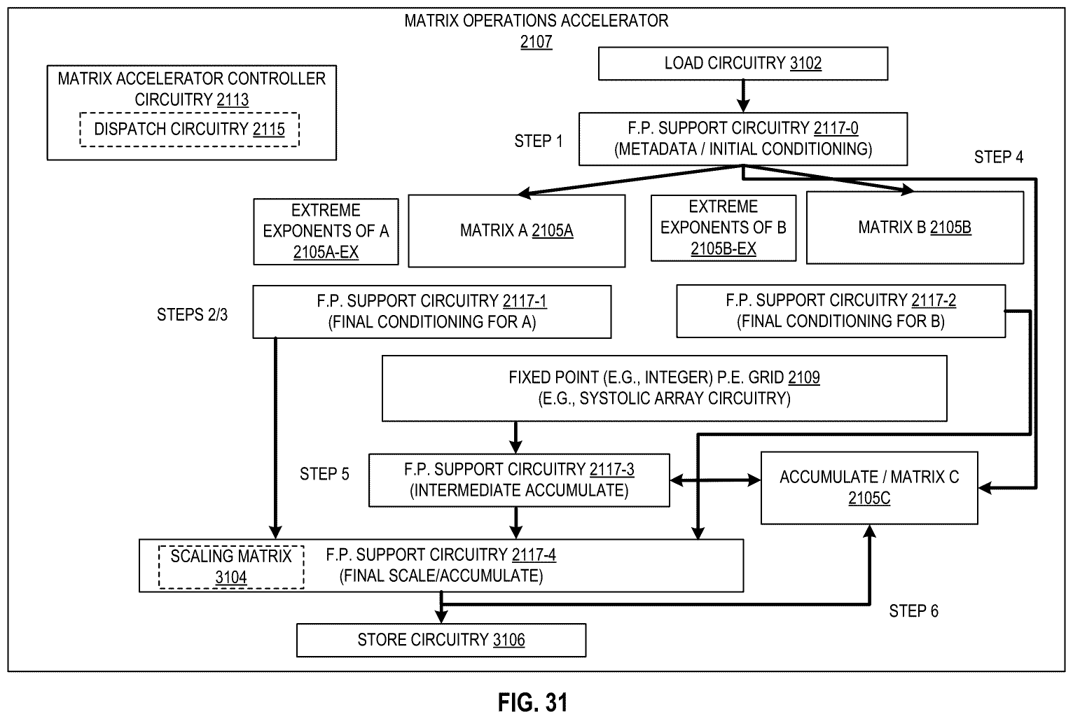

In certain examples, long multiplication as described in FIG. 23 does not directly map to systolic arrays. However, if an inner product calculation is viewed as a series of long multiplications, then the long multiplication terms themselves can be mapped to a narrow-width inner product calculation. Because the inner products are a part of a matrix multiplication, they can be directly mapped to (e.g., “narrow-width”) fixed-point systolic array (e.g., grid 2109 of fixed-point processing elements) (e.g., systolic matrix multiplication engines). Then, for a full-width fixed-point matrix multiplication C′=A′×B′, the multiplication can be broken into a series of (e.g., “narrow-width”) (e.g., chunk width) fixed-point matrix multiplications conforming to long multiplication using narrow-width partitions A1′ . . . An′ of A′ and B1′ . . . Bn′ of B′. In certain examples, A1′ and B1′ are most significant, a convention followed throughout certain examples herein. In certain examples, long multiplication would proceed with the following series of multiplications and accumulations:

$$C {1}^{′} -> A {1}^{′} * {B}^{′} 1$$

$$C {2}^{′} -> {A}^{′} 1 * {B}^{′} 2 + {A}^{′} 2 * {B}^{′} 1$$

$$C {3}^{′} -> {A}^{′} 1 * {B}^{′} 3 + {A}^{′} 2 * {B}^{′} 2 + {A}^{′} 3 * {B}^{′} 1$$

$${C}^{′} 4 -> {A}^{′} 1 * {B}^{′} 4 + {A}^{′} 2 * {B}^{′} 3 + {A}^{′} 3 * {B}^{′} 2 + {A}^{′} 4 * {B}^{′} 1$$

$${C}^{′} 5 -> {A}^{′} 1 * {B}^{′} 5 + {A}^{′} 2 * {B}^{′} 4 + {A}^{′} 3 * {B}^{′} 3 + {A}^{′} 4 * {B}^{′} 2 + {A}^{′} 5 * {B}^{′} 1$$

$$…$$

$${C}^{′} = S . * ( {C}^{′} 1 + {2}^{- narrow \_ width *} ( {C}^{′} 2 + {2}^{- narrow \_ width *} ( {C}^{′} 3 + {2}^{- narrow \_ width *} ( {C}^{′} 4 + … + {C}^{′} n )$$

Where C′ is a full-width matrix and can be converted back in to floating-point. S is a matrix scaling inversion terms (e.g., scaling matrix 3104 in FIG. 31), and .* denotes a point-wise multiplication (as opposed to a matrix multiplication). In certain examples, scaling inversion (“Sn”) terms (e.g., from scaling matrix 3104 in FIG. 31) are highly regular powers of two, and so only a logical shift is implied.

In certain examples, floating-point support circuitry 2117 logically allows the two-dimensional grid 2109 of fixed-point processing elements to perform floating-point (e.g., arithmetic) operations (e.g., floating-point matrix multiplication) via the following algorithm:
1. Determining the extreme exponent for each row of the A input matrix and each column of the B matrix.
2. Creating fixed-point matrices A′ and B′ by converting the floating-point values of matrices A and B to fixed-point, e.g., using the extreme exponents determined in step 1.
3. Partitioning A′ and B′ into sets of narrow-width (e.g., chunk=width) matrices A′n and B′n as in ‘long’ multiplication.
4. Multiplying appropriate A′i and B′j matrices according to “long” multiplication and accumulate them using (e.g., unmodified) narrow-width systolic array (e.g., two-dimensional grid 2109 of fixed-point processing elements), forming a fixed-point matrix C′n. In certain examples, term computations are ordered to ensure correct fixed-point accumulations.
5. Scaling using Sn terms (e.g., from scaling matrix 3104 in FIG. 31) and accumulate C′n matrices to form full-width (e.g., full element width) fixed-point result C′.
6. Creating floating-point result matrix C by converting C′ to floating-point format.

In certain examples, this algorithm is performed serially. Below discusses a well-parallelized implementation, e.g., in which 1-6 execute in a pipeline-parallel fashion, for example, where such an arrangement results in little additionally latency relative to the baseline functionality of the systolic array.

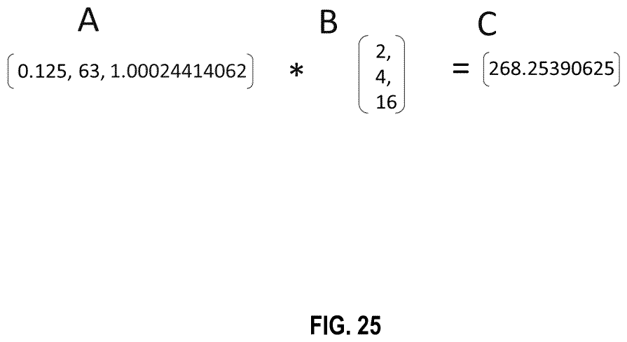

To illustrate the operation of the low precision multiplication algorithm, the below describes one example using the values from FIG. 25. Since the matrix multiplications can be viewed as a series of related, but separable inner products, these examples will consider only an inner product and, for brevity, single precision floating-point values, although one of ordinary skill in the art should understand that this is extendable to full matrix multiplication and/or other precision of floating-point values.

In certain examples, if a user requests a smaller precision, the matrix operations accelerator can simply skip some of the latter steps of the “long” multiplication. For example, there is a long-form and a short-form, e.g., where if you have X chunks of A and B, the long form is always X\hat{ }2 multiply operations and the short form is X*(X+1)/2 pieces, which can be over half the size and complexity. There are certain problems that may only require the “short” form, and this can save additional power. In certain examples, the matrix operations accelerator is able to pick and choose between the long and short forms (and do both). In certain examples, for the short form, the matrix operations accelerator is to, instead of adding up all the Cx terms that go to C_{X*X}, it stops at C_{X+1}. E.g., the matrix operations accelerator computes C_{X+1}=A1*BX+A2*B_{X−1}+ . . . +AX*B1, and does not go any further (e.g., it stops at X*(X+1)/2 multiplications total). In certain examples, a matrix operations accelerator is able to stop the algorithm early, e.g., the hardware determines (e.g., based on a desired level of precision) no further sums are needed, stop here, and skip to step 6.

FIG. 25 illustrates an example inner product of a row of matrix A and a column of matrix B to generate a resultant value C according to examples of the disclosure.

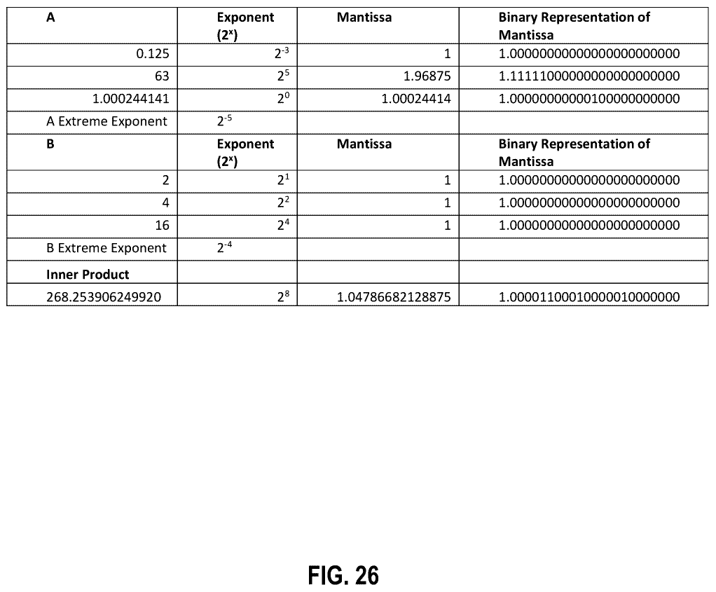

FIG. 26 illustrates an example table of binary representations of the floating-point elements of the row of matrix A and the column of matrix B in FIG. 25 and the extreme exponent for row A being 2\hat{ }−5 and the extreme exponent for column B being 2\hat{ }−4 according to examples of the disclosure. Said another way, for the row of A, the maximum exponent is 2\hat{ }5, so to “normalize” that value to be about 1, an extreme exponent of 2\hat{ }−5 is applied, and for the column of B, the maximum exponent is 2\hat{ }4, so to “normalize” that value to be about 1, an extreme exponent of 2\hat{ }−4 is applied.

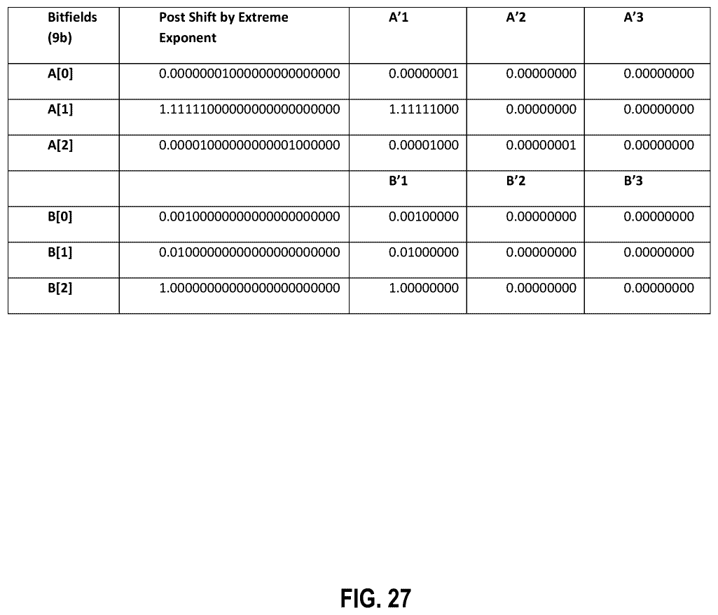

FIG. 27 illustrates an example table of binary fixed-point representations of the mantissas of the elements of the row of matrix A shifted according to the extreme exponent for row A and the mantissas of the elements of the column of matrix B shifted according to the extreme exponent for column B, and the chunking of each of those binary fixed-point representations into three chunks according to examples of the disclosure. FIG. 27 shows the preparation of the A′n and B′n matrices from A and B. In certain examples, the low precision approach operates on fixed-point arithmetic, and the extreme exponents of A rows and B columns, in this case one exponent for each matrix, are used to align the terms of the matrix rows and columns to a single fixed-point per row and column. In certain examples, once aligned, the matrix values are partitioned into individual bitfields forming the A′n and B′n submatrices. When partitioned, the example matrices result in submatrices that are mostly zero in order to simplify calculation. To further simplify understanding, a fixed-point decimal is included.

For example, taking value A[1] of 63, this is binary 1.11111000000000000000000 with an exponent of 2\hat{ }5, so to shift that exponent by the extreme exponent of A (which is 2\hat{ }−5 in this example) results in a zero shift, and thus a shifted binary fixed-point value of A[1] of 1.11111000000000000000000 (e.g., as a shift of 0 bits because the −5 and 5 exponents sum to zero). For example, taking value A[2] of 1.000244141, this is binary 1.00000000000100000000000 with an exponent of 2\hat{ }0, so to shift that exponent by the extreme exponent of A (which is 2\hat{ }−5 in this example) results in a shifted binary fixed-point value of A[2] of 0.00001000000000001000000 (e.g., as a right shift of 5 bits because the −5 and 0 exponents sum to −5). For example, taking value B[1] of 4, this is binary 1.00000000000000000000000 with an exponent of 2\hat{ }2, so to shift that exponent by the extreme exponent of B (which is 2\hat{ }−4 in this example) results in a shifted binary fixed-point value of B[1] of 0.01000000000000000000000 (e.g., as a right shift of 2 bits because the −4 and 2 exponents sum to −2).

Further, FIG. 27 shows how each of those shifted binary fixed-point values can be divided into a plurality of chunks (shown as three chunks, but any plurality may be selected). For example, where shifted binary fixed-point value A[2] of 0.00001000000000001000000 is split into three (8 bit wide) chunks of: chunk 1 A′1[2] being 0.0000100, chunk 2 A′2[2] being 0.00000001, and chunk 3 A′3[2] being 0.00000000. In certain examples, note that while each value of matrix row A is normalized by an extreme exponent A of 2\hat{ }−5, each chunk (other than the first chunk) include a chunk offset to indicate that chunk's position in each value. For example, chunk 1 A′1[2] being 0.0000100 having a chunk offset of 2\hat{ }0 (since it is the first chunk). For example, chunk 2 A′2[2] being 0.00000001 having a chunk offset of 2\hat{ }−9 (since it is the next chunk using 9-bit precision).

Said another way, shifted A[0]=A′1[0]+(2\hat{ }−9)*A′2[0]+(2\hat{ }−18)*A′3[0], where 0 is the element index of an element of a matrix (e.g., element index in a row or element index in a column, and the number after the ‘ is the “chunk index” into a single element, shown here as chunk indices 1-3).

In certain examples, the chunk values are 9-bit precision (corresponds to 10-bit signed multiplication). Fixed-point representation is used to aid in understanding. In certain examples, actual fixed-point multiplication support is not required.

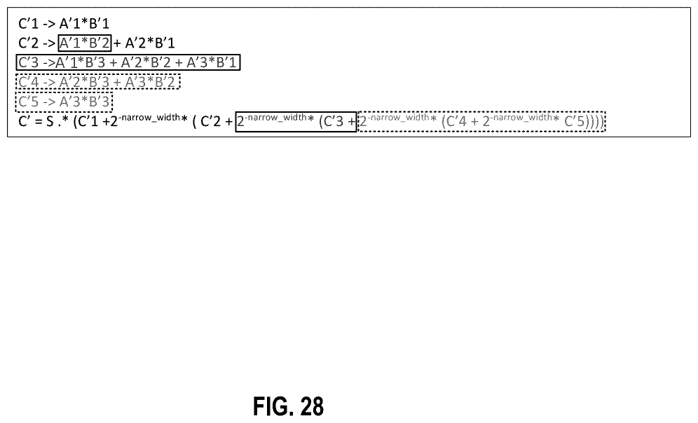

FIG. 28 illustrates an example of the calculations to determine a floating-point multiplication using chunked binary fixed-point representations according to examples of the disclosure. In certain examples, the terms (e.g., results of chunk multiplication) in the solid black box are unneeded in the present calculation, due to zeros in source matrices. In certain examples, the terms (e.g., results of chunk multiplication) in the dotted black box are usually unneeded because their contribution to the final C matrix is too small to influence a rounded result.

Using the examples from FIGS. 25-28, once partitioning (e.g., chunking) has occurred, the chunked (e.g., narrow) matrices are multiplied and accumulated to form the C′n matrices as in FIG. 28. In this example, because of the large number of zero terms, only chunk (e.g., narrow) matrix multiplications A′1*B′1 (component of C′1) and A′2*B′1 (component of C′2) have non-zero terms.

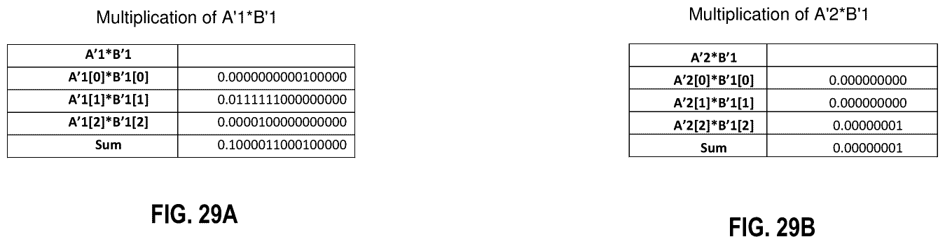

FIG. 29A illustrates an example of the multiplication of A′1*B′1 from the table in FIG. 27 using chunked binary fixed-point representations according to examples of the disclosure. In FIG. 29A, the resultant of A′1*B′1 (component of C′1) is the sum of the resultants of the chunk multiplication, i.e., 0.1000011000100000.

FIG. 29B illustrates an example of the multiplication of A′2*B′1 from the table in FIG. 27 using chunked binary fixed-point representations according to examples of the disclosure. In FIG. 29B, the resultant of A′2*B′1 (component of C′2) is the sum of the resultants of the chunk multiplication, i.e., 0.00000001. The tables in FIGS. 29A and 29B show the result of the A′1*B′1 and A′2*B′1 multiplications, which comprise C′1 and C′2 respectively. In another example multiplication, multiple narrow matrices would be combined by simple term-wise addition to form the C′n matrices, but in this example each of C′1 and C′2 have only one non-zero component multiplication.

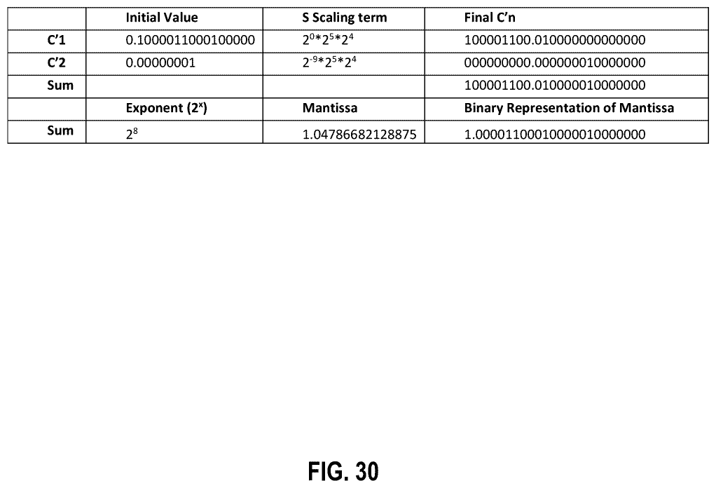

FIG. 30 illustrates an example of the final scaling and summation of the C′n matrices using chunked binary fixed-point representations according to examples of the disclosure. As shown in FIG. 30, the expected result from FIG. 26 is generated using the algorithm discussed above, e.g., via floating-point support circuitry 2117 that logically allows the two-dimensional grid 2109 of fixed-point processing elements to perform floating-point (e.g., arithmetic) operations (e.g., floating-point matrix multiplication) via the algorithm.

In certain examples, the final step in low-precision (e.g., chunked fixed-point) multiplication is to scale and combine the C′n terms to form the final multiplication result. In certain examples, this involves scaling each term of the C′n matrices by an appropriate Sn matrix term and then summing up the individual terms of the C′n matrices to obtain a final C matrix term. This term can then be translated into a full-precision floating-point term directly. As shown in the scaling term for C′1, it includes 2\hat{ }5 (to remove the scaling from the extreme exponent of row A of 2\hat{ }−5), includes 2\hat{ }4 (to remove the scaling from the extreme exponent of column B of 2\hat{ }−4), and a chunk offset (e.g., scaling) of 2\hat{ }0 because both chunk A′1 and chunk B′1 from A′1*B′1 are not offset chunks. As shown in the scaling term for C′2, it includes 2\hat{ }5 (to remove the scaling from the extreme exponent of row A of 2\hat{ }−5), includes 2\hat{ }4 (to remove the scaling from the extreme exponent of column B of 2\hat{ }−4), and a chunk offset (e.g., scaling) of 2\hat{ }−9 because while chunk B′1 from A′2*B′1 is not an offset chunk, chunk A′2 from A′2*B′1 is an offset chunk (it is chunk position “2”, so the chunk offset is −9).

In FIG. 30, the scaling terms are thus multiplied by the initial values of C′1 and C′2 to generate the scaled C′1 and C′2 values, which are then added together to generate a resultant, e.g., and that resultant 100001100.010000010000000 converted from fixed-point format to floating point format of 1.04786682128875×(2\hat{ }8).

### Hardware Implementation

The below describes further details of hardware (e.g., floating-point support circuitry) to implement such a fixed-point approach.

FIG. 31 illustrates a matrix operations accelerator 2107 that includes floating-point support circuitry 2117 (e.g., 2117-0, 2117-1, 2117-2, 2117-3, and 2117-4) for a two-dimensional grid 2109 of fixed-point processing elements according to examples of the disclosure. In certain examples, the two-dimensional grid 2109 is a low-precision matrix multiplication array with extensions (e.g., includes floating-point support circuitry 2117) for supporting high precision operations. FIG. 31 shows a high-level block diagram of certain extensions used to implement a fixed-point approach to floating-point value, framed in terms of augmentations to (e.g., an existing) systolic array hardware.

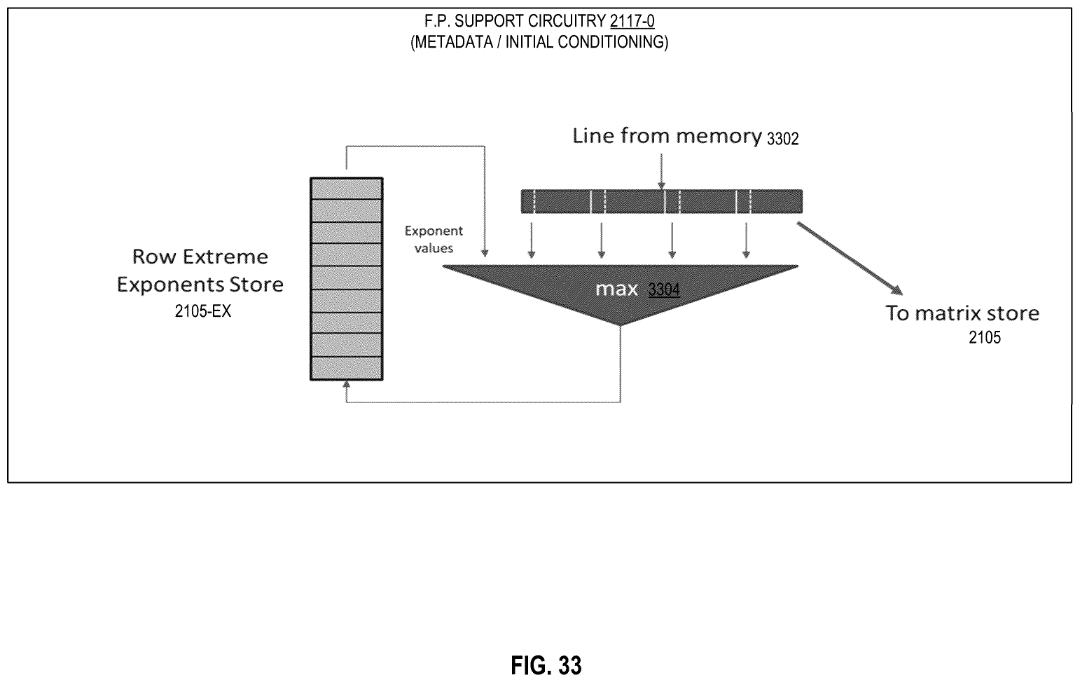

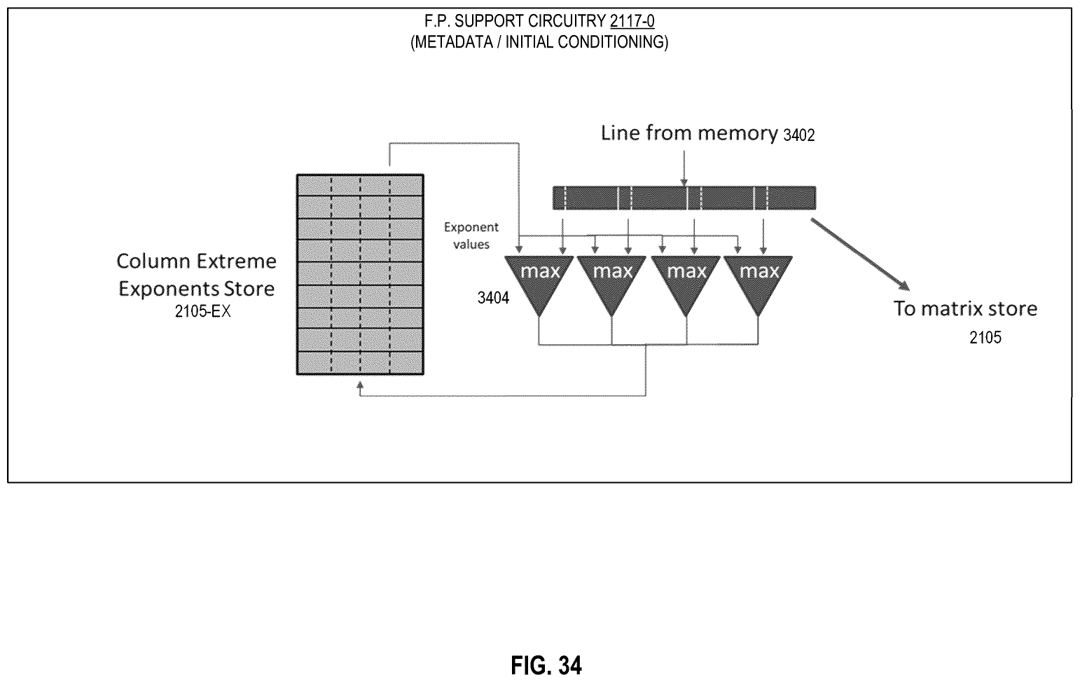

Depicted matrix operations accelerator 2107 includes a matrix accelerator controller circuitry 2113, e.g., to control the operations according to the algorithm disclosed herein. In certain examples, matrix accelerator controller circuitry 2113 includes dispatch circuitry 2115, e.g., to control the sending of data (e.g., one or more values from an input matrix) from data buffers 2105 (e.g., registers forming a tile) to the grid of fixed-point processing elements 2109. In certain examples, a request to perform one or more processing operations on input matrix A 2105A and input matrix B 2105B is generated, e.g., by host processor/processing system 2101 in FIG. 21. In certain examples, the request to perform one or more processing operations on input matrix A 2105A and input matrix B 2105B causes load circuitry 3102 to load (e.g., stream) the input matrices into the local storage of matrix operations accelerator 2107 (e.g., storage 2105A for matrix A, storage 2105B for matrix B, and/or storage 2105B for matrix C), e.g., from system memory (e.g., via coherent memory interface 2103 in FIG. 21). In certain examples, floating-point support circuitry 2117-0 is to determine the extreme exponents for (e.g., reach row of) matrix A (e.g., and store those in storage 2105A-EX) and the extreme exponents for (e.g., reach column of) matrix B (e.g., and store those in storage 2105B-EX). In certain examples, the extreme exponent determination is done via the circuitry illustrated in FIG. 33 or FIGS. 34, e.g., as the floating-point values are streamed into storage 2105A for matrix A and/or storage 2105B for matrix B. In certain examples, floating-point support circuitry 2117-1 for matrix A and floating-point support circuitry 2117-2 for matrix B is to convert the floating-point values (e.g., elements) for matrix A and matrix B into fixed-point values (e.g., and shift them by their corresponding extreme exponent (e.g., and chunk them), e.g., and store (e.g., overwrite the floating-point values) those chunked binary fixed-point representations into storage 2105A for matrix A and/or storage 2105B for matrix B).

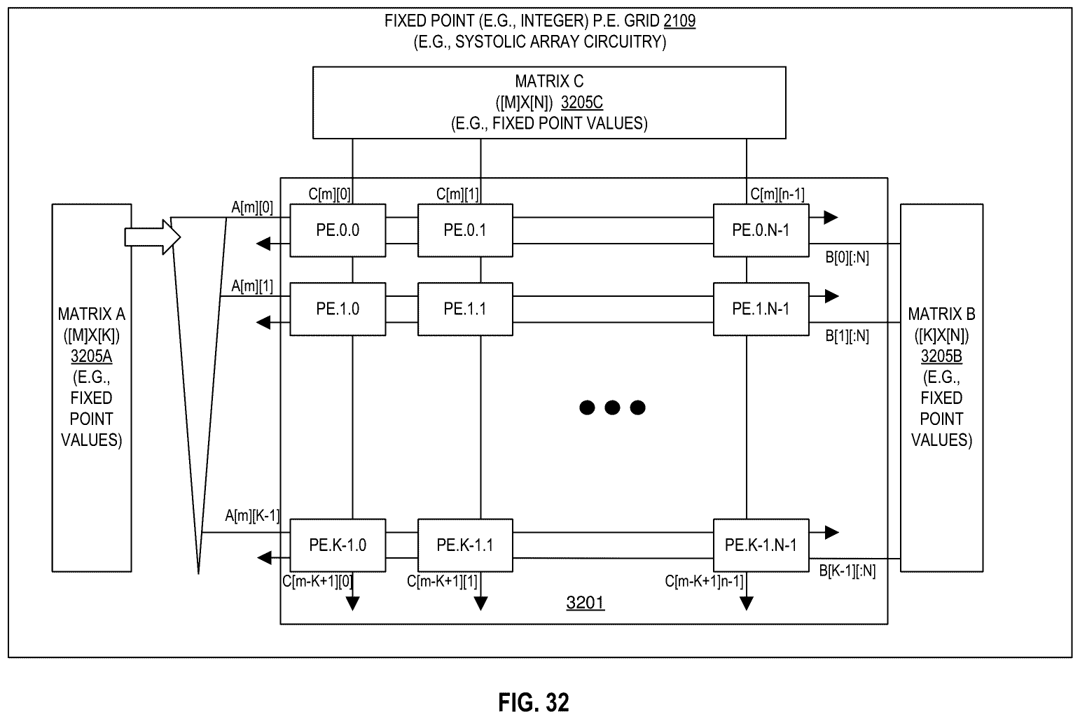

In certain examples, the input values are stored in (e.g., streamed into) storage 2105A for matrix A and/or storage 2105B for matrix B in floating-point format and then converted by floating-point support circuitry 2117 (e.g., floating-point support circuitry 2117-1 for matrix A and floating-point support circuitry 2117-2 for matrix B) as the input values are input (e.g., streamed) into the two-dimensional grid 2109 of fixed-point processing elements (e.g., with the fixed-point input values of A stored in matrix A storage 3205A and the fixed-point input values of B stored into matrix B storage 3205B in FIG. 32). In certain examples, floating-point support circuitry 2117 (e.g., 2117-0, 2117-1, and 2117-2) is to perform the operations discussed above in reference to FIGS. 26-27. In certain examples, the chunked binary fixed-point representations (e.g., as shown in FIG. 27) are dispatched to the two-dimensional grid 2109 of fixed-point processing elements (e.g., under the control of matrix accelerator controller circuitry 2113 (e.g., dispatch circuitry 2115 thereof)). In certain examples, one or more of the multiplications (e.g., only where both operands include non-zero values) shown in FIG. 28 are performed on the chunked binary fixed-point representations (e.g., as shown in FIG. 27) by the two-dimensional grid 2109 of fixed-point processing elements (e.g., under the control of matrix accelerator controller circuitry 2113 (e.g., dispatch circuitry 2115 thereof).

In certain examples, floating-point support circuitry 2117-3 is to perform an intermediate accumulation of values, e.g., to generate the values of C′n (e.g., as shown in FIG. 28), e.g., C′1, C′2, etc. In certain examples, the floating-point support circuitry 2117-3 uses accumulation circuitry 2105C to perform an intermediate accumulation of values.

In certain examples, the final fixed-point C′n values (e.g., as shown in FIG. 30) are generated by floating-point support circuitry 2117-4, e.g., via a scaling according to the scaling matrix 3104. In certain examples, the final floating-point C value (e.g., as shown in FIG. 30) is generated by floating-point support circuitry 2117-4, e.g., via conversion circuitry thereof to convert fixed-point value to a floating-point value.

In certain examples, the final floating-point C values are accumulated in matrix C 2105C (e.g., with previous floating-point values of an initial matrix C) to generate an updated resultant floating-point matrix C).

In certain examples, the final floating-point C values are sent by store circuitry 3106 from (e.g., storage 2105C of matrix C within) matrix operations accelerator 2107 to system memory (e.g., via coherent memory interface 2103 in FIG. 21) and/or to matrix C 2105C.

In certain examples, while the stores for the A, B, and C matrices are shown as independent, this storage can be unified.

In certain examples, the floating-point support circuitry 2117 (e.g., as discrete components as shown or as a single unitary component in other examples) is included to implement the six steps of the fixed-point matrix multiplication algorithm. In certain examples, step 1 of the algorithm is to determine the extreme exponents for the input matrices, e.g., where this occurs as the matrices are streamed into the array-local storage (2105A, 2105B), with the extreme exponents being stored as additional data (e.g., metadata) along with the matrices (e.g. into extreme exponent storage 2105A-EX and 2105B-EX. In certain examples, step 2 scales matrix values according to the extreme exponents and converts the floating-point values to fixed-point as they are streamed from array-local storage into the array 2109 itself. In certain examples, step 3 forms narrow width (e.g., chunked) matrices, e.g., concurrently with step 2 as values are streamed into the array 2109. In certain examples, at step 4, the matrix multiplication for fixed-point values is unchanged and requires no additional hardware relative to a (e.g., baseline) systolic array. In certain examples, step 5 modifies the array inner product results by inverting part of the extreme exponent scaling and accumulates a partial C′ result. In certain examples, step 6 inverts the remaining extreme exponent scaling converts a C′ back into floating-point matrix C.

In certain examples, all steps are pipelined and so incur little latency penalty and no throughput penalty relative to a baseline systolic array. Additionally, in certain examples, while there are many views of the A, B, and C matrices that are used during low-precision computation in practice only one view of data is materialized at a time and so existing storage structures can be largely reused without additional sizing.

FIG. 32 illustrates further detail of a two-dimensional grid 2109 of fixed-point processing elements (shown connected together via interconnect 3201) according to examples of the disclosure. In certain examples, the chunked binary fixed-point values are input into matrix A storage 3205A (e.g., from storage 2105A in FIG. 31) and into matrix B storage 3205B (e.g., from storage 2105B in FIG. 31), e.g., with the resultant(s) output into matrix C storage 3205C (e.g., then into storage 2105C in FIG. 31).

### Step 1: Extreme Exponent Determination

FIG. 33 illustrates floating-point support circuitry 2117-0 for extracting extreme exponents from line-oriented floating-point data according to examples of the disclosure. In certain examples, extreme exponents are produced for each row of the A matrix and each column of the B matrix. In certain examples, determining the extreme exponent requires the observation of all values in the particular row or column. This can be done without latency penalty as matrices are streamed into the local array store 2105. In certain examples, the floating-point support circuitry 2117-0 in FIG. 33 extracts extreme exponents from line-oriented data, for example, a C-style row major data array in which row data is packed into a cache line 3302. In certain examples, the extreme exponent is set to the minimum exponent for the particular floating-point type. In certain examples, as values of the row are input, the maximum exponent seen to that point is determined via maximum selection logic circuitry 3304 with inputs of the incoming cache line exponents from cache line 3302 and the prior maximum exponent value from extreme exponent storage 2105-EX, e.g., where the new maximum determined is then stored. In certain examples, this process is repeated across the row, until the entire row has been scanned, at which point the extreme exponent for the row has been discovered.

FIG. 34 illustrates floating-point support circuitry 2117-0 for extracting extreme exponents from non-line-oriented floating-point data according to examples of the disclosure. This can be done without latency penalty as matrices are streamed into the local array store 2105. In certain examples, for non-line oriented extreme exponent extraction, several extreme exponents are calculated in parallel. In certain examples, additional hardware (e.g., floating-point support circuitry 2117-0) is introduced to handle extreme exponent extraction for “transposed” non-line-oriented matrices, e.g., rather than selecting the maximum exponent from among all values in the incoming cache line, each element (e.g., word) of the incoming line 3402 is compared by a respective one of a plurality of maximum selection logic circuitry 3404 to a prior maximum value from column extreme exponents store 2105-EX for the appropriate column. In certain examples, both row and column extreme exponents are determined in parallel for a particular input matrix.

In certain examples, extreme exponents are stored along with the array data for use during Step 2 and Step 4.

### Steps 2/3: Extreme Exponent Scaling and Fixed-Point Conversion

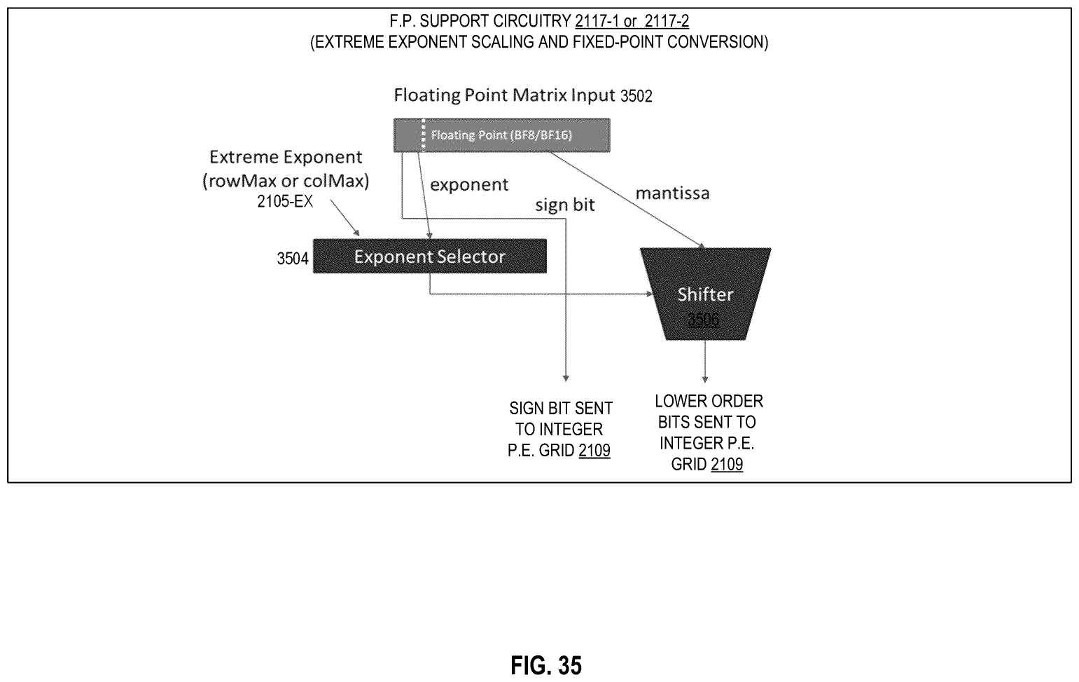

FIG. 35 illustrates an example of low-precision extraction hardware (e.g., floating-point support circuitry 2117-1 and/or 2117-2). In certain examples, this hardware aligns bits of the input to prevent overflow.

In certain examples, the next steps in the method are to convert floating-point values in to appropriately scaled narrow-width (e.g., chunk width as shown in the rightmost three columns of FIG. 27) fixed-point values, using the extreme exponents determined in step 1 to form a common basis across rows and columns. FIG. 35 shows example hardware to achieve this conversion.

FIG. 35 illustrates floating-point support circuitry 2117-1 and/or 2117-2 for extreme exponent scaling and floating-point to fixed-point conversions according to examples of the disclosure. Here, the mantissa bits (e.g., significand) of each floating-point value from matrix input 3502 are shifted by their position relative to the extreme exponent, e.g., and their position relative to the narrow chunk (e.g., sub-word) being operated on. For example, when operating on the second least significant chunk (e.g., sub-word), if the extreme exponent (selected by exponent selector circuitry 3504 for that chunk) is 5 and the present exponent is 2, then a right shift (by shifter 3506) of 3 (5−2)+1*narrow_width would be performed to align the fixed-point value. In the case of irregular values (e.g., subnormal or denormal values), the exponent shift may be adjusted and so this operation is not necessarily a subtraction. In certain examples, the matrix operations accelerator (e.g., floating-point support circuitry) is to detect an irregular value (e.g., subnormal or denormal value) in the input and then flag that as an error and/or terminate the requested matrix operation. In certain examples, where floating-point arithmetic is signed, the floating-point sign bit is propagated into the array (e.g., grid 2109), and signed multiplication is used. In certain examples, these signed values are directly fed into a systolic array supporting signed integer multiplication.

### Step 4: Matrix Multiplication

In certain examples, no modifications or additional floating-point support circuitry is utilized for this step, although the bit widths of the integer multiplications in the array may be optimized (larger or smaller) for certain target markets. In certain examples, this bit width is decoupled from the floating-point type.

### Step 5: C′ Partial Accumulation

In certain examples, intermediate partial sum accumulation hardware (e.g., floating-point support circuitry 2117-3) is included.

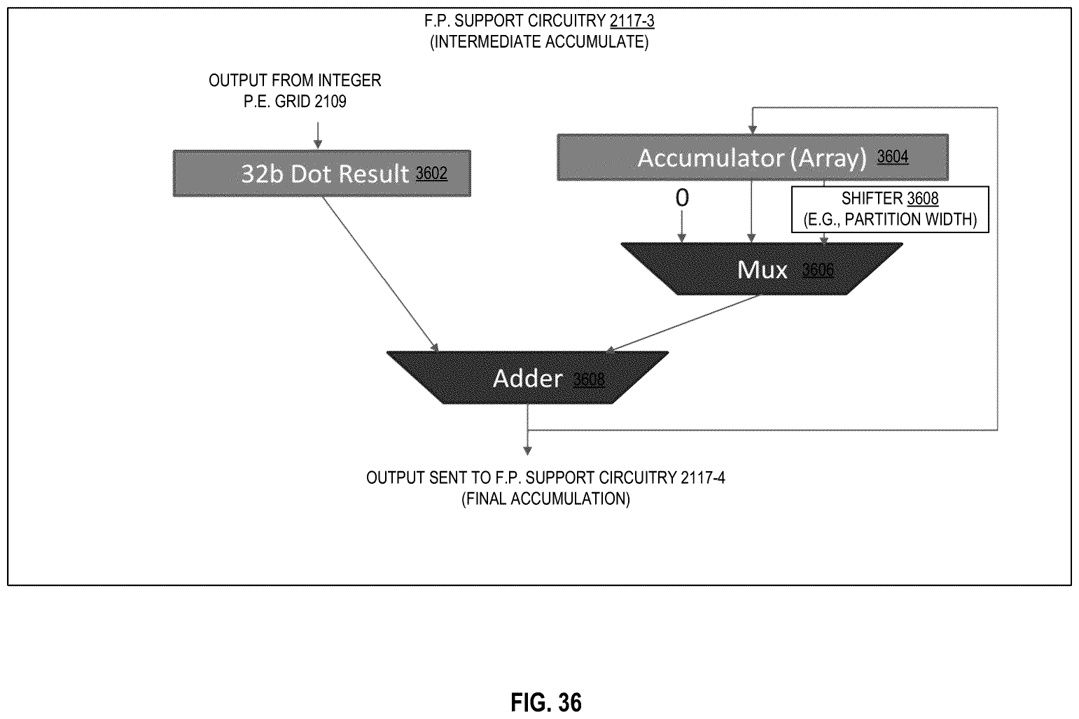

FIG. 36 illustrates floating-point support circuitry 2117-3 for intermediate partial sum accumulation according to examples of the disclosure. In certain examples, during step 5, inner product results are accumulated with previously calculated partial results, which are stored (e.g., in a register 3602). In certain examples, because fixed-point terms are aligned for the computation of a given C′n, for a given chunk (e.g., sub-word) this is simply an addition by adder circuit 3608. In certain examples, during the first accumulation of the first matrix multiplication of a C′n, the value stored and accumulated in accumulator array 3604 is C′n−1, the final result of all accumulations of all prior matrix multiplications. In certain examples, the C′n−1 accumulator values are right shifted by shifter 3608 by narrow_width (e.g., chunk width or chunk offset) to align the fixed-point term. In certain examples, a multiplexer 3606 is utilized to select the desired values, e.g., where during a first accumulation operation, 0 is used as an initializer. In certain examples, multiplexer 3606 is controlled (e.g., by matrix accelerator controller circuitry 2113) to pick the correct accumulation value, e.g., sometimes to select 0, sometimes to select the previously calculated value (without a shift), and sometimes a shifted version of the previous value (e.g., shifted the chunk offset) depending on where the computation is at (e.g., as shown in FIG. 28). In certain examples, integer accumulations may be stored in their own array or they may reuse existing matrix storage.

### Step 6: Extreme Exponent Scaling Inversion and Conversion to Floating-Point.

In certain examples, during Step 6, the fixed-point result calculated in the systolic array is scaled, converted back in to floating-point, and potentially accumulated into a previously computed floating-point partial sum. In certain examples, this step occurs once all matrix multiplications are complete, as data is streamed from the hardware of Step 5 after the final fixed-point accumulation in that step.

In certain examples, internal array operations happen in fixed-point. Thus, in certain examples, a final conversion step back to floating-point is performed before accumulation into a full-precision result matrix. In certain examples, this step inverts the scaling by extreme exponent values done as input values were streamed into the matrix. In certain examples, these scaling inversion factors are referred to as a scaling matrix (S matrix), e.g., scaling matrix 3104 in FIG. 31. In certain examples, all S matrix terms are powers-of-two and so the scaling operation is a shift operation (e.g., left or right). Alternatively, the scaling can be performed post floating-point conversion as a modification to the floating-point exponent.

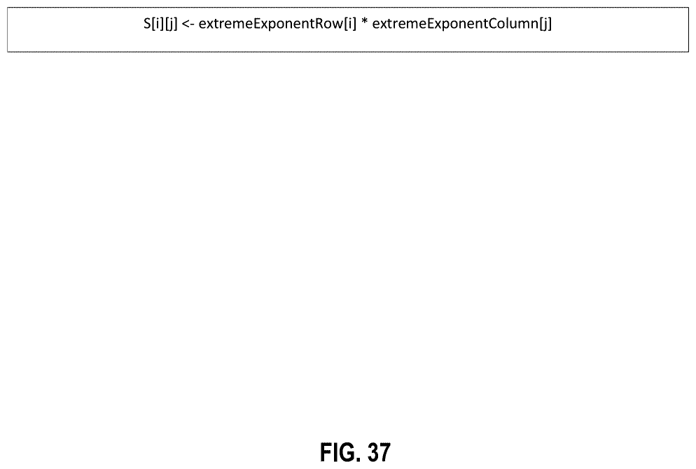

FIG. 37 illustrates an example of the calculation of terms of a scaling matrix (S matrix) according to examples of the disclosure (e.g., but not illustrating the chunk offset scaling discussed herein). Although multiplication is shown, in certain examples all terms are powers of two and are eventually consumed during floating-point addition. In certain examples, S matrix terms are determined as shown in FIG. 37, and are unique per computed dot product in the C matrix. In certain examples, each S matrix term is determined by combining the extreme exponent of the row and column used to produce the dot product.

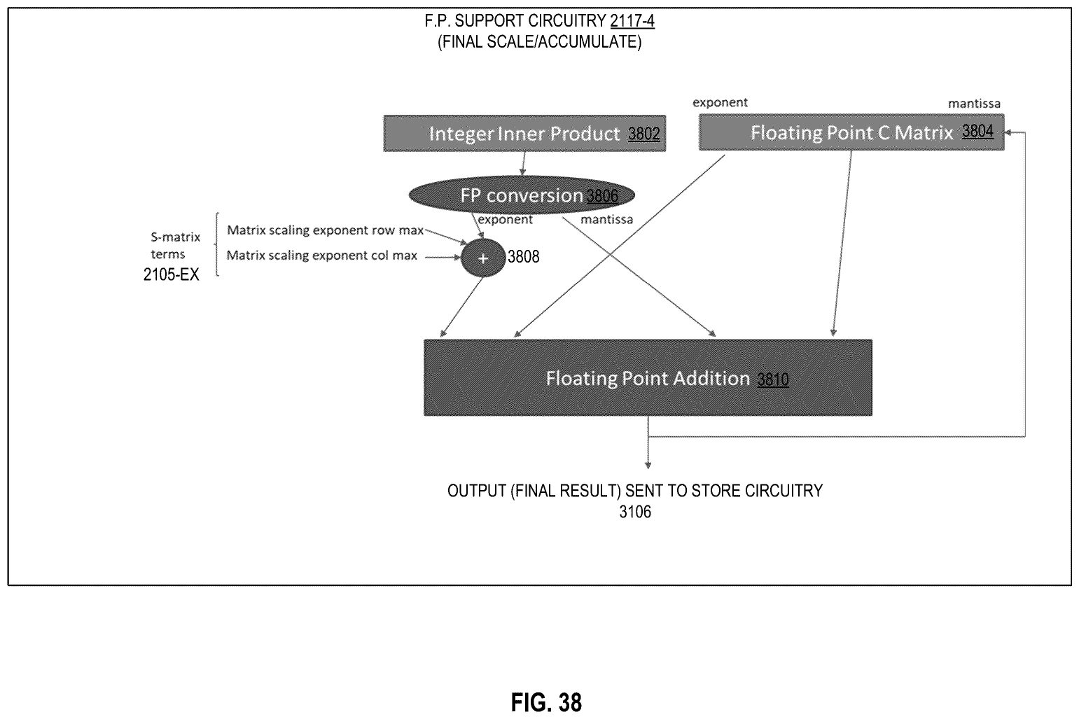

FIG. 38 illustrates floating-point support circuitry a scaling and conversion of a fixed-point value and accumulation into a final floating-point result according to examples of the disclosure.

FIG. 38 shows the hardware (e.g., floating-point support circuitry 2117-4) used for scaling and accumulation of systolic array results. In certain examples, array results (e.g., (e.g., integer) inner product 3802) are converted from fixed-point to floating-point by floating-point conversion circuitry 3806, then the S matrix terms (e.g., generated by an addition of the scaling exponent for a row added to the scaling exponent for a column by adder 3808) are applied to “adjust” the exponent of the floating-point term, see, e.g., FIG. 30. Optionally, this term in accumulated by floating point addition circuitry 3810 into a previously computed partial C matrix 3804 accumulator value.

In some examples, extreme exponents may also be determined for result matrices as those result matrices are being calculated.

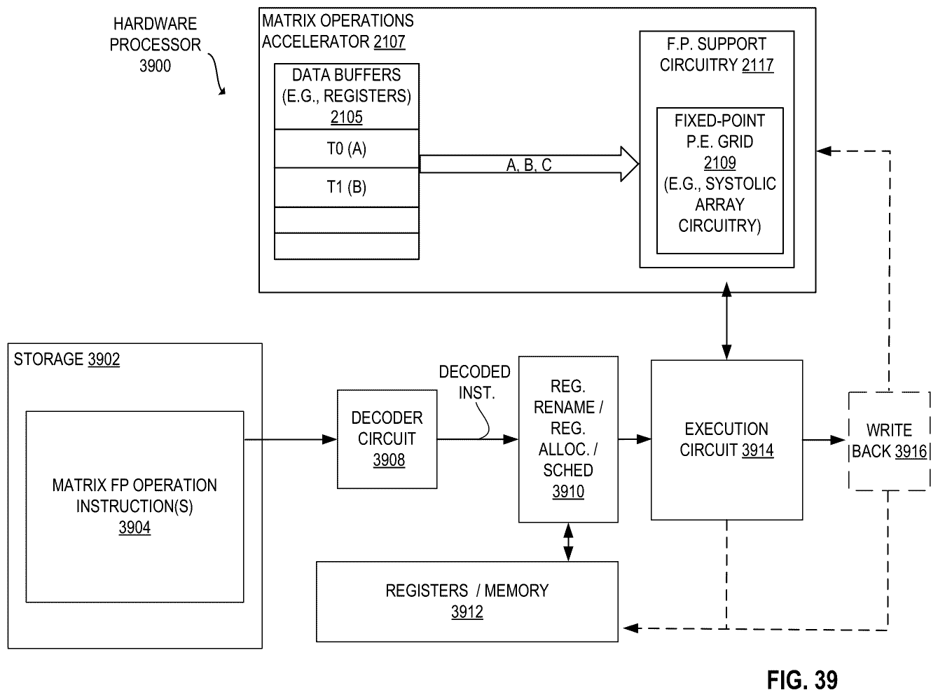

FIG. 39 illustrates a hardware processor 3900 coupled to storage 3902 that includes one or more matrix floating-point (FP) operation instructions 3904 that utilize a matrix operations accelerator 2107 that includes floating-point support circuitry 2117 for a two-dimensional grid 2109 of fixed-point processing elements according to examples of the disclosure. The instructions 3904 may include one or more data selection fields (e.g., operands) that identify data buffers 2105 (e.g., registers forming a tile). In certain examples, matrix operations accelerator 2107 is part of a hardware processor. In certain examples, matrix operations accelerator 2107 is a stand-alone accelerator (e.g., without an attached processor), for example, where matrix operations accelerator 2107 is part of a graphics processing unit (GPU) and/or AI accelerator.

In certain examples, (e.g., where the processor/core supports out-of-order (OoO) execution), the processor includes a register rename/allocator circuit 3910 coupled to register file/memory circuit 3912 (e.g., unit) to allocate resources and perform register renaming on registers (e.g., registers associated with the initial sources and final destination of the instruction). In certain examples, (e.g., for out-of-order execution), the processor includes one or more scheduler circuits 3910 coupled to the decoder circuit 3908. The scheduler circuit(s) may schedule one or more operations associated with decoded instructions, including one or more operations decoded from “matrix floating-point (FP) operation instructions” instructions 3904, e.g., for execution on the execution circuit 3914.

As one example, “matrix floating-point (FP) operation” instruction 3904 is to cause decoding, by decoder circuit 3908 of a hardware processor comprising a matrix operations accelerator circuit 2107 including a two-dimensional grid of fixed-point processing elements 2109, floating-point support circuitry 2117 coupled to the two-dimensional grid of fixed-point processing elements, and storage 2105 for a first, a second, and a destination two-dimensional floating-point matrices coupled to the floating-point support circuitry, a single instruction into a decoded single instruction, the single instruction including a first field that identifies the first two-dimensional floating-point matrix, a second field that identifies the second two-dimensional floating-point matrix, and an opcode that indicates an execution circuit of the hardware processor is to cause the matrix operations accelerator circuit to: determine, by the floating-point support circuitry, an extreme exponent for each row of the first two-dimensional floating-point matrix and for each column of the second two-dimensional floating-point matrix, generate, by the floating-point support circuitry, a first fixed-point matrix from the first two-dimensional floating-point matrix and a second fixed-point matrix from the second two-dimensional floating-point matrix, generate, by the two-dimensional grid of fixed-point processing elements, corresponding fixed-point results by a multiplication of fixed-point elements of the first fixed-point matrix by corresponding fixed-point elements of the second fixed-point matrix, scale, by the floating-point support circuitry, the corresponding fixed-point results according to the extreme exponents to generate scaled fixed-point results, generate, by the floating-point support circuitry, a resultant floating-point matrix from the scaled fixed-point results, and store the resultant floating-point matrix into the destination two-dimensional floating-point matrix, and executing, by the execution circuit 3914 of the hardware processor, the decoded single instruction according to the opcode.

In certain examples, a write back circuit 3916 is included to write back results of an instruction to a destination (e.g., write them to a tile of data buffers 2105), for example, so those results are visible within a processor (e.g., visible outside of the execution circuit that produced those results).

One or more of these components (e.g., decoder 3908, register rename/register allocator/scheduler 3910, execution circuit 3914, registers (e.g., register file)/memory 3912, or write back circuit 3916) may be in a single core of a hardware processor (e.g., and multiple cores each with an instance of these components).

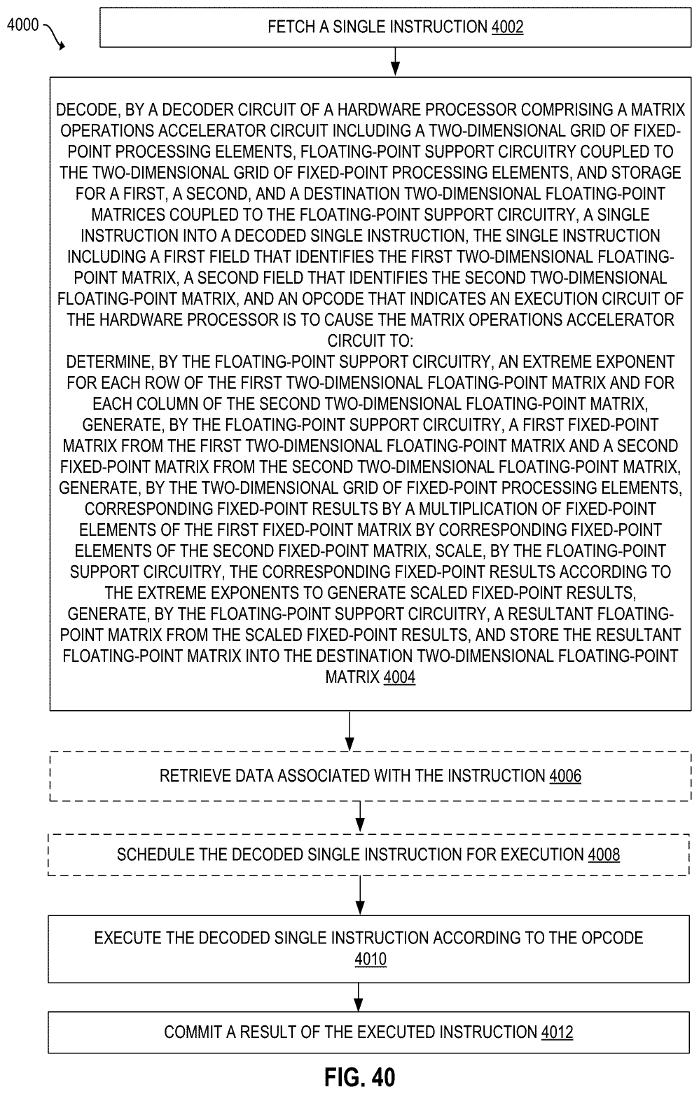

FIG. 40 illustrates a method 4000 of processing a “matrix floating-point (FP) operation” instruction according to examples of the disclosure.

A processor (e.g., or processor core) may perform method 4000, e.g., in response to receiving a request to execute an instruction from software. Depicted method 4000 includes processing a “matrix floating-point (FP) operation” instruction by: fetch an instruction at 4002, decode, by a decoder circuit of a hardware processor comprising a matrix operations accelerator circuit including a two-dimensional grid of fixed-point processing elements, floating-point support circuitry coupled to the two-dimensional grid of fixed-point processing elements, and storage for a first, a second, and a destination two-dimensional floating-point matrices coupled to the floating-point support circuitry, a single instruction into a decoded single instruction, the single instruction including a first field that identifies the first two-dimensional floating-point matrix, a second field that identifies the second two-dimensional floating-point matrix, and an opcode that indicates an execution circuit of the hardware processor is to cause the matrix operations accelerator circuit to: determine, by the floating-point support circuitry, an extreme exponent for each row of the first two-dimensional floating-point matrix and for each column of the second two-dimensional floating-point matrix, generate, by the floating-point support circuitry, a first fixed-point matrix from the first two-dimensional floating-point matrix and a second fixed-point matrix from the second two-dimensional floating-point matrix, generate, by the two-dimensional grid of fixed-point processing elements, corresponding fixed-point results by a multiplication of fixed-point elements of the first fixed-point matrix by corresponding fixed-point elements of the second fixed-point matrix, scale, by the floating-point support circuitry, the corresponding fixed-point results according to the extreme exponents to generate scaled fixed-point results, generate, by the floating-point support circuitry, a resultant floating-point matrix from the scaled fixed-point results, and store the resultant floating-point matrix into the destination two-dimensional floating-point matrix at 4004, (optionally) retrieve data associated with the instruction at 4006, (optionally) schedule the decoded instruction for execution at 4008, execute the decoded instruction according to the opcode at 4010, and commit a result of the executed instruction at 4012.

In one example, the format of an instruction includes a field to identify matrix A, matrix B, and matrix C. e.g., as discussed herein. In certain examples, the opcode of the instruction is to cause the floating-point support circuitry 2117 to function as discussed herein.

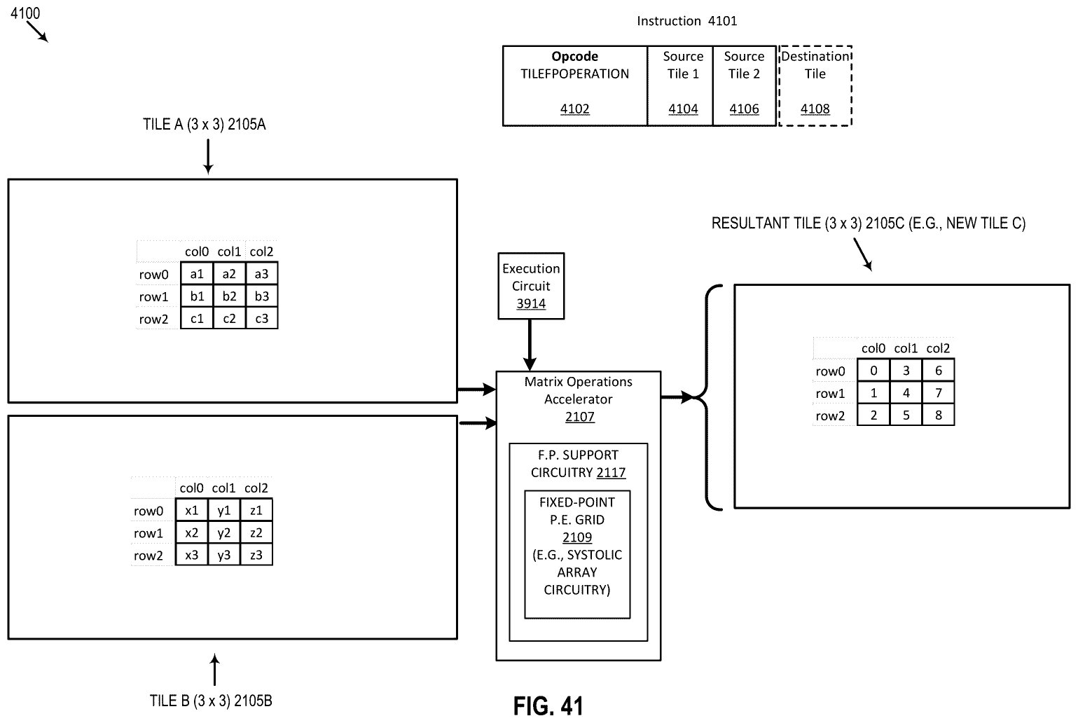

FIG. 41 is a block diagram illustrating use of a “matrix floating-point (FP) operation” instruction according to examples of the disclosure. In certain examples, the opcode of the instruction is to cause the floating-point support circuitry 2117 to function as discussed herein.

As shown, instruction 4101 includes an opcode 4102 (e.g., MATRIXFPOPERATION), which indicates that the processor is to decode, by decoder circuit of a hardware processor comprising a matrix operations accelerator circuit 2107 including a two-dimensional grid of fixed-point processing elements 2109, floating-point support circuitry 2117 coupled to the two-dimensional grid of fixed-point processing elements, and storage 2105 for a first, a second, and a destination two-dimensional floating-point matrices coupled to the floating-point support circuitry, a single instruction into a decoded single instruction, the single instruction including a first field that identifies the first two-dimensional floating-point matrix, a second field that identifies the second two-dimensional floating-point matrix, and an opcode that indicates an execution circuit of the hardware processor is to cause the matrix operations accelerator circuit to: determine, by the floating-point support circuitry, an extreme exponent for each row of the first two-dimensional floating-point matrix and for each column of the second two-dimensional floating-point matrix, generate, by the floating-point support circuitry, a first fixed-point matrix from the first two-dimensional floating-point matrix and a second fixed-point matrix from the second two-dimensional floating-point matrix, generate, by the two-dimensional grid of fixed-point processing elements, corresponding fixed-point results by a multiplication of fixed-point elements of the first fixed-point matrix by corresponding fixed-point elements of the second fixed-point matrix, scale, by the floating-point support circuitry, the corresponding fixed-point results according to the extreme exponents to generate scaled fixed-point results, generate, by the floating-point support circuitry, a resultant floating-point matrix from the scaled fixed-point results, and store the resultant floating-point matrix into the destination two-dimensional floating-point matrix, and execute, by the execution circuit 3914 of the hardware processor, the decoded single instruction according to the opcode. In FIG. 41, tiles A and B each have 9 elements (3×3 tiles), so it in certain examples, the above example for a single row and single column is to be repeated for each set of rows and columns, e.g., to generate each of the 9 floating-point numbers (shown with the labels of 0 to 9) in resultant tile 2105C from the floating-point numbers in tile 2105A (shown with the labels of a1-a3, b1-b3, and c1-c3) and the floating-point numbers in tile 2105B (shown with the labels of x1-x3, y1-y3, and z1-z3) using floating-point support circuitry 2117 and the two-dimensional grid of fixed-point processing elements 2109 as disclosed herein.

Further exemplary architectures, systems, etc. that the above may be used in are detailed below.

At least some examples of the disclosed technologies can be described in view of the following examples:

Example 1. An apparatus comprising:
a matrix operations accelerator circuit comprising:
   a two-dimensional grid of fixed-point (e.g., integer only) processing elements,
   floating-point support circuitry coupled to the two-dimensional grid of fixed-point processing elements, and
   storage for a first, a second, and a destination two-dimensional floating-point matrices coupled to the floating-point support circuitry; and
a hardware processor core coupled to the matrix operations accelerator circuit and comprising:
   a decoder circuit to decode a single instruction into a decoded single instruction, the single instruction including a first field that identifies the first two-dimensional floating-point matrix, a second field that identifies the second two-dimensional floating-point matrix, and an opcode that indicates the matrix operations accelerator circuit is to:
      determine, by the floating-point support circuitry, an extreme exponent for each row of the first two-dimensional floating-point matrix and for each column of the second two-dimensional floating-point matrix,
      generate, by the floating-point support circuitry, a first fixed-point matrix from the first two-dimensional floating-point matrix and a second fixed-point matrix from the second two-dimensional floating-point matrix,
      generate, by the two-dimensional grid of fixed-point processing elements, corresponding fixed-point results by a multiplication of fixed-point elements of the first fixed-point matrix by corresponding fixed-point elements of the second fixed-point matrix,
      scale, by the floating-point support circuitry, the corresponding fixed-point results according to the extreme exponents to generate scaled fixed-point results,
      generate, by the floating-point support circuitry, a resultant floating-point matrix from the scaled fixed-point results, and
      store the resultant floating-point matrix into the destination two-dimensional floating-point matrix.
         Example 2. The apparatus of example 1, wherein the opcode further indicates the matrix operations accelerator circuit is to:
partition each element of the first fixed-point matrix and each element of the second fixed-point matrix into a plurality of chunks,
generate, by the two-dimensional grid of fixed-point processing elements, the corresponding fixed-point results by a multiplication of chunks of the first fixed-point matrix by chunks of the second fixed-point matrix.
   Example 3. The apparatus of example 2, wherein the opcode further indicates the matrix operations accelerator circuit is to scale, by the floating-point support circuitry, the corresponding fixed-point results according to the extreme exponents and a chunk offset to generate the scaled fixed-point results.
   Example 4. The apparatus of example 2, wherein the opcode further indicates the matrix operations accelerator circuit is to partition each element of the first fixed-point matrix and each element of the second fixed-point matrix into at least three chunks.
   Example 5. The apparatus of example 1, wherein the opcode further indicates the matrix operations accelerator circuit is to determine, by the floating-point support circuitry, the extreme exponent for each row of the first two-dimensional floating-point matrix as the first two-dimensional floating-point matrix is loaded into the storage and the extreme exponent for each column of the second two-dimensional floating-point matrix as the second two-dimensional floating-point matrix is loaded into the storage.
   Example 6. The apparatus of example 1, wherein the single instruction includes a third field that identifies a third two-dimensional floating-point matrix, and the opcode further indicates the matrix operations accelerator circuit is to, before the store of the resultant floating-point matrix into the destination two-dimensional floating-point matrix, accumulate each element of the third two-dimensional floating-point matrix with a corresponding element of the resultant floating-point matrix to generate an updated resultant floating-point matrix, wherein the store is of the updated resultant floating-point matrix into the destination two-dimensional floating-point matrix.
   Example 7. The apparatus of example 6, wherein the third two-dimensional floating-point matrix is stored in the storage for the destination two-dimensional floating-point matrix.
   Example 8. The apparatus of any one of examples 1-7, wherein the apparatus does not include a two-dimensional grid of floating-point processing elements.
   Example 9. A method comprising:
decoding, by a decoder circuit of a hardware processor comprising a matrix operations accelerator circuit including a two-dimensional grid of fixed-point processing elements,
   floating-point support circuitry coupled to the two-dimensional grid of fixed-point processing elements, and storage for a first, a second, and a destination two-dimensional floating-point matrices coupled to the floating-point support circuitry, a single instruction into a decoded single instruction, the single instruction including a first field that identifies the first two-dimensional floating-point matrix, a second field that identifies the second two-dimensional floating-point matrix, and an opcode that indicates the matrix operations accelerator circuit is to:
      determine, by the floating-point support circuitry, an extreme exponent for each row of the first two-dimensional floating-point matrix and for each column of the second two-dimensional floating-point matrix,
      generate, by the floating-point support circuitry, a first fixed-point matrix from the first two-dimensional floating-point matrix and a second fixed-point matrix from the second two-dimensional floating-point matrix,
      generate, by the two-dimensional grid of fixed-point processing elements, corresponding fixed-point results by a multiplication of fixed-point elements of the first fixed-point matrix by corresponding fixed-point elements of the second fixed-point matrix,
      scale, by the floating-point support circuitry, the corresponding fixed-point results according to the extreme exponents to generate scaled fixed-point results,
      generate, by the floating-point support circuitry, a resultant floating-point matrix from the scaled fixed-point results, and
      store the resultant floating-point matrix into the destination two-dimensional floating-point matrix, and
      executing, by the matrix operations accelerator circuit, the decoded single instruction according to the opcode.
         Example 10. The method of example 9, wherein the opcode further indicates the matrix operations accelerator circuit is to:
partition each element of the first fixed-point matrix and each element of the second fixed-point matrix into a plurality of chunks,
generate, by the two-dimensional grid of fixed-point processing elements, the corresponding fixed-point results by a multiplication of chunks of the first fixed-point matrix by chunks of the second fixed-point matrix.
   Example 11. The method of example 10, wherein the opcode further indicates the matrix operations accelerator circuit is to scale, by the floating-point support circuitry, the corresponding fixed-point results according to the extreme exponents and a chunk offset to generate the scaled fixed-point results.
   Example 12. The method of example 10, wherein the opcode further indicates the matrix operations accelerator circuit is to partition each element of the first fixed-point matrix and each element of the second fixed-point matrix into at least three chunks.
   Example 13. The method of example 9, wherein the opcode further indicates the matrix operations accelerator circuit is to determine, by the floating-point support circuitry, the extreme exponent for each row of the first two-dimensional floating-point matrix as the first two-dimensional floating-point matrix is loaded into the storage and the extreme exponent for each column of the second two-dimensional floating-point matrix as the second two-dimensional floating-point matrix is loaded into the storage.
   Example 14. The method of example 9, wherein the single instruction includes a third field that identifies a third two-dimensional floating-point matrix, and the opcode further indicates the matrix operations accelerator circuit is to, before the store of the resultant floating-point matrix into the destination two-dimensional floating-point matrix, accumulate each element of the third two-dimensional floating-point matrix with a corresponding element of the resultant floating-point matrix to generate an updated resultant floating-point matrix, wherein the store is of the updated resultant floating-point matrix into the destination two-dimensional floating-point matrix.
   Example 15. The method of example 14, wherein the third two-dimensional floating-point matrix is stored in the storage for the destination two-dimensional floating-point matrix.
   Example 16. The method of any one of examples 9-15, wherein the hardware processor does not utilize a two-dimensional grid of floating-point processing elements to generate the resultant floating-point matrix.
   Example 17. An apparatus comprising:
a two-dimensional grid of fixed-point processing elements;
floating-point support circuitry coupled to the two-dimensional grid of fixed-point processing elements;
storage for a first, a second, and a destination two-dimensional floating-point matrices coupled to the floating-point support circuitry; and
controller circuitry to cause the two-dimensional grid of fixed-point processing elements and the floating-point support circuitry to:
   determine, by the floating-point support circuitry, an extreme exponent for each row of the first two-dimensional floating-point matrix and for each column of the second two-dimensional floating-point matrix,
   generate, by the floating-point support circuitry, a first fixed-point matrix from the first two-dimensional floating-point matrix and a second fixed-point matrix from the second two-dimensional floating-point matrix,
   generate, by the two-dimensional grid of fixed-point processing elements, corresponding fixed-point results by a multiplication of fixed-point elements of the first fixed-point matrix by corresponding fixed-point elements of the second fixed-point matrix,
   scale, by the floating-point support circuitry, the corresponding fixed-point results according to the extreme exponents to generate scaled fixed-point results,
   generate, by the floating-point support circuitry, a resultant floating-point matrix from the scaled fixed-point results, and
   store the resultant floating-point matrix into the destination two-dimensional floating-point matrix.
      Example 18. The apparatus of example 17, wherein the controller circuitry is to cause the two-dimensional grid of fixed-point processing elements and the floating-point support circuitry to:
partition each element of the first fixed-point matrix and each element of the second fixed-point matrix into a plurality of chunks,
generate, by the two-dimensional grid of fixed-point processing elements, the corresponding fixed-point results by a multiplication of chunks of the first fixed-point matrix by chunks of the second fixed-point matrix.
   Example 19. The apparatus of example 18, wherein the controller circuitry is to cause the floating-point support circuitry to scale the corresponding fixed-point results according to the extreme exponents and a chunk offset to generate the scaled fixed-point results.
   Example 20. The apparatus of example 18, wherein the controller circuitry is to cause the floating-point support circuitry to partition each element of the first fixed-point matrix and each element of the second fixed-point matrix into at least three chunks.
   Example 21. The apparatus of example 17, wherein the controller circuitry is to cause the floating-point support circuitry to determine the extreme exponent for each row of the first two-dimensional floating-point matrix as the first two-dimensional floating-point matrix is loaded into the storage and the extreme exponent for each column of the second two-dimensional floating-point matrix as the second two-dimensional floating-point matrix is loaded into the storage.
   Example 22. The apparatus of example 17, wherein the storage is also for a third two-dimensional floating-point matrix, and the controller circuitry is to cause the floating-point support circuitry to, before the store of the resultant floating-point matrix into the destination two-dimensional floating-point matrix, accumulate each element of the third two-dimensional floating-point matrix with a corresponding element of the resultant floating-point matrix to generate an updated resultant floating-point matrix, wherein the store is of the updated resultant floating-point matrix into the destination two-dimensional floating-point matrix.
   Example 23. The apparatus of example 22, wherein the third two-dimensional floating-point matrix is stored in the storage for the destination two-dimensional floating-point matrix.
   Example 24. The apparatus of any one of examples 17-23, wherein the apparatus does not include a two-dimensional grid of floating-point processing elements.

In yet another example, an apparatus comprises a data storage device that stores code that when executed by a hardware processor causes the hardware processor to perform any method disclosed herein. An apparatus may be as described in the detailed description. A method may be as described in the detailed description.

### Example Computer Architectures.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

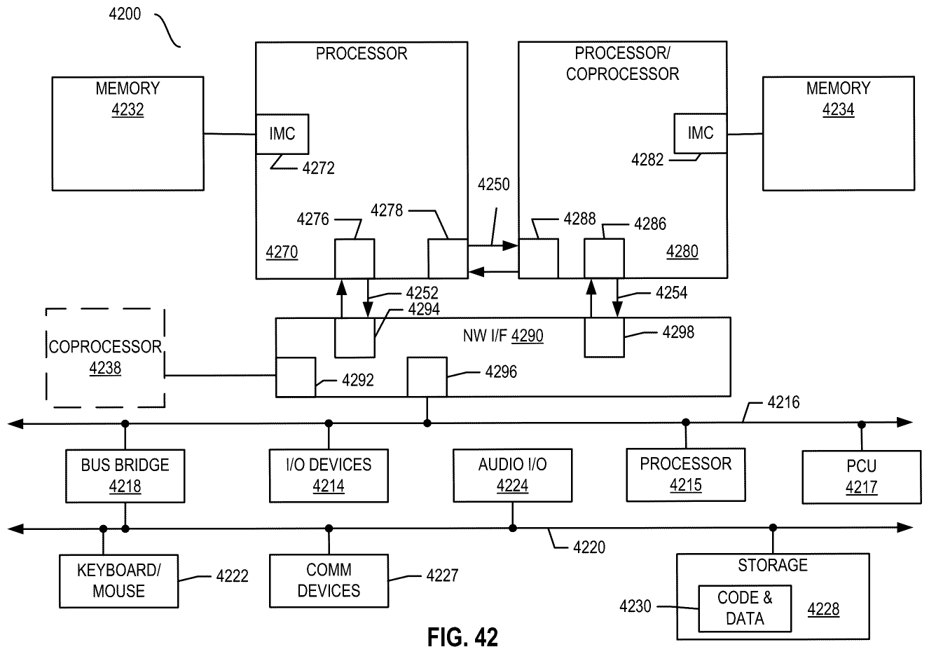

FIG. 42 illustrates an example computing system. Multiprocessor system 4200 is an interfaced system and includes a plurality of processors or cores including a first processor 4270 and a second processor 4280 coupled via an interface 4250 such as a point-to-point (P-P) interconnect, a fabric, and/or bus. In some examples, the first processor 4270 and the second processor 4280 are homogeneous. In some examples, first processor 4270 and the second processor 4280 are heterogenous. Though the example system 4200 is shown to have two processors, the system may have three or more processors, or may be a single processor system. In some examples, the computing system is a system on a chip (SoC).

Processors 4270 and 4280 are shown including integrated memory controller (IMC) circuitry 4272 and 4282, respectively. Processor 4270 also includes interface circuits 4276 and 4278; similarly, second processor 4280 includes interface circuits 4286 and 4288. Processors 4270, 4280 may exchange information via the interface 4250 using interface circuits 4278, 4288. IMCs 4272 and 4282 couple the processors 4270, 4280 to respective memories, namely a memory 4232 and a memory 4234, which may be portions of main memory locally attached to the respective processors.

Processors 4270, 4280 may each exchange information with a network interface (NW I/F) 4290 via individual interfaces 4252, 4254 using interface circuits 4276, 4294, 4286, 4298. The network interface 4290 (e.g., one or more of an interconnect, bus, and/or fabric, and in some examples is a chipset) may optionally exchange information with a coprocessor 4238 via an interface circuit 4292. In some examples, the coprocessor 4238 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 4270, 4280 or outside of both processors, yet connected with the processors via an interface such as P-P interconnect, such that either or both processors' local cache information may be stored in the shared cache if a processor is placed into a low power mode.

Network interface 4290 may be coupled to a first interface 4216 via interface circuit 4296. In some examples, first interface 4216 may be an interface such as a Peripheral Component Interconnect (PCI) interconnect, a PCI Express interconnect or another I/O interconnect. In some examples, first interface 4216 is coupled to a power control unit (PCU) 4217, which may include circuitry, software, and/or firmware to perform power management operations with regard to the processors 4270, 4280 and/or co-processor 4238. PCU 4217 provides control information to a voltage regulator (not shown) to cause the voltage regulator to generate the appropriate regulated voltage. PCU 4217 also provides control information to control the operating voltage generated. In various examples, PCU 4217 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 4217 is illustrated as being present as logic separate from the processor 4270 and/or processor 4280. In other cases, PCU 4217 may execute on a given one or more of cores (not shown) of processor 4270 or 4280. In some cases, PCU 4217 may be implemented as a microcontroller (dedicated or general-purpose) or other control logic configured to execute its own dedicated power management code, sometimes referred to as P-code. In yet other examples, power management operations to be performed by PCU 4217 may be implemented externally to a processor, such as by way of a separate power management integrated circuit (PMIC) or another component external to the processor. In yet other examples, power management operations to be performed by PCU 4217 may be implemented within BIOS or other system software.

Various I/O devices 4214 may be coupled to first interface 4216, along with a bus bridge 4218 which couples first interface 4216 to a second interface 4220. In some examples, one or more additional processor(s) 4215, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 4216. In some examples, second interface 4220 may be a low pin count (LPC) interface. Various devices may be coupled to second interface 4220 including, for example, a keyboard and/or mouse 4222, communication devices 4227 and storage circuitry 4228. Storage circuitry 4228 may be one or more non-transitory machine-readable storage media as described below, such as a disk drive or other mass storage device which may include instructions/code and data 4230 and may implement the storage 4228 in some examples. Further, an audio I/O 4224 may be coupled to second interface 4220. Note that other architectures than the point-to-point architecture described above are possible. For example, instead of the point-to-point architecture, a system such as multiprocessor system 4200 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

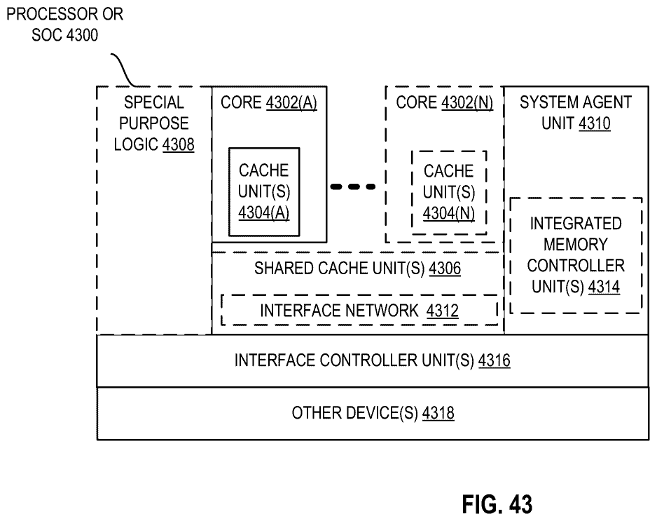

FIG. 43 illustrates a block diagram of an example processor and/or SoC 4300 that may have one or more cores and an integrated memory controller. The solid lined boxes illustrate a processor 4300 with a single core 4302(A), system agent unit circuitry 4310, and a set of one or more interface controller unit(s) circuitry 4316, while the optional addition of the dashed lined boxes illustrates an alternative processor 4300 with multiple cores 4302(A)-(N), a set of one or more integrated memory controller unit(s) circuitry 4314 in the system agent unit circuitry 4310, and special purpose logic 4308, as well as a set of one or more interface controller units circuitry 4316. Note that the processor 4300 may be one of the processors 4270 or 4280, or co-processor 4238 or 4215 of FIG. 42.

Thus, different implementations of the processor 4300 may include: 1) a CPU with the special purpose logic 4308 being integrated graphics and/or scientific (throughput) logic (which may include one or more cores, not shown), and the cores 4302(A)-(N) being one or more general purpose cores (e.g., general purpose in-order cores, general purpose out-of-order cores, or a combination of the two); 2) a coprocessor with the cores 4302(A)-(N) being a large number of special purpose cores intended primarily for graphics and/or scientific (throughput); and 3) a coprocessor with the cores 4302(A)-(N) being a large number of general purpose in-order cores. Thus, the processor 4300 may be a general-purpose processor, coprocessor, or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 4300 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 4304(A)-(N) within the cores 4302(A)-(N), a set of one or more shared cache unit(s) circuitry 4306, and external memory (not shown) coupled to the set of integrated memory controller unit(s) circuitry 4314. The set of one or more shared cache unit(s) circuitry 4306 may include one or more mid-level caches, such as level 2 (L2), level 3 (L3), level 4 (L4), or other levels of cache, such as a last level cache (LLC), and/or combinations thereof. While in some examples interface network circuitry 4312 (e.g., a ring interconnect) interfaces the special purpose logic 4308 (e.g., integrated graphics logic), the set of shared cache unit(s) circuitry 4306, and the system agent unit circuitry 4310, alternative examples use any number of well-known techniques for interfacing such units. In some examples, coherency is maintained between one or more of the shared cache unit(s) circuitry 4306 and cores 4302(A)-(N). In some examples, interface controller units circuitry 4316 couple the cores 4302 to one or more other devices 4318 such as one or more I/O devices, storage, one or more communication devices (e.g., wireless networking, wired networking, etc.), etc.

In some examples, one or more of the cores 4302(A)-(N) are capable of multi-threading. The system agent unit circuitry 4310 includes those components coordinating and operating cores 4302(A)-(N). The system agent unit circuitry 4310 may include, for example, power control unit (PCU) circuitry and/or display unit circuitry (not shown). The PCU may be or may include logic and components needed for regulating the power state of the cores 4302(A)-(N) and/or the special purpose logic 4308 (e.g., integrated graphics logic). The display unit circuitry is for driving one or more externally connected displays.

The cores 4302(A)-(N) may be homogenous in terms of instruction set architecture (ISA). Alternatively, the cores 4302(A)-(N) may be heterogeneous in terms of ISA; that is, a subset of the cores 4302(A)-(N) may be capable of executing an ISA, while other cores may be capable of executing only a subset of that ISA or another ISA.

### Example Core Architectures—In-Order and Out-of-Order Core Block Diagram.

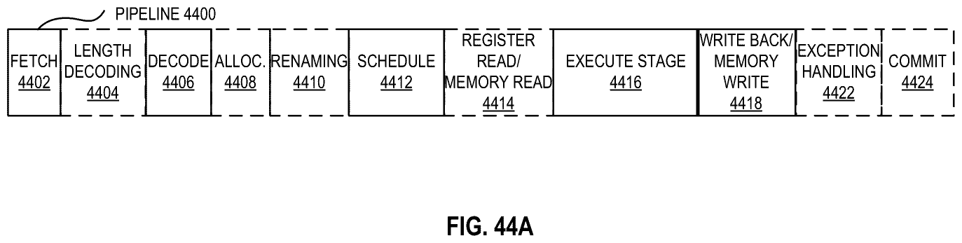

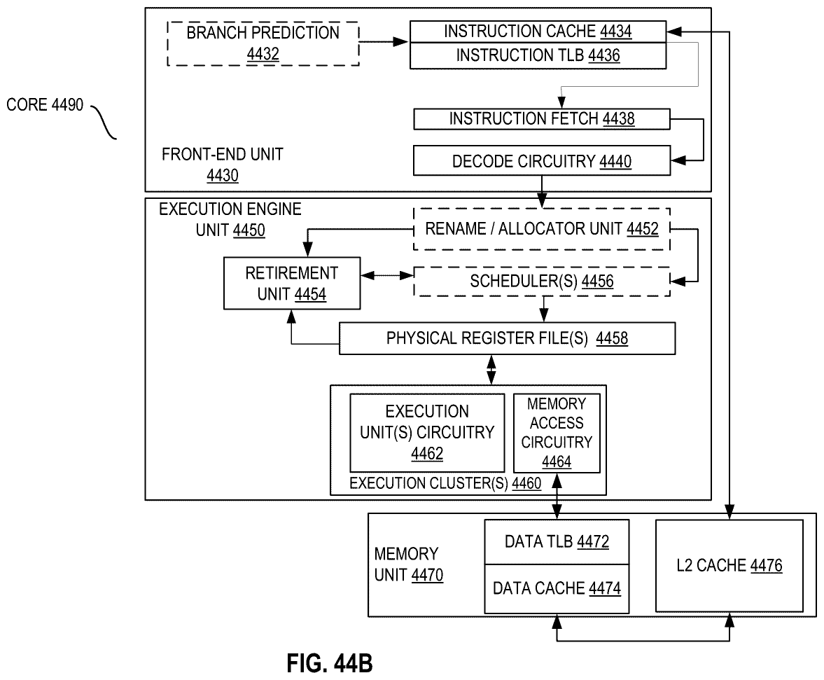

FIG. 44A is a block diagram illustrating both an example in-order pipeline and an example register renaming, out-of-order issue/execution pipeline according to examples. FIG. 44B is a block diagram illustrating both an example in-order architecture core and an example register renaming, out-of-order issue/execution architecture core to be included in a processor according to examples. The solid lined boxes in FIGS. 44A-44B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 44A, a processor pipeline 4400 includes a fetch stage 4402, an optional length decoding stage 4404, a decode stage 4406, an optional allocation (Alloc) stage 4408, an optional renaming stage 4410, a schedule (also known as a dispatch or issue) stage 4412, an optional register read/memory read stage 4414, an execute stage 4416, a write back/memory write stage 4418, an optional exception handling stage 4422, and an optional commit stage 4424. One or more operations can be performed in each of these processor pipeline stages. For example, during the fetch stage 4402, one or more instructions are fetched from instruction memory, and during the decode stage 4406, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 4406 and the register read/memory read stage 4414 may be combined into one pipeline stage. In one example, during the execute stage 4416, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 44B may implement the pipeline 4400 as follows: 1) the instruction fetch circuitry 4438 performs the fetch and length decoding stages 4402 and 4404; 2) the decode circuitry 4440 performs the decode stage 4406; 3) the rename/allocator unit circuitry 4452 performs the allocation stage 4408 and renaming stage 4410; 4) the scheduler(s) circuitry 4456 performs the schedule stage 4412; 5) the physical register file(s) circuitry 4458 and the memory unit circuitry 4470 perform the register read/memory read stage 4414; the execution cluster(s) 4460 perform the execute stage 4416; 6) the memory unit circuitry 4470 and the physical register file(s) circuitry 4458 perform the write back/memory write stage 4418; 7) various circuitry may be involved in the exception handling stage 4422; and 8) the retirement unit circuitry 4454 and the physical register file(s) circuitry 4458 perform the commit stage 4424.

FIG. 44B shows a processor core 4490 including front-end unit circuitry 4430 coupled to execution engine unit circuitry 4450, and both are coupled to memory unit circuitry 4470. The core 4490 may be a reduced instruction set architecture computing (RISC) core, a complex instruction set architecture computing (CISC) core, a very long instruction word (VLIW) core, or a hybrid or alternative core type. As yet another option, the core 4490 may be a special-purpose core, such as, for example, a network or communication core, compression engine, coprocessor core, general purpose computing graphics processing unit (GPGPU) core, graphics core, or the like.

The front-end unit circuitry 4430 may include branch prediction circuitry 4432 coupled to instruction cache circuitry 4434, which is coupled to an instruction translation lookaside buffer (TLB) 4436, which is coupled to instruction fetch circuitry 4438, which is coupled to decode circuitry 4440. In one example, the instruction cache circuitry 4434 is included in the memory unit circuitry 4470 rather than the front-end circuitry 4430. The decode circuitry 4440 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 4440 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 4440 may be implemented using various different mechanisms. Examples of suitable mechanisms include, but are not limited to, look-up tables, hardware implementations, programmable logic arrays (PLAs), microcode read only memories (ROMs), etc. In one example, the core 4490 includes a microcode ROM (not shown) or other medium that stores microcode for certain macroinstructions (e.g., in decode circuitry 4440 or otherwise within the front-end circuitry 4430). In one example, the decode circuitry 4440 includes a micro-operation (micro-op) or operation cache (not shown) to hold/cache decoded operations, micro-tags, or micro-operations generated during the decode or other stages of the processor pipeline 4400. The decode circuitry 4440 may be coupled to rename/allocator unit circuitry 4452 in the execution engine circuitry 4450.

The execution engine circuitry 4450 includes the rename/allocator unit circuitry 4452 coupled to retirement unit circuitry 4454 and a set of one or more scheduler(s) circuitry 4456. The scheduler(s) circuitry 4456 represents any number of different schedulers, including reservations stations, central instruction window, etc. In some examples, the scheduler(s) circuitry 4456 can include arithmetic logic unit (ALU) scheduler/scheduling circuitry, ALU queues, address generation unit (AGU) scheduler/scheduling circuitry, AGU queues, etc. The scheduler(s) circuitry 4456 is coupled to the physical register file(s) circuitry 4458. Each of the physical register file(s) circuitry 4458 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 4458 includes vector registers unit circuitry, writemask registers unit circuitry, and scalar register unit circuitry. These register units may provide architectural vector registers, vector mask registers, general-purpose registers, etc. The physical register file(s) circuitry 4458 is coupled to the retirement unit circuitry 4454 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 4454 and the physical register file(s) circuitry 4458 are coupled to the execution cluster(s) 4460. The execution cluster(s) 4460 includes a set of one or more execution unit(s) circuitry 4462 and a set of one or more memory access circuitry 4464. The execution unit(s) circuitry 4462 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 4456, physical register file(s) circuitry 4458, and execution cluster(s) 4460 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 4464). It should also be understood that where separate pipelines are used, one or more of these pipelines may be out-of-order issue/execution and the rest in-order.

In some examples, the execution engine unit circuitry 4450 may perform load store unit (LSU) address/data pipelining to an Advanced Microcontroller Bus (AMB) interface (not shown), and address phase and writeback, data phase load, store, and branches.

The set of memory access circuitry 4464 is coupled to the memory unit circuitry 4470, which includes data TLB circuitry 4472 coupled to data cache circuitry 4474 coupled to level 2 (L2) cache circuitry 4476. In one example, the memory access circuitry 4464 may include load unit circuitry, store address unit circuitry, and store data unit circuitry, each of which is coupled to the data TLB circuitry 4472 in the memory unit circuitry 4470. The instruction cache circuitry 4434 is further coupled to the level 2 (L2) cache circuitry 4476 in the memory unit circuitry 4470. In one example, the instruction cache 4434 and the data cache 4474 are combined into a single instruction and data cache (not shown) in L2 cache circuitry 4476, level 3 (L3) cache circuitry (not shown), and/or main memory. The L2 cache circuitry 4476 is coupled to one or more other levels of cache and eventually to a main memory.

The core 4490 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 4490 includes logic to support a packed data instruction set architecture extension (e.g., AVX1, AVX2), thereby allowing the operations used by many multimedia applications to be performed using packed data.

### Example Execution Unit(s) Circuitry.

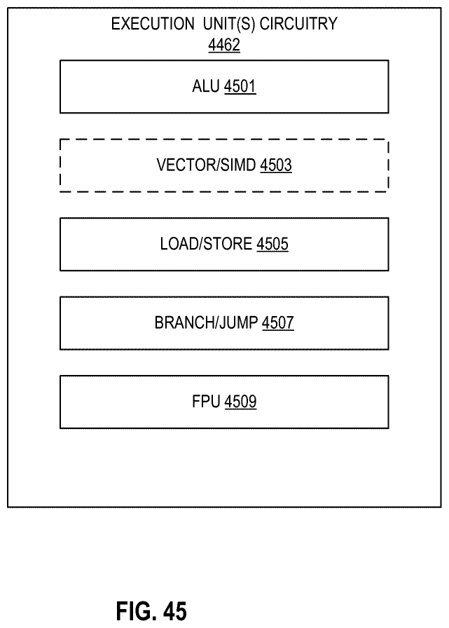

FIG. 45 illustrates examples of execution unit(s) circuitry, such as execution unit(s) circuitry 4462 of FIG. 44B. As illustrated, execution unit(s) circuitry 4462 may include one or more ALU circuits 4501, optional vector/single instruction multiple data (SIMD) circuits 4503, load/store circuits 4505, branch/jump circuits 4507, and/or Floating-point unit (FPU) circuits 4509. ALU circuits 4501 perform integer arithmetic and/or Boolean operations. Vector/SIMD circuits 4503 perform vector/SIMD operations on packed data (such as SIMD/vector registers). Load/store circuits 4505 execute load and store instructions to load data from memory into registers or store from registers to memory. Load/store circuits 4505 may also generate addresses. Branch/jump circuits 4507 cause a branch or jump to a memory address depending on the instruction. FPU circuits 4509 perform floating-point arithmetic. The width of the execution unit(s) circuitry 4462 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

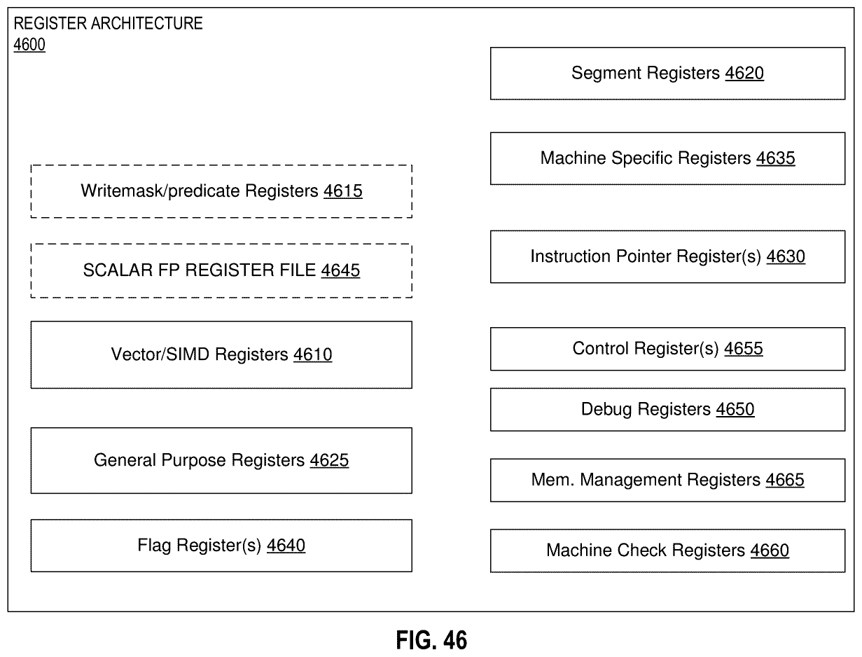

FIG. 46 is a block diagram of a register architecture 4600 according to some examples. As illustrated, the register architecture 4600 includes vector/SIMD registers 4610 that vary from 128-bit to 1,024 bits width. In some examples, the vector/SIMD registers 4610 are physically 512-bits and, depending upon the mapping, only some of the lower bits are used. For example, in some examples, the vector/SIMD registers 4610 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 4600 includes writemask/predicate registers 4615. For example, in some examples, there are 8 writemask/predicate registers (sometimes called k0 through k7) that are each 16-bit, 32-bit, 64-bit, or 128-bit in size. Writemask/predicate registers 4615 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 4615 corresponds to a data element position of the destination. In other examples, the writemask/predicate registers 4615 are scalable and consists of a set number of enable bits for a given vector element (e.g., 8 enable bits per 64-bit vector element).

The register architecture 4600 includes a plurality of general-purpose registers 4625. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 4600 includes scalar floating-point (FP) register file 4645 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 4640 (e.g., EFLAGS, RFLAGS, etc.) store status and control information for arithmetic, compare, and system operations. For example, the one or more flag registers 4640 may store condition code information such as carry, parity, auxiliary carry, zero, sign, and overflow. In some examples, the one or more flag registers 4640 are called program status and control registers.

Segment registers 4620 contain segment points for use in accessing memory. In some examples, these registers are referenced by the names CS, DS, SS, ES, FS, and GS.

Machine specific registers (MSRs) 4635 control and report on processor performance. Most MSRs 4635 handle system-related functions and are not accessible to an application program. Machine check registers 4660 consist of control, status, and error reporting MSRs that are used to detect and report on hardware errors.

One or more instruction pointer register(s) 4630 store an instruction pointer value. Control register(s) 4655 (e.g., CR0-CR4) determine the operating mode of a processor (e.g., processor 4270, 4280, 4238, 4215, and/or 4300) and the characteristics of a currently executing task. Debug registers 4650 control and allow for the monitoring of a processor or core's debugging operations.

Memory (mem) management registers 4665 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 4600 may, for example, be used in register files 1315, 1415, 1819, or physical register file(s) circuitry 4458.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

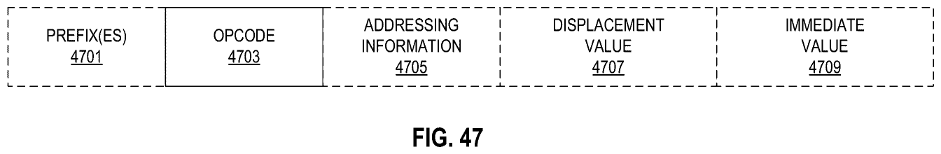

FIG. 47 illustrates examples of an instruction format. As illustrated, an instruction may include multiple components including, but not limited to, one or more fields for: one or more prefixes 4701, an opcode 4703, addressing information 4705 (e.g., register identifiers, memory addressing information, etc.), a displacement value 4707, and/or an immediate value 4709. Note that some instructions utilize some or all the fields of the format whereas others may only use the field for the opcode 4703. In some examples, the order illustrated is the order in which these fields are to be encoded, however, it should be appreciated that in other examples these fields may be encoded in a different order, combined, etc.

The prefix(es) field(s) 4701, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 4703 is used to at least partially define the operation to be performed upon a decoding of the instruction. In some examples, a primary opcode encoded in the opcode field 4703 is one, two, or three bytes in length. In other examples, a primary opcode can be a different length. An additional 3-bit opcode field is sometimes encoded in another field.

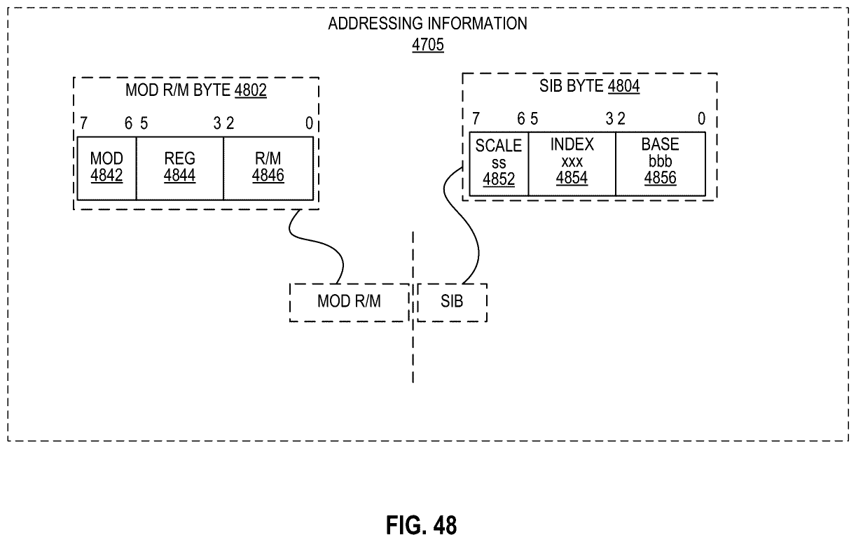

The addressing information field 4705 is used to address one or more operands of the instruction, such as a location in memory or one or more registers. FIG. 48 illustrates examples of the addressing information field 4705. In this illustration, an optional MOD R/M byte 4802 and an optional Scale, Index, Base (SIB) byte 4804 are shown. The MOD R/M byte 4802 and the SIB byte 4804 are used to encode up to two operands of an instruction, each of which is a direct register or effective memory address. Note that both of these fields are optional in that not all instructions include one or more of these fields. The MOD R/M byte 4802 includes a MOD field 4842, a register (reg) field 4844, and R/M field 4846.

The content of the MOD field 4842 distinguishes between memory access and non-memory access modes. In some examples, when the MOD field 4842 has a binary value of 11 (11b), a register-direct addressing mode is utilized, and otherwise a register-indirect addressing mode is used.

The register field 4844 may encode either the destination register operand or a source register operand or may encode an opcode extension and not be used to encode any instruction operand. The content of register field 4844, directly or through address generation, specifies the locations of a source or destination operand (either in a register or in memory). In some examples, the register field 4844 is supplemented with an additional bit from a prefix (e.g., prefix 4701) to allow for greater addressing.

The R/M field 4846 may be used to encode an instruction operand that references a memory address or may be used to encode either the destination register operand or a source register operand. Note the R/M field 4846 may be combined with the MOD field 4842 to dictate an addressing mode in some examples.

The SIB byte 4804 includes a scale field 4852, an index field 4854, and a base field 4856 to be used in the generation of an address. The scale field 4852 indicates a scaling factor. The index field 4854 specifies an index register to use. In some examples, the index field 4854 is supplemented with an additional bit from a prefix (e.g., prefix 4701) to allow for greater addressing. The base field 4856 specifies a base register to use. In some examples, the base field 4856 is supplemented with an additional bit from a prefix (e.g., prefix 4701) to allow for greater addressing. In practice, the content of the scale field 4852 allows for the scaling of the content of the index field 4854 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. valuc. In some examples, the displacement field 4707 provides this value. Additionally, in some examples, a displacement factor usage is encoded in the MOD field of the addressing information field 4705 that indicates a compressed displacement scheme for which a displacement value is calculated and stored in the displacement field 4707.

In some examples, the immediate value field 4709 specifies an immediate value for the instruction. An immediate value may be encoded as a 1-byte value, a 2-byte value, a 4-byte value, etc.

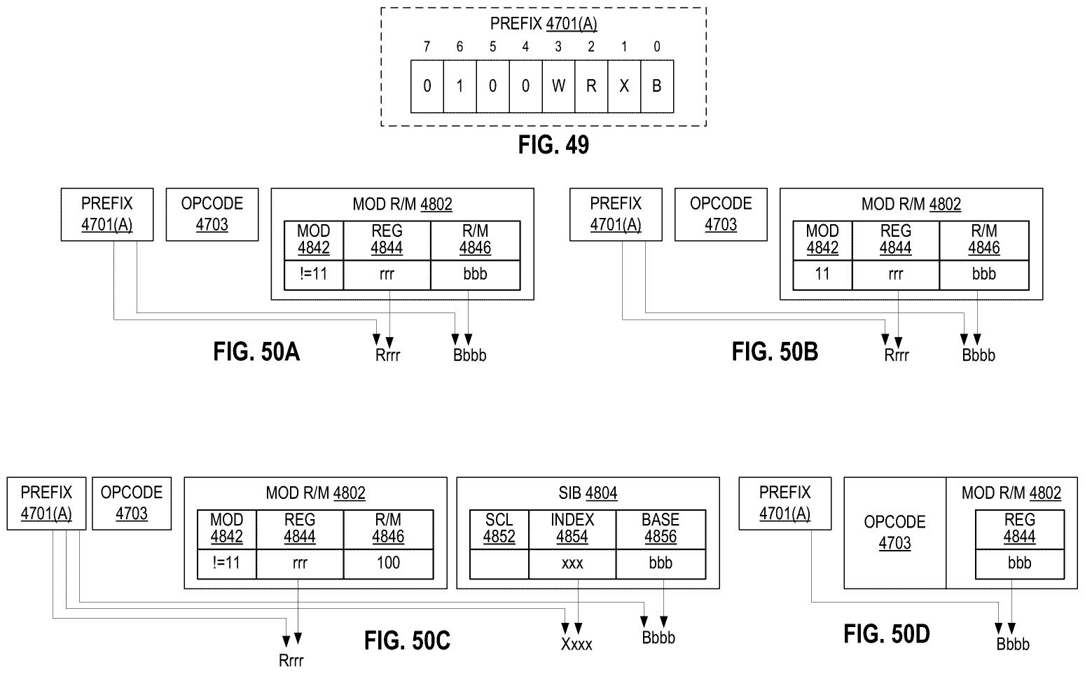

FIG. 49 illustrates examples of a first prefix 4701(A). In some examples, the first prefix 4701(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 4701(A) may specify up to three registers using 3-bit fields depending on the format: 1) using the reg field 4844 and the R/M field 4846 of the MOD R/M byte 4802; 2) using the MOD R/M byte 4802 with the SIB byte 4804 including using the reg field 4844 and the base field 4856 and index field 4854; or 3) using the register field of an opcode.

In the first prefix 4701(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 4844 and MOD R/M R/M field 4846 alone can each only address 8 registers.

In the first prefix 4701(A), bit position 2 (R) may be an extension of the MOD R/M reg field 4844 and may be used to modify the MOD R/M reg field 4844 when that field encodes a general-purpose register, a 64-bit packed data register (e.g., an SSE register), or a control or debug register. R is ignored when MOD R/M byte 4802 specifies other registers or defines an extended opcode.

Bit position 1 (X) may modify the SIB byte index field 4854.

Bit position 0 (B) may modify the base in the MOD R/M R/M field 4846 or the SIB byte base field 4856; or it may modify the opcode register field used for accessing general purpose registers (e.g., general purpose registers 4625).

FIGS. 50A-50D illustrate examples of how the R, X, and B fields of the first prefix 4701(A) are used. FIG. 50A illustrates R and B from the first prefix 4701(A) being used to extend the reg field 4844 and R/M field 4846 of the MOD R/M byte 4802 when the SIB byte 48 04 is not used for memory addressing. FIG. 50B illustrates R and B from the first prefix 4701(A) being used to extend the reg field 4844 and R/M field 4846 of the MOD R/M byte 4802 when the SIB byte 48 04 is not used (register-register addressing). FIG. 50C illustrates R, X, and B from the first prefix 4701(A) being used to extend the reg field 4844 of the MOD R/M byte 4802 and the index field 4854 and base field 4856 when the SIB byte 48 04 being used for memory addressing. FIG. 50D illustrates B from the first prefix 4701(A) being used to extend the reg field 4844 of the MOD R/M byte 4802 when a register is encoded in the opcode 4703.

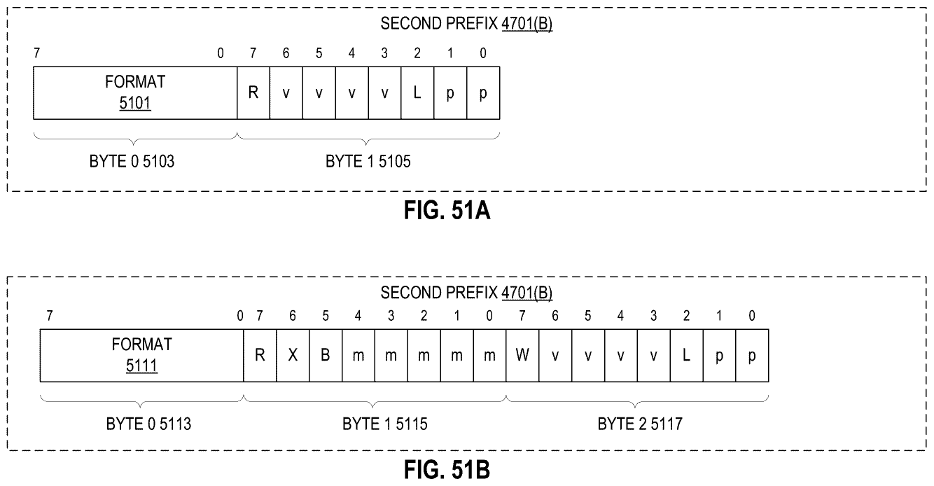

FIGS. 51A-51B illustrate examples of a second prefix 4701(B). In some examples, the second prefix 4701(B) is an example of a VEX prefix. The second prefix 4701(B) encoding allows instructions to have more than two operands, and allows SIMD vector registers (e.g., vector/SIMD registers 4610) to be longer than 64-bits (e.g., 128-bit and 256-bit). The use of the second prefix 4701(B) provides for three-operand (or more) syntax. For example, previous two-operand instructions performed operations such as A=A+B, which overwrites a source operand. The use of the second prefix 4701(B) enables operands to perform nondestructive operations such as A=B+C.

In some examples, the second prefix 4701(B) comes in two forms—a two-byte form and a three-byte form. The two-byte second prefix 4701(B) is used mainly for 128-bit, scalar, and some 256-bit instructions; while the three-byte second prefix 4701(B) provides a compact replacement of the first prefix 4701(A) and 3-byte opcode instructions.

FIG. 51A illustrates examples of a two-byte form of the second prefix 4701(B). In one example, a format field 5101 (byte 0 5103) contains the value C5H. In one example, byte 1 5105 includes an “R” value in bit[7]. This value is the complement of the “R” value of the first prefix 4701(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 4846 to encode the instruction operand that references a memory address or encode either the destination register operand or a source register operand.

Instructions that use this prefix may use the MOD R/M reg field 4844 to encode either the destination register operand or a source register operand, or to be treated as an opcode extension and not used to encode any instruction operand.

For instruction syntax that support four operands, vvvv, the MOD R/M R/M field 4846 and the MOD R/M reg field 4844 encode three of the four operands. Bits[7:4] of the immediate value field 4709 are then used to encode the third source register operand.

FIG. 51B illustrates examples of a three-byte form of the second prefix 4701(B). In one example, a format field 5111 (byte 0 5113) contains the value C4H. Byte 1 5115 includes in bits [7:5] “R,” “X,” and “B” which are the complements of the same values of the first prefix 4701(A). Bits[4:0] of byte 1 5115 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 5117 is used similar to W of the first prefix 4701(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 4846 to encode the instruction operand that references a memory address or encode either the destination register operand or a source register operand.

Instructions that use this prefix may use the MOD R/M reg field 4844 to encode either the destination register operand or a source register operand, or to be treated as an opcode extension and not used to encode any instruction operand.

For instruction syntax that support four operands, vvvv, the MOD R/M R/M field 4846, and the MOD R/M reg field 4844 encode three of the four operands. Bits[7:4] of the immediate value field 4709 are then used to encode the third source register operand.

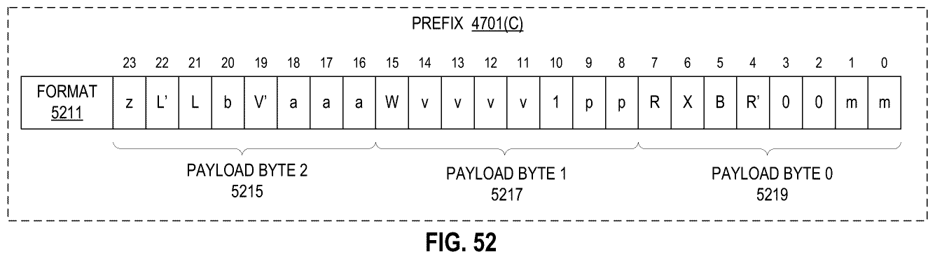

FIG. 52 illustrates examples of a third prefix 4701(C). In some examples, the third prefix 4701(C) is an example of an EVEX prefix. The third prefix 4701(C) is a four-byte prefix.

The third prefix 4701(C) can encode 32 vector registers (e.g., 128-bit, 256-bit, and 512-bit registers) in 64-bit mode. In some examples, instructions that utilize a writemask/opmask (sec discussion of registers in a previous figure, such as FIG. 46) or predication utilize this prefix. Opmask register allow for conditional processing or selection control. Opmask instructions, whose source/destination operands are opmask registers and treat the content of an opmask register as a single value, are encoded using the second prefix 4701(B).

The third prefix 4701(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 4701(C) is a format field 5211 that has a value, in one example, of 62H. Subsequent bytes are referred to as payload bytes 5215-5219 and collectively form a 24-bit value of P[23:0] providing specific capability in the form of one or more fields (detailed herein).

In some examples, P[1:0] of payload byte 5219 are identical to the low two mm bits. P[3:2] are reserved in some examples. Bit P[4] (R′) allows access to the high 16 vector register set when combined with P[7] and the MOD R/M reg field 4844. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 4844 and MOD R/M R/M field 4846. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 4701(A) and second prefix 4711(B) and may serve as an opcode extension bit or operand size promotion.

P[18:16] specify the index of a register in the opmask (writemask) registers (e.g., writemask/predicate registers 4615). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a nondestructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 4701(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination |
| | | | reg | | or Source |
| VVVV | V′ | vvvv | | GPR, Vector | 2nd Source |
| | | | | | or Destination |
| RM | X | B | MOD R/M | GPR, Vector | 1st Source |
| | | | R/M | | or Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

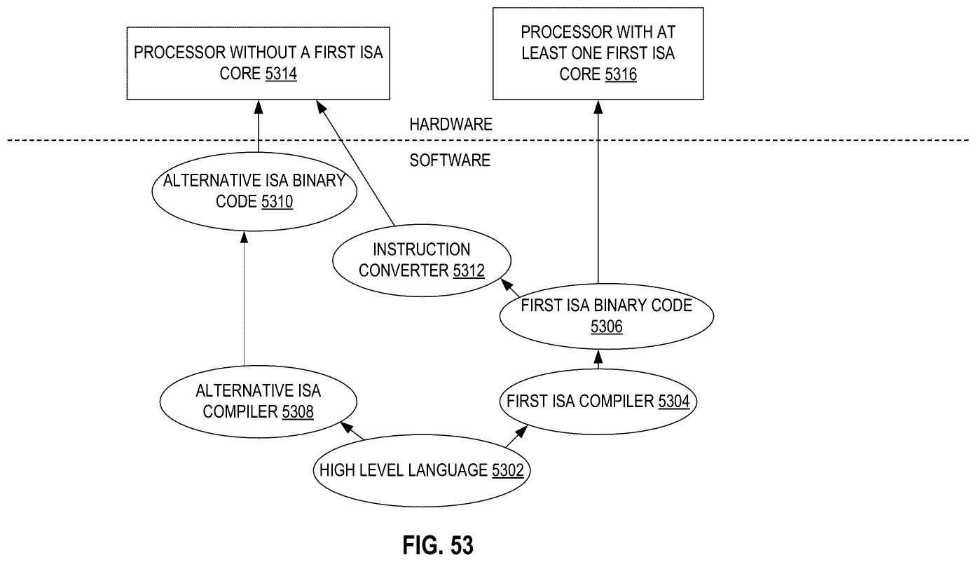

FIG. 53 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 53 shows a program in a high-level language 5302 may be compiled using a first ISA compiler 5304 to generate first ISA binary code 5306 that may be natively executed by a processor with at least one first ISA core 5316. The processor with at least one first ISA core 5316 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 5304 represents a compiler that is operable to generate first ISA binary code 5306 (e.g., object code) that can, with or without additional linkage processing, be executed on the processor with at least one first ISA core 5316. Similarly, FIG. 53 shows the program in the high-level language 5302 may be compiled using an alternative ISA compiler 5308 to generate alternative ISA binary code 5310 that may be natively executed by a processor without a first ISA core 5314. The instruction converter 5312 is used to convert the first ISA binary code 5306 into code that may be natively executed by the processor without a first ISA core 5314. This converted code is not necessarily to be the same as the alternative ISA binary code 5310; however, the converted code will accomplish the general operation and be made up of instructions from the alternative ISA. Thus, the instruction converter 5312 represents software, firmware, hardware, or a combination thereof that, through emulation, simulation, or any other process, allows a processor or other electronic device that does not have a first ISA processor or core to execute the first ISA binary code 5306.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a matrix operations accelerator circuit comprising:
a two-dimensional grid of fixed-point processing elements,
floating-point support circuitry coupled to the two-dimensional grid of fixed-point processing elements, and
storage for a first, a second, and a destination two-dimensional floating-point matrices coupled to the floating-point support circuitry; and
a hardware processor core coupled to the matrix operations accelerator circuit and comprising a decoder circuit to decode a single instruction into a decoded single instruction, the single instruction including a first field that identifies the first two-dimensional floating-point matrix, a second field that identifies the second two-dimensional floating-point matrix, and an opcode that indicates the matrix operations accelerator circuit is to:
determine, by the floating-point support circuitry, an extreme exponent for each row of the first two-dimensional floating-point matrix and for each column of the second two-dimensional floating-point matrix,
generate, by the floating-point support circuitry, a first fixed-point matrix from the first two-dimensional floating-point matrix and a second fixed-point matrix from the second two-dimensional floating-point matrix,
generate, by the two-dimensional grid of fixed-point processing elements, corresponding fixed-point results by a multiplication of fixed-point elements of the first fixed-point matrix by corresponding fixed-point elements of the second fixed-point matrix,
scale, by the floating-point support circuitry, the corresponding fixed-point results according to the extreme exponents to generate scaled fixed-point results,
generate, by the floating-point support circuitry, a resultant floating-point matrix from the scaled fixed-point results, and
store the resultant floating-point matrix into the destination two-dimensional floating-point matrix.

2. The apparatus of claim 1, wherein the opcode further indicates the matrix operations accelerator circuit is to:
partition each element of the first fixed-point matrix and each element of the second fixed-point matrix into a plurality of chunks,
generate, by the two-dimensional grid of fixed-point processing elements, the corresponding fixed-point results by a multiplication of chunks of the first fixed-point matrix by chunks of the second fixed-point matrix.

3. The apparatus of claim 2, wherein the opcode further indicates the matrix operations accelerator circuit is to scale, by the floating-point support circuitry, the corresponding fixed-point results according to the extreme exponents and a chunk offset to generate the scaled fixed-point results.

4. The apparatus of claim 2, wherein the opcode further indicates the matrix operations accelerator circuit is to partition each element of the first fixed-point matrix and each element of the second fixed-point matrix into at least three chunks.

5. The apparatus of claim 1, wherein the opcode further indicates the matrix operations accelerator circuit is to determine, by the floating-point support circuitry, the extreme exponent for each row of the first two-dimensional floating-point matrix as the first two-dimensional floating-point matrix is loaded into the storage and the extreme exponent for each column of the second two-dimensional floating-point matrix as the second two-dimensional floating-point matrix is loaded into the storage.

6. The apparatus of claim 1, wherein the single instruction includes a third field that identifies a third two-dimensional floating-point matrix, and the opcode further indicates the matrix operations accelerator circuit is to, before the store of the resultant floating-point matrix into the destination two-dimensional floating-point matrix, accumulate each element of the third two-dimensional floating-point matrix with a corresponding element of the resultant floating-point matrix to generate an updated resultant floating-point matrix, wherein the store is of the updated resultant floating-point matrix into the destination two-dimensional floating-point matrix.

7. The apparatus of claim 6, wherein the third two-dimensional floating-point matrix is stored in the storage for the destination two-dimensional floating-point matrix.

8. The apparatus of claim 1, wherein the apparatus does not include a two-dimensional grid of floating-point processing elements.

9. A method comprising:
decoding, by a decoder circuit of a hardware processor comprising a matrix operations accelerator circuit including a two-dimensional grid of fixed-point processing elements,
floating-point support circuitry coupled to the two-dimensional grid of fixed-point processing elements, and storage for a first, a second, and a destination two-dimensional floating-point matrices coupled to the floating-point support circuitry, a single instruction into a decoded single instruction, the single instruction including a first field that identifies the first two-dimensional floating-point matrix, a second field that identifies the second two-dimensional floating-point matrix, and an opcode that indicates the matrix operations accelerator circuit is to:
determine, by the floating-point support circuitry, an extreme exponent for each row of the first two-dimensional floating-point matrix and for each column of the second two-dimensional floating-point matrix,
generate, by the floating-point support circuitry, a first fixed-point matrix from the first two-dimensional floating-point matrix and a second fixed-point matrix from the second two-dimensional floating-point matrix,
generate, by the two-dimensional grid of fixed-point processing elements, corresponding fixed-point results by a multiplication of fixed-point elements of the first fixed-point matrix by corresponding fixed-point elements of the second fixed-point matrix,
scale, by the floating-point support circuitry, the corresponding fixed-point results according to the extreme exponents to generate scaled fixed-point results,
generate, by the floating-point support circuitry, a resultant floating-point matrix from the scaled fixed-point results, and
store the resultant floating-point matrix into the destination two-dimensional floating-point matrix, and
executing, by the matrix operations accelerator circuit, the decoded single instruction according to the opcode.

10. The method of claim 9, wherein the opcode further indicates the matrix operations accelerator circuit is to:
partition each element of the first fixed-point matrix and each element of the second fixed-point matrix into a plurality of chunks,
generate, by the two-dimensional grid of fixed-point processing elements, the corresponding fixed-point results by a multiplication of chunks of the first fixed-point matrix by chunks of the second fixed-point matrix.

11. The method of claim 10, wherein the opcode further indicates the matrix operations accelerator circuit is to scale, by the floating-point support circuitry, the corresponding fixed-point results according to the extreme exponents and a chunk offset to generate the scaled fixed-point results.

12. The method of claim 10, wherein the opcode further indicates the matrix operations accelerator circuit is to partition each element of the first fixed-point matrix and each element of the second fixed-point matrix into at least three chunks.

13. The method of claim 9, wherein the opcode further indicates the matrix operations accelerator circuit is to determine, by the floating-point support circuitry, the extreme exponent for each row of the first two-dimensional floating-point matrix as the first two-dimensional floating-point matrix is loaded into the storage and the extreme exponent for each column of the second two-dimensional floating-point matrix as the second two-dimensional floating-point matrix is loaded into the storage.

14. The method of claim 9, wherein the single instruction includes a third field that identifies a third two-dimensional floating-point matrix, and the opcode further indicates the matrix operations accelerator circuit is to, before the store of the resultant floating-point matrix into the destination two-dimensional floating-point matrix, accumulate each element of the third two-dimensional floating-point matrix with a corresponding element of the resultant floating-point matrix to generate an updated resultant floating-point matrix, wherein the store is of the updated resultant floating-point matrix into the destination two-dimensional floating-point matrix.

15. The method of claim 14, wherein the third two-dimensional floating-point matrix is stored in the storage for the destination two-dimensional floating-point matrix.

16. The method of claim 9, wherein the hardware processor does not utilize a two-dimensional grid of floating-point processing elements to generate the resultant floating-point matrix.

17. An apparatus comprising:
a two-dimensional grid of fixed-point processing elements;
floating-point support circuitry coupled to the two-dimensional grid of fixed-point processing elements;
storage for a first, a second, and a destination two-dimensional floating-point matrices coupled to the floating-point support circuitry; and
controller circuitry to cause the two-dimensional grid of fixed-point processing elements and the floating-point support circuitry to:
determine, by the floating-point support circuitry, an extreme exponent for each row of the first two-dimensional floating-point matrix and for each column of the second two-dimensional floating-point matrix,
generate, by the floating-point support circuitry, a first fixed-point matrix from the first two-dimensional floating-point matrix and a second fixed-point matrix from the second two-dimensional floating-point matrix,
generate, by the two-dimensional grid of fixed-point processing elements, corresponding fixed-point results by a multiplication of fixed-point elements of the first fixed-point matrix by corresponding fixed-point elements of the second fixed-point matrix,
scale, by the floating-point support circuitry, the corresponding fixed-point results according to the extreme exponents to generate scaled fixed-point results,
generate, by the floating-point support circuitry, a resultant floating-point matrix from the scaled fixed-point results, and
store the resultant floating-point matrix into the destination two-dimensional floating-point matrix.

18. The apparatus of claim 17, wherein the controller circuitry is to cause the two-dimensional grid of fixed-point processing elements and the floating-point support circuitry to:
partition each element of the first fixed-point matrix and each element of the second fixed-point matrix into a plurality of chunks,
generate, by the two-dimensional grid of fixed-point processing elements, the corresponding fixed-point results by a multiplication of chunks of the first fixed-point matrix by chunks of the second fixed-point matrix.

19. The apparatus of claim 18, wherein the controller circuitry is to cause the floating-point support circuitry to scale the corresponding fixed-point results according to the extreme exponents and a chunk offset to generate the scaled fixed-point results.

20. The apparatus of claim 18, wherein the controller circuitry is to cause the floating-point support circuitry to partition each element of the first fixed-point matrix and each element of the second fixed-point matrix into at least three chunks.

21. The apparatus of claim 17, wherein the controller circuitry is to cause the floating-point support circuitry to determine the extreme exponent for each row of the first two-dimensional floating-point matrix as the first two-dimensional floating-point matrix is loaded into the storage and the extreme exponent for each column of the second two-dimensional floating-point matrix as the second two-dimensional floating-point matrix is loaded into the storage.

22. The apparatus of claim 17, wherein the storage is also for a third two-dimensional floating-point matrix, and the controller circuitry is to cause the floating-point support circuitry to, before the store of the resultant floating-point matrix into the destination two-dimensional floating-point matrix, accumulate each element of the third two-dimensional floating-point matrix with a corresponding element of the resultant floating-point matrix to generate an updated resultant floating-point matrix, wherein the store is of the updated resultant floating-point matrix into the destination two-dimensional floating-point matrix.

23. The apparatus of claim 22, wherein the third two-dimensional floating-point matrix is stored in the storage for the destination two-dimensional floating-point matrix.

24. The apparatus of claim 17, wherein the apparatus does not include a two-dimensional grid of floating-point processing elements.
